(19) United States
(12) Patent Application Publication
(10) Pub. No.: US 2026/0364916 A1
(43) Pub. Date: Nov. 19, 2026

(54) THERMAL INSULATING MATERIAL

(71) Applicant: NITTO DENKO CORPORATION, Osaka (JP)

(72) Inventors: Shu SASAKI, Osaka (JP); Takehiro UI, Osaka (JP)

(73) Assignee: NITTO DENKO CORPORATION, Osaka (JP)

(21) Appl. No.: 19/125,346

(22) PCT Filed: Oct. 27, 2023
(86) PCT No.: PCT/JP2023/038971

§ 371 Date: Apr. 29, 2025

(30) Foreign Application Priority Data
Oct. 31, 2022 (JP) 2022-175114

(51) Int. Cl. B32B 5/02; B32B 5/18

(52) U.S. Cl. CPC B32B 5/02; B32B 5/18; B32B 2264/1021; B32B 2307/304

(57) ABSTRACT

Provided is a thermal insulating material including a thermal insulating layer containing inorganic particles, and a cushioning layer formed of a fiber-containing shaped material containing fiber or a foamed shaped material containing foam. The cushioning layer is a layer capable of generating a compressed state with a compressive strain value x_{B} [%] and a compressive stress value y_{B} [MPa] satisfying the following Formula (b1-1) and the following Formula (b1-2) in a compression test at a compression rate of 0.5 mm/min only for the cushioning layer.

0.50≤y_{B}≤3.45 Formula (b1-1)

0.30x_{B}−18.68≤y_{B}≤0.20x_{B}−0.48 Formula (b1-2)

### TECHNICAL FIELD

The present invention relates to a thermal insulating material, more particularly a thermal insulating material including a thermal insulating layer and a cushioning layer.

This application claims the priority based on Japanese Patent Application No. 2022-175114, filed on Oct. 31, 2022, the content of which is herein incorporated by reference in its entirety.

### BACKGROUND ART

Nonaqueous electrolyte secondary batteries such as lithium-ion secondary batteries have been increasingly utilized as electric sources of electric-powered vehicles such as electric vehicles (EVs), hybrid electric vehicles (HEVs), plug-in hybrid electric vehicles (PEVs), and fuel cell vehicles (FCVs). These applications need very high output and capacitance and thus employ a system of a battery module or a battery pack with battery cells (unit cells) integrated. As for battery packs of lithium ion secondary batteries, use of members having various functions have been investigated for ensuring safety. For example, a thermal insulating material is placed between cells in order to prevent thermal runway even in abnormal heat of some cells.

A cell in a lithium ion secondary battery is known to repeat expansion by charging and contraction by discharge, and the cause and solution have been actively researched. For example, Non-patent Document 1 describes that these are caused by an oxide film generated from a side reaction of silicon particles with an electrolyte or the like, and shows a measure in which a novel antioxidant film is used to prevent a material from irreversible expansion, thereby reducing both electrode expansion and cycle deterioration. Furthermore, with regard to a secondary battery that results in large expansion and contraction of a battery cell associated with charge and discharge, Non-patent Document 2 exemplarily discloses that use of a binder having adjusted elastic modulus prevents an electrode from expansion, leading to a good cycle property.

Patent Document 1 discloses that an elastic body that receives a load from an electrode body (electrode assembly) of a secondary battery in a stacking direction of the electrode body also has a role of absorbing pressure, and that prescribing a compressive elastic modulus of each member allows reducing increase in resistance in high-rate charge and discharge and decrease in capacitance in a charge and discharge cycle.

### CITATION LIST

### Patent Literature

[Patent Document 1] Japanese Patent Application Publication No. 2021-114361
[Patent Document 2] Canadian Patent Application Publication No. 1190279

### Non Patent Literature

[Non patent Document 1]“Practical Use of Silicon-based High-capacitance Negative Electrode Material for Lithium Ion Battery with Reducing Material Expansion Associated with Charging”, Strategic Foundational Technology Improvement Support Operation, 2015, entruster: Kansai Bureau of Economy, Trade and Industry, entrustee: Advanced Science, Technology & Management Research Institute of Kyoto
[Non patent Document 2] Development of binder for Si anode and evaluation of electrode expansion, JSR Technical Review No. 125 (2018/3), published by JSR Corporation
[Non patent Document 3] Effects of Pressure and Mechanical Property of Stack Separator on Electrode Reaction of Lithium Metal Negative Electrode, Shogo Kanamori, Master's thesis, Energy Conversion Chemistry Course, Department of Chemistry for Materials, Graduate School of Engineering, Mie University (2020/3)
[Non-patent Document 4] Investigation of Constant Stack Pressure on Lithium-Ion Battery Performance, High Voltage Energy Storage Group, School of Engineering, Computing, and Mathematics, Oxford Brookes University, Oxford, UK, OX33 1HX, by Aiden Leonarda, Brady Plandena, and Katie Lukowa (2023/1)

### SUMMARY OF INVENTION

### Technical Problem

As described above, a cell in a lithium ion secondary battery repeats expansion by charging and contraction by discharge and further also generates irreversible expansion, and hence dimensional change in a stacking direction of the cell, pressure thus generated, and other factors should be taken into account in terms of a battery pack having integrated cells or a battery module included in the battery pack. Several reports have also shown that a cell in a lithium ion secondary battery has more improved efficiency as a battery when the cell itself receives a certain degree of pressure (see, e.g., Patent Document 2, Non-patent Document 3, and Non-patent Document 4). Accordingly, a thermal insulating material placed between cells such as a battery pack not only provides a thermal insulating property for preventing thermal runway or the like, but also allows change in thickness corresponding to repetition of cell expansion and contraction and the like, and preferably further has a cushioning property that can generate a moderate stress.

The present invention has an object to provide a thermal insulating material having an excellent thermal insulating property and cushioning property, particularly having a preferred thermal insulating property and cushioning property when used as a thermal insulating material placed between cells in a battery pack or the like.

### Solution to Problem

The thermal insulating material provided hereby includes a thermal insulating layer containing inorganic particles, and a cushioning layer formed of a fiber-containing shaped material containing fiber or a foamed shaped material containing foam. The cushioning layer is a layer capable of generating a compressed state with a compressive strain value x_{B} [%] and a compressive stress value y_{B} [MPa] satisfying the following Formula (b1-1) and the following Formula (b1-2) in a compression test at a compression rate of 0.5 mm/min only for the cushioning layer. Employing a cushioning layer capable of generating a compressed state with a compressive strain value x_{B} [%] and a compressive stress value y_{B} [MPa] simultaneously satisfying the Formula (b1-1) and the Formula (b1-2) in the compression test can provide a thermal insulating material that suitably changes its thickness and further generates a preferred stress corresponding to repetition of expansion and contraction of a cell.

0.50≤y_{B}≤3.45 Formula (b1-1)

0.30x_{B}−18.68≤y_{B}≤0.20x_{B}−0.48 Formula (b1-2)

In some embodiments of the thermal insulating material disclosed herein, the cushioning layer is preferably a layer capable of generating a compressed state with a compressive strain value x_{B} [%] and a compressive stress value y_{B} [MPa] satisfying the following Formula (b2-1) and the following Formula (b2-2) in the compression test. When the cushioning layer is a layer capable of generating such a compressed state, a preferred cushioning property is provided more easily.

1.00≤y_{B}≤3.00 Formula (b2-1)

0.20x_{B}−11.00≤y_{B}≤0.10x_{B} Formula (b2-2)

In some embodiments, the cushioning layer is more preferably a layer capable of generating a compressed state with a compressive strain value x_{B} [%] and a compressive stress value y_{B} [MPa] satisfying the following Formula (b3-1) and the following Formula (b3-2) in the compression test. When the cushioning layer is a layer capable of generating such a compressed state, a more preferred cushioning property is provided more easily.

1.50≤y_{B}≤3.00 Formula (b3-1)

0.15x_{B}−7.50≤y_{B}≤0.10x_{B}−1.00 Formula (b3-2)

In some embodiments, the cushioning layer is even more preferably a layer capable of generating a compressed state with a compressive strain value x_{B} [%] and a compressive stress value y_{B} [MPa] satisfying the following Formula (b4-1) and the following Formula (b4-2) in the compression test. When the cushioning layer is a layer capable of generating such a compressed state, an even more preferred cushioning property is provided more easily.

2.00≤y_{B}≤2.50 Formula (b4-1)

0.10x_{B}−3.50≤y_{B}≤0.10x_{B}−1.50 Formula (b4-2)

In some embodiments of the thermal insulating material disclosed herein, the thermal insulating layer is preferably a layer capable of generating a compressed state with a compressive strain value x_{A} [%] and a compressive stress value y_{A} [MPa] satisfying the following Formula (a1-1) and the following Formula (a1-2) in a compression test at a compression rate of 0.5 mm/min only for the thermal insulating layer. Employment of a thermal insulating layer capable of generating a compressed state with a compressive strain value x_{A} [%] and a compressive stress value y_{A} [MPa] simultaneously satisfying the Formula (a1-1) and the Formula (a1-2) in the compression test as a thermal insulating layer used for constructing a thermal insulating material in combination with any cushioning layer disclosed herein can result in exertion of a preferred thermal insulating property and cushioning property in the thermal insulating material.

0.50≤y_{A}≤3.45 Formula (a1-1)

0.12x_{A}−2.45≤y_{A} Formula (a1-2)

In some embodiments, the thermal insulating layer is more preferably a layer capable of generating a compressed state with a compressive strain value x_{A} [%] and a compressive stress value y_{A} [MPa] satisfying the following Formula (a2-1) and the following Formula (a2-2) in the compression test. When the thermal insulating layer is a layer capable of generating such a compressed state, a better thermal insulating property is provided more easily.

1.00≤y_{A}≤3.00 Formula (a2-1)

0.20x_{A}−3.00≤y_{A} Formula (a2-2)

In some embodiments, the thermal insulating layer is even more preferably a layer capable of generating a compressed state with a compressive strain value x_{A} [%] and a compressive stress value y_{A} [MPa] satisfying the following Formula (a3-1) and the following Formula (a3-2) in the compression test. When the thermal insulating layer is a layer capable of generating such a compressed state, an even better thermal insulating property is provided more easily.

1.50≤y_{A}≤2.50 Formula (a3-1)

0.20x_{A}−1.50≤y_{A} Formula (a3-2)

In some embodiments, the thermal insulating layer is preferably a layer containing silicon dioxide particles as the inorganic particles. The thermal insulating material disclosed herein can be preferably implemented with a configuration including a thermal insulating layer containing silicon dioxide particles and the cushioning layer. As the silicon dioxide particles, at least one selected from the group consisting of dry silica, wet silica, and silica aerogel can be preferably employed. A preferred example of the dry silica can be hydrophilic fumed silica.

In some embodiments, the thermal insulating layer is preferably a shaped material shaped from a mixture containing the inorganic particles and inorganic fiber. The thermal insulating material disclosed herein can be preferably implemented with a configuration including a thermal insulating layer that is a such a shaped material, and the cushioning layer.

The thermal insulating material disclosed herein can be preferably used in an embodiment where it is placed between cells in a battery module. In particular, the thermal insulating material is preferred as a thermal insulating material placed between cells in a lithium ion battery module.

It should be noted that an appropriate combination of components each described herein can also be encompassed within the range of the present invention for which patent protection is sought by the application.

### DESCRIPTION OF EMBODIMENTS

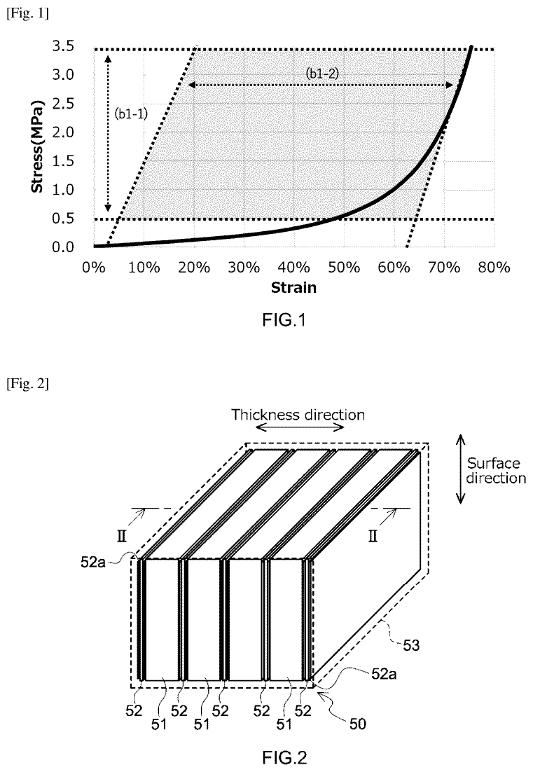

FIG. 1 is a graph depicting a stress-strain curve (S-S curve) and a region of a compressive strain value x_{B} [%] and a compressive stress value y_{B} [MPa] satisfying Formula (b1-1) and Formula (b1-2), in a compression test only for a cushioning layer.

FIG. 2 is a perspective view schematically illustrating an exemplary battery module in which a thermal insulating material according to an embodiment is placed between cells.

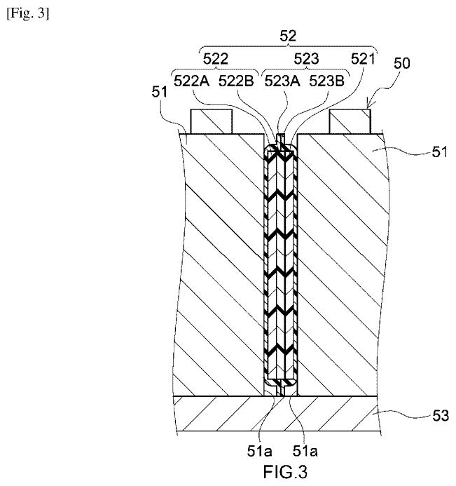

FIG. 3 is a cross-sectional view taken along the line II-II in FIG. 2.

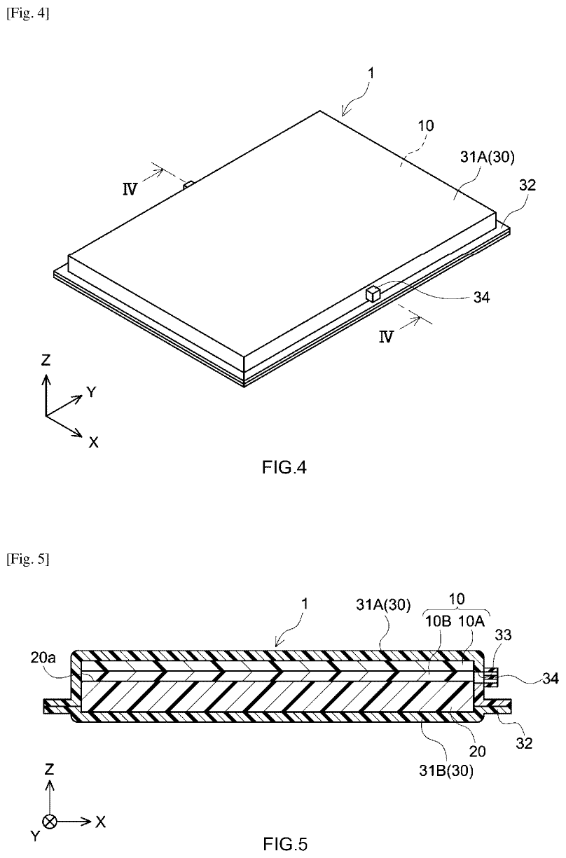

FIG. 4 is a perspective view schematically illustrating athermal insulating material according to an embodiment.

FIG. 5 is a cross-sectional view taken along the line IV-IV in FIG. 4.

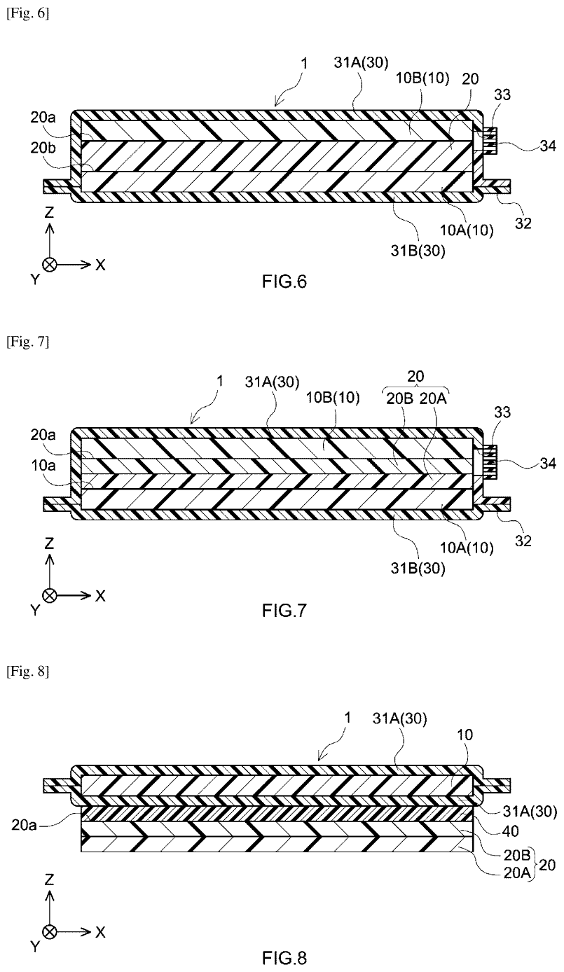

FIG. 6 is a cross-sectional view schematically illustrating a thermal insulating material according to another embodiment.

FIG. 7 is a cross-sectional view schematically illustrating a thermal insulating material according to another embodiment.

FIG. 8 is a cross-sectional view schematically illustrating a thermal insulating material according to another embodiment.

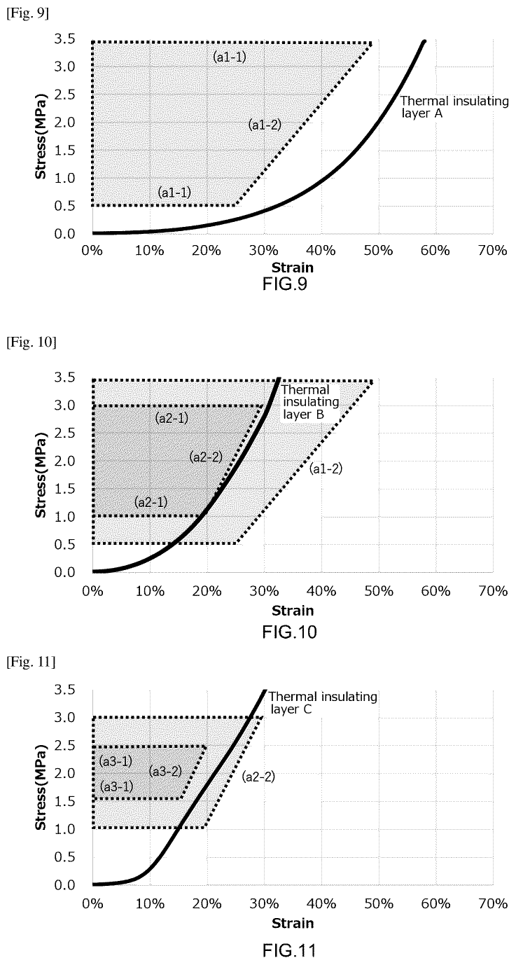

FIG. 9 shows a stress-strain curve (S-S curve) of Thermal insulating layer A.

FIG. 10 shows a stress-strain curve (S-S curve) of Thermal insulating layer B.

FIG. 11 shows a stress-strain curve (S-S curve) of Thermal insulating layer C.

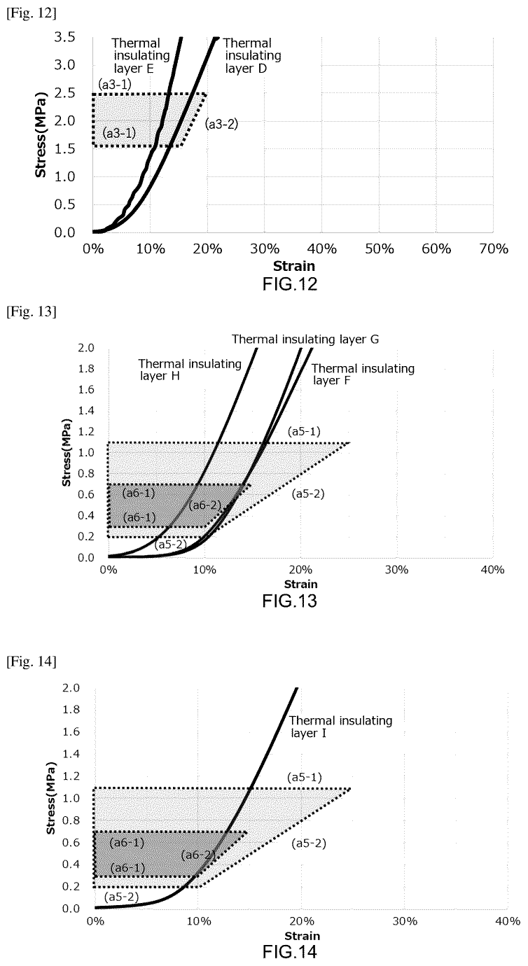

FIG. 12 shows stress-strain curves (S-S curves) of Thermal insulating layers D and E.

FIG. 13 shows stress-strain curves (S-S curves) of Thermal insulating layers F, G, and H.

FIG. 14 shows a stress-strain curve (S-S curve) of Thermal insulating layer I.

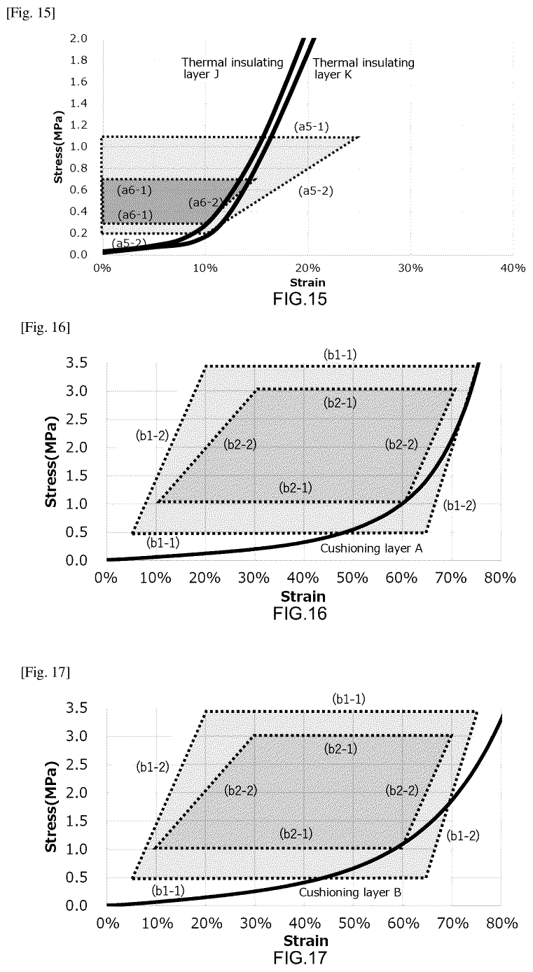

FIG. 15 shows stress-strain curves (S-S curves) of Thermal insulating layers J and K.

FIG. 16 shows a stress-strain curve (S-S curve) of Cushioning layer A.

FIG. 17 shows a stress-strain curve (S-S curve) of Cushioning layer B.

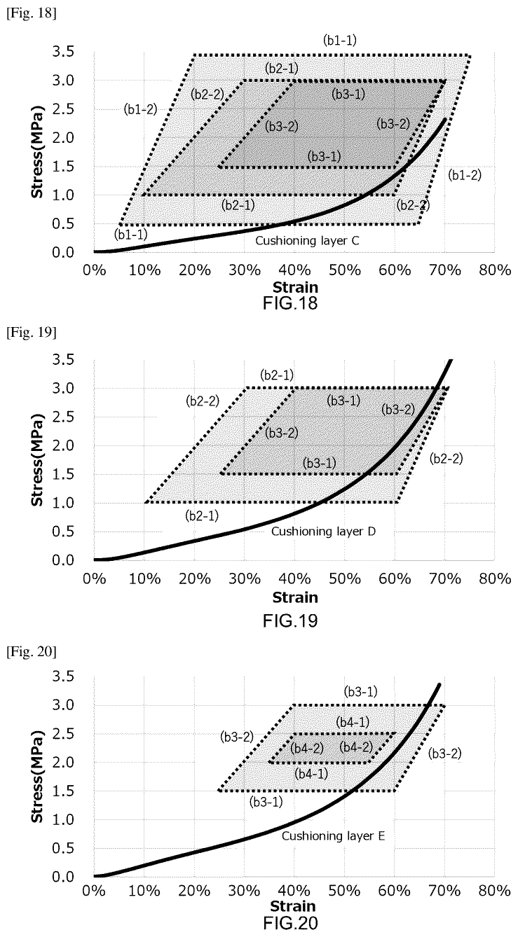

FIG. 18 shows a stress-strain curve (S-S curve) of Cushioning layer C.

FIG. 19 shows a stress-strain curve (S-S curve) of Cushioning layer D.

FIG. 20 shows a stress-strain curve (S-S curve) of Cushioning layer E.

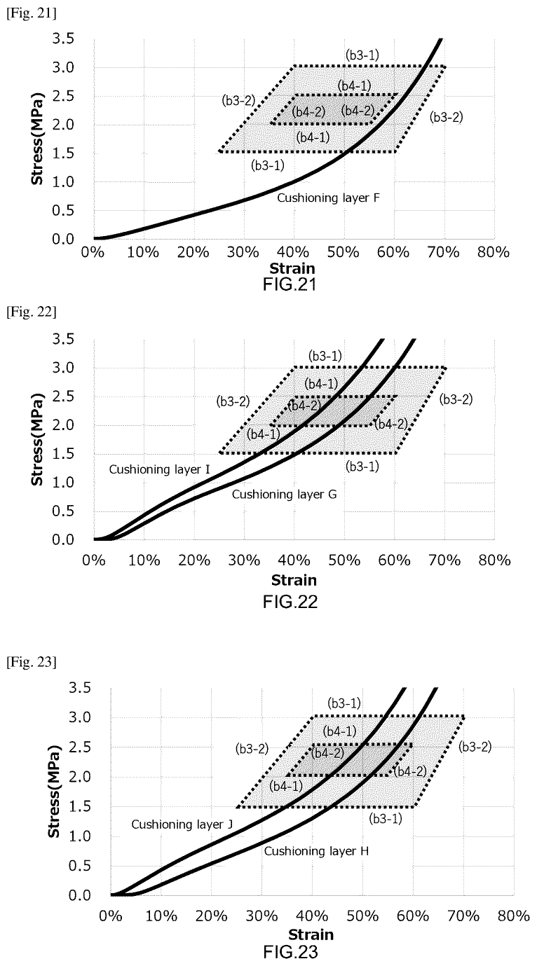

FIG. 21 shows a stress-strain curve (S-S curve) of Cushioning layer F.

FIG. 22 shows a stress-strain curve (S-S curve) of cushioning layer G.

FIG. 23 shows stress-strain curves (S-S curves) of Cushioning layers H and J.

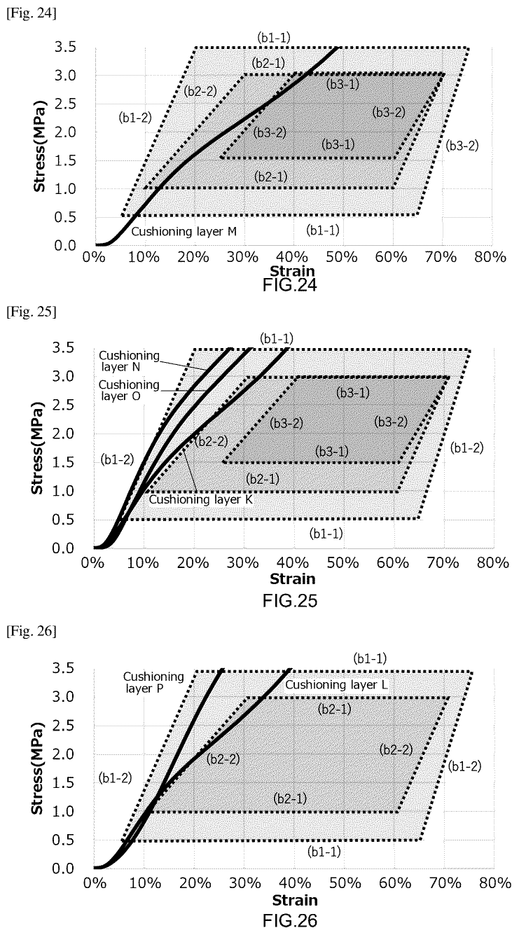

FIG. 24 shows a stress-strain curve (S-S curve) of Cushioning layer M.

FIG. 25 shows stress-strain curves (S-S curves) of Cushioning layers K, N, and O.

FIG. 26 shows stress-strain curves (S-S curves) of Cushioning layers L and P.

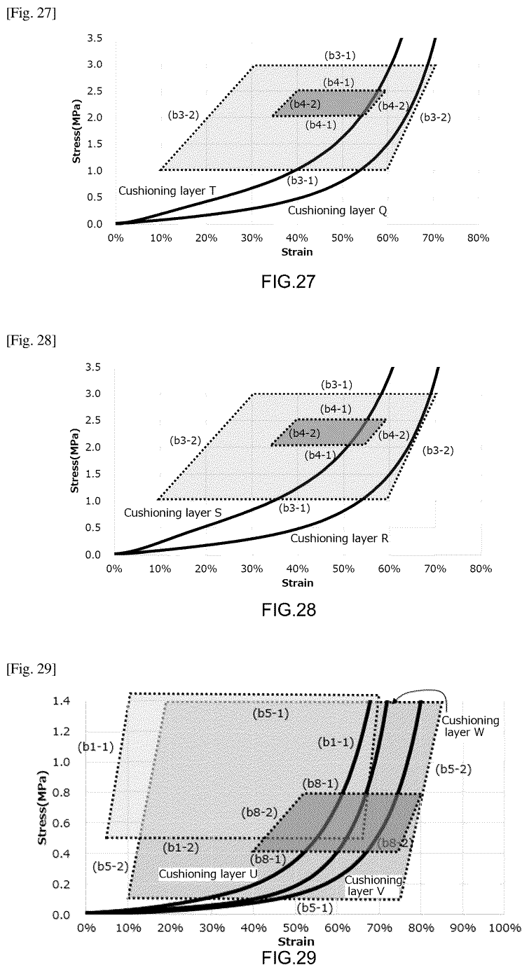

FIG. 27 shows stress-strain curves (S-S curves) of Cushioning layers Q and T.

FIG. 28 shows stress-strain curves (S-S curves) of Cushioning layers R and S.

FIG. 29 shows stress-strain curves (S-S curves) of Cushioning layers U, V, and W.

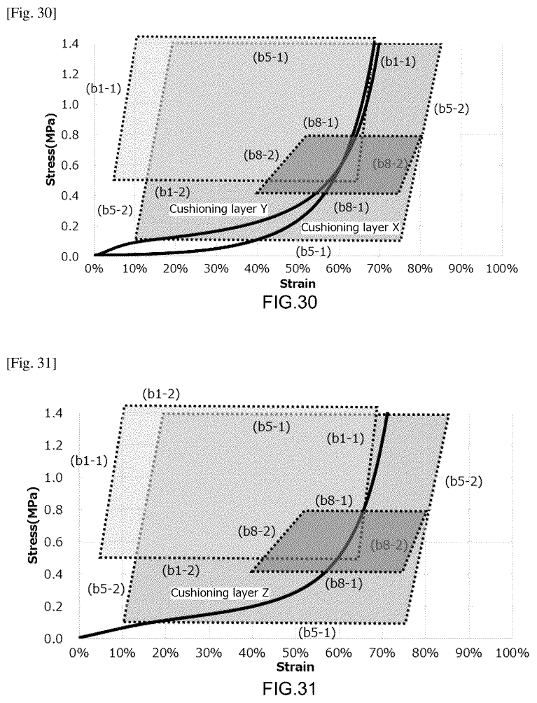

FIG. 30 shows stress-strain curves (S-S curves) of Cushioning layers X and Y.

FIG. 31 shows a stress-strain curve (S-S curve) of Cushioning layer Z.

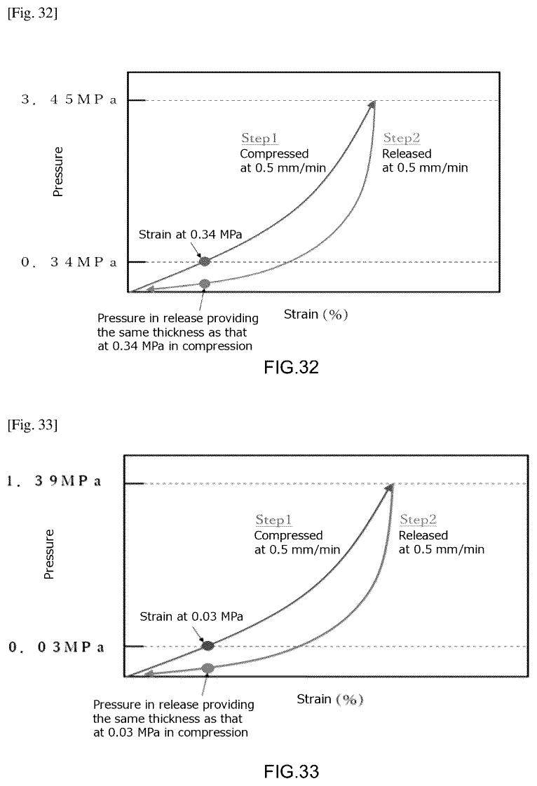

FIG. 32 shows stress-strain curves (S-S curves) schematically illustrating Loading-unloading test 1 (high-pressure condition).

FIG. 33 shows stress-strain curves (S-S curves) schematically illustrating Loading-unloading test 2 (low-pressure condition).

### DESCRIPTION OF EMBODIMENTS

Preferred embodiments of the present invention will be described below. Matters that are other than those particularly mentioned herein but are necessary for implementation of the present invention can be recognized by those skilled in the art based on teachings for practice of the present invention described herein and common technical knowledge at the time of filing. The present invention can be implemented based on the contents disclosed herein and common technical knowledge in the art. In the drawings below, members or sites producing the same effects may be described with a common reference numeral, and duplicated descriptions may be omitted or simplified. The embodiments depicted in the drawings are schematized for explicitly illustrating the present invention, and do not necessarily represent the accurate size or reduction scale of a product actually provided.

The thermal insulating material disclosed hereby (hereinafter sometimes omitted as “thermal insulating material”) includes a thermal insulating layer containing inorganic particles (hereinafter sometimes omitted as “thermal insulating layer”) and a cushioning layer formed of a fiber-containing shaped material containing fiber or a foamed shaped material containing foam (hereinafter sometimes omitted as “cushioning layer”).

In some embodiments, the thermal insulating material has a characteristic in that the cushioning layer is a layer capable of generating a compressed state with a compressive strain value x_{B} [%] and a compressive stress value y_{B} [MPa] satisfying the following Formula (b1-1) and the following Formula (b1-2) in a compression test at a compression rate of 0.5 mm/min only for the cushioning layer.

0.50≤y_{B}≤3.45 Formula(b1-1)

0.30x_{B}−18.68≤y_{B}≤0.20x_{B}−0.48 Formula (b1-2)

In some other embodiments, the thermal insulating material has a characteristic in that the cushioning layer is a layer capable of generating a compressed state with a compressive strain value x_{B} [%] and a compressive stress value y_{B} [MPa] satisfying the following Formula (b5-1) and the following Formula (b5-2) in a compression test at a compression rate of 0.5 mm/min only for the cushioning layer.

0.10≤y_{B}≤1.39 Formula (b5-1)

0.129x_{B}−9.575≤y_{B}≤0.129x_{B}−1.19 Formula (b5-2)

The inventors earnestly investigated a thermal insulating material having a thermal insulating property and a cushioning property, and consequently found that a thermal insulating material that suitably changes its thickness and further generates a preferred stress corresponding to repetition of expansion and contraction of a cell is produced by arranging, in addition to a thermal insulating layer, a cushioning layer formed of a fiber-containing shaped material containing fiber or a foamed shaped material containing foam, and further employing, as the cushioning layer, a layer capable of generating a specific compressed state in a compression test.

Hereinafter, detailed description will be made on “compression test”, “compressive strain value”, “compressive stress value” and the like.

As used herein, “compression test” means a test performed by adding a compression force (load) to a test object and measuring a compression strength and the like until the test object is deformed, broken, or the like. A compression test is a test that can be appropriately performed by using a commercially available testing machine such as the precision universal testing machine AUTOGRAPH. Such a testing machine and control software are capable of setting “compression rate” as a test condition, and typically configured to successively measure compression displacements and compression strengths in a process of compressing a test object and automatically output “compressive strain”, “compressive stress”, a stress-strain curve (S-S curve), and the like. Although the thermal insulating material disclosed hereby includes a thermal insulating layer and a cushioning layer, a compression test itself is considered as a single-component test directed to a form including only a cushioning layer or only a thermal insulating layer as a test object.

In some embodiments of the thermal insulating material disclosed hereby, a cushioning layer in the thermal insulating material is “a layer capable of generating a compressed state with a compressive strain value x_{B} [%] and a compressive stress value y_{B} [MPa] satisfying the following Formula (b1-1) and the following Formula (b1-2)” in the compression test described above. This means a cushioning layer having numerical values simultaneously satisfying the following Formula (b1-1) and the following Formula (b1-2) as “compressive strain value x_{B} [%]” and “compressive stress value y_{B} [MPa]” corresponding to the x_{B} in a compressed state generated by the compression test described above.

0.50≤y_{B}≤3.45 Formula(b1-1)

0.30x_{B}−18.68≤y_{B}≤0.20x_{B}−0.48 Formula (b1-2)

Formula (b1-1) represents the interior defined by two lines parallel to the x-axis in FIG. 1, and Formula (b1-2) represents the interior defined by two lines obliquely extending in FIG. 1. A compressive strain value x_{B} and a compressive stress value y_{B} simultaneously satisfying Formula (b1-1) and Formula (b1-2) are presenting a region enclosed by these lines (hereinafter referred to as Region (b1)). Thus, “a layer capable of generating a compressed state with a compressive strain value x_{B}[%] and a compressive stress value y_{B} [MPa] satisfying Formula (b1-1) and Formula (b1-2)” can be a layer in which at least one of combinations of compressive strain values x_{B} and compressive stress values y_{B} derived by a compression test falls within the Region (b1). In addition, even though no combination as particular measured values in a compression test falls within Region (b1), such a layer can also be considered to fall within Region (b1) when an approximate curve of compressive strain values x_{B} and compressive stress values y_{B} is created and found to pass through Region (b1). In other words, “a layer capable of generating a compressed state with a compressive strain value x_{B} [%] and a compressive stress value y_{B} [MPa] satisfying Formula (b1-1) and Formula (b1-2)” can be a layer in which a so-called “stress-strain curve (S-S curve)”, derived by a compression test, passes through Region (b1).

The left side of Formula (b1-2) “0.30x_{B}−18.68” represents a line connecting a point with a compressive strain value of “65%” and a compressive stress value of “0.50 MPa”, and a point with a compressive strain value of “75%” and a compressive stress value of “3.45 MPa”. These points provide a slope of “0.30” and an intercept of “−18.68” through calculation. Accordingly, a compressive strain value employs a numerical value in “%”, and a compressive stress value employs a numerical value in “MPa”. On the other hand, the right side of Formula (b1-2) “0.20x_{B}−0.48” represents a line connecting a point with a compressive strain value of “5%” and a compressive stress value of “0.50 MPa”, and a compressive strain value of “20%” and a compressive stress value of “3.45 MPa”. These points provide a slope of “0.20” and an intercept of “−0.48” through calculation.

The cushioning layer is preferably a layer capable of generating a compressed state with a compressive strain value x_{B} [%] and a compressive stress value y_{B} [MPa] satisfying the following Formula (b2-1) and the following Formula (b2-2) in the compression test described above. In other words, a stress-strain curve derived by the compression test preferably passes a region enclosed by Formula (b2-1) and Formula (b2-2) (Region (b2)).

1.00≤y_{B}≤3.00 Formula (b2-1)

0.20x_{B}−11.00≤y_{B}≤0.10x_{B} Formula (b2-2)

When the cushioning layer is a layer capable of generating such a compressed state, a more preferred cushioning property is provided more easily.

The left side of Formula (b2-2) “0.20x_{B}−11.00” represents a line connecting a point with a compressive strain value of “60%” and a compressive stress value of “1.00 MPa”, and a point with a compressive strain value of “70%” and a compressive stress value of “3.00 MPa”. These points provide a slope of “0.20” and an intercept of “−11.00” through calculation. On the other hand, the right side of Formula (b2-2) “0.10x_{B}” represents a line connecting a point with a compressive strain value of “10%” and a compressive stress value of “1.00 MPa”, and a compressive strain value of “30%” and a compressive stress value of “3.00 MPa”. These points provide a slope of “0.10” and an intercept of “0” through calculation.

The cushioning layer is preferably a layer capable of generating a compressed state with a compressive strain value x_{B} [%] and a compressive stress value y_{B} [MPa] satisfying the following Formula (b3-1) and the following Formula (b3-2) in the compression test described above.

1.50≤y_{B}≤3.00 Formula (b3-1)

0.15x_{B}−7.50≤y_{B}≤0.10x_{B}−1.00 Formula (b3-2)

When the cushioning layer is a layer capable of generating such a compressed state, a more preferred cushioning property is provided more easily.

The left side of Formula (b3-2) “0.15x_{B}−7.50” represents a line connecting a point with a compressive strain value of “60%” and a compressive stress value of “1.50 MPa”, and a point with a compressive strain value of “70%” and a compressive stress value of “3.00 MPa”. These points provide a slope of “0.15” and an intercept of “−7.50” through calculation. On the other hand, the right side of Formula (b3-2) “0.10x_{B}−1.00” represents a line connecting a point with a compressive strain value of “25%” and a compressive stress value of “1.50 MPa”, and a compressive strain value of “40%” and a compressive stress value of “3.00 MPa”. These points provide a slope of “0.10” and an intercept of “−1.00” through calculation.

The cushioning layer is more preferably a layer capable of generating a compressed state with a compressive strain value x_{B} [%] and a compressive stress value y_{B} [MPa] satisfying the following Formula (b4-1) and the following Formula (b4-2) in the compression test described above.

2.00≤y_{B}≤2.50 Formula (b4-1)

0.10x_{B}−3.50≤y_{B}≤0.10x_{B}−1.50 Formula (b4-2)

When the cushioning layer is a layer capable of generating such a compressed state, a more preferred cushioning property is provided more easily.

The left side of Formula (b4-2) “0.10x_{B}−3.50” represents a line connecting a point with a compressive strain value of “55%” and a compressive stress value of “2.00 MPa”, and a point with a compressive strain value of “60%” and a compressive stress value of “2.50 MPa”. These points provide a slope of “0.10” and an intercept of “−3.50” through calculation. On the other hand, the right side of Formula (b4-2) “0.10x_{B}−1.50” represents a line connecting a point with a compressive strain value of “35%” and a compressive stress value of “2.00 MPa”, and a compressive strain value of “40%” and a compressive stress value of “2.50 MPa”. These points provide a slope of “0.10” and an intercept of “−1.50” through calculation.

In some embodiments of the thermal insulating material disclosed hereby, a cushioning layer in the thermal insulating material is “a layer capable of generating a compressed state with a compressive strain value x_{B} [%] and a compressive stress value y_{B} [MPa] satisfying the following Formula (b5-1) and the following Formula (b5-2)” in the compression test described above. This means a cushioning layer having numerical values simultaneously satisfying the following Formula (b5-1) and the following Formula (b5-2) as “compressive strain value x_{B} [%]” and “compressive stress value y_{B} [MPa]” corresponding to the x_{B} in a compressed state generated in the compression test described above.

0.10≤y_{B}≤1.39 Formula (b5-1)

0.129x_{B}−9.575≤y_{B}≤0.129x_{B}−1.19 Formula (b5-2)

Formula (b5-1) represents the interior defined by two lines parallel to the x-axis in a graph with strain on the x-axis and stress on the y-axis, and Formula (b5-2) represents the interior defined by two lines obliquely extending in the graph. A compressive strain value x_{B} and a compressive stress value y_{B} simultaneously satisfying Formula (b5-1) and Formula (b5-2) are present in a region enclosed by these lines (hereinafter referred to as Region (b5)). Thus, “a layer capable of generating a compressed state with a compressive strain value x_{B} [%] and a compressive stress value y_{B} [MPa] satisfying Formula (b5-1) and Formula (b5-2)” can be a layer in which at least one of combinations of compressive strain values x_{B} and compressive stress values y_{B} derived by a compression test falls within the Region (b5). In addition, even though no combination as particular measured values in a compression test falls within Region (b5), such a layer can also be considered to fall within Region (b5) when an approximate curve of compressive strain values x_{B} and compressive stress values y_{B} is created and found to pass through Region (b5). In other words, “a layer capable of generating a compressed state with a compressive strain value x_{B} [%] and a compressive stress value y_{B} [MPa] satisfying Formula (b5-1) and Formula (b5-2)” can be a layer in which a so-called “stress-strain curve (S-S curve)”, derived by a compression test, passes through Region (b5).

The left side of Formula (b5-2) “0.129x_{B}−9.575” represents a line connecting a point with a compressive strain value of “75%” and a compressive stress value of “0.10 MPa”, and a point with a compressive strain value of “85%” and a compressive stress value of “1.39 MPa”. These points provide a slope of “0.129” and an intercept of “−9.575” through calculation. Accordingly, a compressive strain value employs a numerical value in “%”, and a compressive stress value employs a numerical value in “MPa”. On the other hand, the right side of Formula (b5-2) “0.13x_{B}−1.19” represents a line connecting a point with a compressive strain value of “10%” and a compressive stress value of “0.10 MPa”, and a compressive strain value of “20%” and a compressive stress value of “1.39 MPa”. These points provide a slope of “0.129” and an intercept of “−1.19” through calculation.

The cushioning layer is preferably a layer capable of generating a compressed state with a compressive strain value x_{B} [%] and a compressive stress value y_{B} [MPa] satisfying the following Formula (b6-1) and the following Formula (b6-2) in the compression test described above.

0.20≤y_{B}≤1.10 Formula (b6-1)

0.12x_{B}−8.80≤y_{B}≤0.036x_{B}−0.34. Formula (b6-2)

When the cushioning layer is a layer capable of generating such a compressed state, a more preferred cushioning property is provided more easily.

The left side of Formula (b6-2) “0.12x_{B}−8.80” represents a line connecting a point with a compressive strain value of “75%” and a compressive stress value of “0.20 MPa”, and a point with a compressive strain value of “85%” and a compressive stress value of “1.39 MPa”. These points provide a slope of “0.12” and an intercept of “−8.80” through calculation. On the other hand, the right side of Formula (b6-2) “0.036x_{B}−0.34” represents a line connecting a point with a compressive strain value of “15%” and a compressive stress value of “0.20 MPa”, and a compressive strain value of “40%” and a compressive stress value of “1.10 MPa”. These points provide a slope of “0.036” and an intercept of “−0.34” through calculation.

The cushioning layer is preferably a layer capable of generating a compressed state with a compressive strain value x_{B} [%] and a compressive stress value y_{B} [MPa] satisfying the following Formula (b7-1) and the following Formula (b7-2) in the compression test described above.

0.30≤y_{B}≤0.90 Formula (b7-1)

0.12x_{B}−8.70≤y_{B}≤0.04x_{B}−0.90 Formula (b7-2)

When the cushioning layer is a layer capable of generating such a compressed state, a more preferred cushioning property is provided more easily.

The left side of Formula (b7-2) “0.12x_{B}−8.70” represents a line connecting a point with a compressive strain value of “75%” and a compressive stress value of “0.30 MPa”, and a point with a compressive strain value of “80%” and a compressive stress value of “0.90 MPa”. These points provide a slope of “0.12” and an intercept of “−8.70” through calculation. On the other hand, the right side of Formula (b7-2) “0.04x_{B}−0.90” represents a line connecting a point with a compressive strain value of “30%” and a compressive stress value of “0.30 MPa”, and a compressive strain value of “45%” and a compressive stress value of “0.90 MPa”. These points provide a slope of “0.04” and an intercept of “−0.90” through calculation.

The cushioning layer is more preferably a layer capable of generating a compressed state with a compressive strain value x_{B} [%] and a compressive stress value y_{B} [MPa] satisfying the following Formula (b8-1) and the following Formula (b8-2) in the compression test described above.

0.40≤y_{B}≤0.80 Formula (b8-1)

0.08x_{B}−5.60≤y_{B}≤0.032x_{B}−0.88 Formula (b8-2)

When the cushioning layer is a layer capable of generating such a compressed state, a more preferred cushioning property is provided more easily.

The left side of Formula (b8-2) “0.08x_{B}−5.60≤” represents a line connecting a point with a compressive strain value of “75%” and a compressive stress value of “0.40 MPa”, and a point with a compressive strain value of “80%” and a compressive stress value of “0.80 MPa”. These points provide a slope of “0.08” and an intercept of “−5.60” through calculation. On the other hand, the right side of Formula (b8-2) “0.032x_{B}−0.88” represents a line connecting a point with a compressive strain value of “40%” and a compressive stress value of “0.40 MPa”, and a compressive strain value of “52.5%” and a compressive stress value of “0.80 MPa”. These points provide a slope of “0.032” and an intercept of “−0.88” through calculation.

To shift a stress-strain curve (S-S curve) of the cushioning layer to provide a lower compressive strain and a higher compressive stress, the cushioning layer may, for example, have increased density when the cushioning layer is a fiber-containing shaped material. By contrast, to shift a stress-strain curve (S-S curve) of the cushioning layer to provide a higher compressive strain and lower compressive stress, the cushioning layer may, for example, have reduced density when the cushioning layer is a fiber-containing shaped material.

To shift a stress-strain curve (S-S curve) of the cushioning layer to provide a lower compressive strain and a higher compressive stress, the cushioning layer may, for example, have increased density when the cushioning layer is a fiber-containing shaped material. By contrast, to shift a stress-strain curve (S-S curve) of the cushioning layer to provide a higher compressive strain and lower compressive stress, the cushioning layer may, for example, have reduced density when the cushioning layer is a fiber-containing shaped material.

When a stress-strain curve derived by the compression test passes a region enclosed by Formula (b1-1) and Formula (b1-2) (Region (b1)), preferably a region enclosed by Formula (b2-1) and Formula (b2-2) (Region (b2)), more preferably a region enclosed by Formula (b3-1) and Formula (b3-2) (Region (b3)), even more preferably a region enclosed by Formula (b4-1) and Formula (b4-2) (Region (b4)), the cushioning layer is more likely to provide a thermal insulating material with a good thermal insulating property and cushioning property (e.g., good compression properties in a loading-unloading test under a high-pressure condition described later), in combination with a thermal insulating layer containing inorganic particles. On the other hand, when a stress-strain curve derived by the compression test passes a region enclosed by Formula (b5-1) and Formula (b5-2) (Region (b5)), preferably a region enclosed by Formula (b6-1) and Formula (b6-2) (Region (b6)), more preferably a region enclosed by Formula (b7-1) and Formula (b7-2) (Region (b7)), even more preferably a region enclosed by Formula (b8-1) and Formula (b8-2) (Region (b8)), the cushioning layer is more likely to provide a thermal insulating material with a good thermal insulating property and cushioning property (e.g., good compression properties in a loading-unloading test under a low-pressure condition described later), in combination with a thermal insulating layer containing inorganic particles.

The thermal insulating layer is not particularly limited except that it contains inorganic particles. In some embodiments of the thermal insulating material disclosed hereby, the thermal insulating layer in the thermal insulating material is preferably a layer capable of generating a compressed state with a compressive strain value x_{B} [%] and a compressive stress value y_{B} [MPa] satisfying the following Formula (a1-1) and the following Formula (a1-2), in a compression test at a compression rate of 0.5 mm/min only for the thermal insulating layer. In other words, a stress-strain curve derived by the compression test preferably passes a region enclosed by Formula (a1-1) and Formula (a1-2) (Region (a1)).

0.50≤y_{A}≤3.45 Formula (a1-1)

0.12x_{A}−2.45≤y_{A} Formula (a1-2)

When the thermal insulating layer is a layer capable of generating such a compressed state, a better thermal insulating property is provided more easily. When the thermal insulating layer is harder, i.e., has a lower compressive strain and a higher compressive stress, there is a tendency that a good thermal insulating property is provided more easily. Thus, acquiring a sufficient cushioning property in the aforementioned cushioning layer allows utilization of a thermal insulating layer more dedicated to providing a thermal insulating property, and consequently produces a thermal insulating material with a preferred thermal insulating property and cushioning property.

The left side of Formula (a1-2) “0.12x_{A}−2.45” represents a line connecting a point with a compressive strain value of “25%” and a compressive stress value of “0.50 MPa”, and a point with a compressive strain value of “50%” and a compressive stress value of “3.45 MPa”. These points provide a slope of “0.12” and an intercept of “−2.45” through calculation.

The thermal insulating layer is more preferably a layer capable of generating a compressed state with a compressive strain value x_{A} [%] and a compressive stress value y_{A} [MPa] satisfying the following Formula (a2-1) and the following Formula (a2-2) in the compression test described above.

1.00≤y_{A}≤3.00 Formula (a2-1)

0.20x_{A}−3.00≤y_{A} Formula (a2-2)

When the thermal insulating layer is a layer capable of generating such a compressed state, a better thermal insulating property is provided more easily.

The left side of Formula (a2-2) “0.20x_{A}−3.00” represents a line connecting a point with a compressive strain value of “20%” and a compressive stress value of “1.00 MPa”, and a point with a compressive strain value of “30%” and a compressive stress value of “3.00 MPa”. These points provide a slope of “0.20” and an intercept of “−3.00” through calculation.

The thermal insulating layer is more preferably a layer capable of generating a compressed state with a compressive strain value x_{A} [%] and a compressive stress value y_{A} [MPa] satisfying the following Formula (a3-1) and the following Formula (a3-2) in the compression test described above.

1.50≤y_{A}≤2.50 Formula (a3-1)

0.20x_{A}−1.50≤y_{A} Formula (a3-2)

When the thermal insulating layer is a layer capable of generating such a compressed state, a better thermal insulating property is provided more easily.

The left side of Formula (a3-2) “0.20x_{A}−1.50” represents a line connecting a point with a compressive strain value of “15%” and a compressive stress value of “1.50 MPa”, and a point with a compressive strain value of “20%” and a compressive stress value of “2.50 MPa”. These points provide a slope of “0.20” and an intercept of “−1.50” through calculation.

Additionally, in some other embodiments of the thermal insulating material disclosed hereby, a thermal insulating layer in the thermal insulating material is preferably a layer capable of generating a compressed state with a compressive strain value x_{A} [%] and a compressive stress value y_{A} [MPa] satisfying the following Formula (a 4-1) and the following Formula (a4-2) in a compression test at a compression rate of 0.5 mm/min only for the thermal insulating layer.

0.10≤y_{A}≤1.39 Formula (a4-1)

0.043x_{A}−0.545≤y_{A} Formula (a4-2)

When the thermal insulating layer is a layer capable of generating such a compressed state, a better thermal insulating property is provided more easily. When the thermal insulating layer is harder, i.e., has a lower compressive strain and a higher compressive stress, there is a tendency that a good thermal insulating property is provided more easily. Thus, acquiring a sufficient cushioning property in the aforementioned cushioning layer allows utilization of a thermal insulating layer more dedicated to providing a thermal insulating property, and consequently produces a thermal insulating material with a preferred thermal insulating property and cushioning property.

The left side of Formula (a4-2) “0.043x_{A}−0.545” represents a line connecting a point with a compressive strain value of “15%” and a compressive stress value of “0.10 MPa”, and a point with a compressive strain value of “45%” and a compressive stress value of “1.39 MPa”. These points provide a slope of “0.043” and an intercept of “−0.545” through calculation.

The thermal insulating layer is more preferably a layer capable of generating a compressed state with a compressive strain value x_{A} [%] and a compressive stress value y_{A} [MPa] satisfying the following Formula (a5-1) and the following Formula (a5-2) in the compression test described above.

0.20≤y_{A}≤1.10 Formula (a5-1)

0.09x_{A}−1.15≤y_{A} Formula (a5-2)

When the thermal insulating layer is a layer capable of generating such a compressed state, a better thermal insulating property is provided more easily.

The left side of Formula (a5-2) “0.09x_{A}−1.15” represents a line connecting a point with a compressive strain value of “15%” and a compressive stress value of “0.20 MPa”, and a point with a compressive strain value of “25%” and a compressive stress value of “1.10 MPa”. These points provide a slope of “0.09” and an intercept of “−1.15” through calculation.

The thermal insulating layer is even more preferably a layer capable of generating a compressed state with a compressive strain value x_{A} [%] and a compressive stress value y_{A} [MPa] satisfying the following Formula (a6-1) and the following Formula (a6-2) in the compression test described above.

0.30≤y_{A}≤0.90 Formula (a6-1)

0.12x_{A}−0.90≤y_{A} Formula (a6-2)

When the thermal insulating layer is a layer capable of generating such a compressed state, a better thermal insulating property is provided more easily.

The left side of Formula (a6-2) “0.12x_{A}−0.90” represents a line connecting a point with a compressive strain value of “10%” and a compressive stress value of “0.30 MPa”, and a point with a compressive strain value of “15%” and a compressive stress value of “0.90 MPa”. These points provide a slope of “0.12” and an intercept of “−0.90” through calculation.

To shift a stress-strain curve (S-S curve) of the thermal insulating layer to provide a lower compressive strain and a higher compressive stress, the thermal insulating layer may, for example, have increased density when the thermal insulating layer is a shaped material shaped from a mixture containing inorganic particles and inorganic fiber. By contrast, to shift a stress-strain curve (S-S curve) of the thermal insulating layer to provide a higher compressive strain and lower compressive stress, the thermal insulating layer may, for example, have reduced density when the thermal insulating layer is a shaped material shaped from a mixture containing inorganic particles inorganic fiber.

When a stress-strain curve derived by the compression test passes a region enclosed by Formula (a1-1) L Formula (a1-2) (Region (a1)), preferably a region enclosed by Formula (a2-1) and Formula (a2-2) (Region (a2)), more preferably a region enclosed by Formula (a3-1) and Formula (a3-2) (Region (a3)), the thermal insulating layer is more likely to provide a thermal insulating material with a good thermal insulating property and cushioning property (e.g., good compression properties in a loading-unloading test under a high-pressure condition described later), in combination with a cushioning layer in which the stress-strain curve passes Region (b1) (preferably Region (b2), more preferably Region (b3), even more preferably Region (b4)). On the other hand, when a stress-strain curve derived by the compression test passes a region enclosed by Formula (a4-1) L Formula (a4-2) (Region (a4)), preferably a region enclosed by Formula (a5-1) and Formula (a5-2) (Region (a5)), more preferably a region enclosed by Formula (a6-1) and Formula (a6-2) (Region (a6)), the thermal insulating layer is more likely to provide a thermal insulating material with a good thermal insulating property and cushioning property (e.g., good compression properties in a loading-unloading test under a high-pressure condition described later) in combination with a cushioning layer in which the stress-strain curve passes Region (b5) (preferably Region (b6), more preferably Region (b7), even more preferably Region (b8)).

Hereinafter, detailed description will be made on “thermal insulating layer”, “cushioning layer”, and the like.

### (Thermal Insulating Layer)

The thermal insulating layer is a layer containing inorganic particles. As used herein, “a layer containing inorganic particles” means a material that contains at least inorganic particles as a component material and is formed into a layer. The type of the inorganic particles is not particularly limited, and examples thereof include silicon dioxide particles (silica), titanium oxide particles, zinc oxide particles, aluminum oxide particles, silicon carbide particles, titanic iron ore particles (ilmenite, FeTiO), zirconium silicate particles, iron (III) oxide particles, iron (II) oxide (wustite (FeO)) particles, magnetite particles (Fe₃O₄), hematite particles (Fe₂O₃)), chromium dioxide particles, zirconium oxide particles, manganese dioxide particles, zirconia sol, titania sol, silica sol, alumina sol, bentonite particles, and kaolin particles. Other examples of the inorganic particles include carbon-based particles such as graphite, carbon black, and carbon. The graphite preferably have a particle diameter of 18 μm or less. The type of the graphite for use can be any of flake, vein, spherical, isotropic (artificial), anisotropic (artificial), and the like in shape. Examples of flake graphite include BF-3AK, FBF, and BF-10AK (manufactured by Chuetsu Graphite Works Co., Ltd.); and GE-1, Z-5F, CNP7, and V-iOF (manufactured by Ito Graphite Co., Ltd.) Examples of vein graphite include HLP and SB-1 (manufactured by Chuetsu Graphite Works Co., Ltd.) Examples of spherical graphite include SG-BH8 (manufactured by Ito Graphite Co., Ltd.) Examples of the isotropic graphite (artificial) include AGB-5 (manufactured by Ito Graphite Co., Ltd.) Examples of anisotropic graphite (artificial) include AG-6T (manufactured by Ito Graphite Co., Ltd.) Examples of carbon black include TOKABLACK #5500 (manufactured by Tokai Carbon Co., Ltd.) and Mitsubishi carbon black MA100 (manufactured by Mitsubishi Chemical Group Corporation). The thermal insulating layer may contain one type of the inorganic particles, or two or more types of the inorganic particles. The inorganic particles can preferably reduce thermal radiation, more particularly have an absorption peak within the infrared region. The absorption peak within the infrared region can be measured with an infrared spectrophotometer. The inorganic particles may also function as a binder that binds inorganic fiber fibrils one another.

The inorganic particle content in the thermal insulating layer is not particularly limited, and is, e.g., 50% by mass to 99.5% by mass, preferably 60% by mass or more, more preferably 70% by mass or more, even more preferably 80% by mass or more, or preferably 95% by mass or less, more preferably 90% by mass or less, even more preferably 85% by mass or less in the thermal insulating layer. When the inorganic particle content falls within these ranges, a good thermal insulating property and a mechanical strength are provided more easily.

The thermal insulating layer preferably contains silicon dioxide (silica, SiO₂) as the inorganic particles. Silicon dioxide can be classified into crystalline silica, amorphous silica, and the like for structural characteristics, and into natural silica, synthetic silica, and the like depending on a way of acquisition. Furthermore, synthetic silica can be classified into dry silica, wet silica, silica aerogel, and the like depending on a production method; dry silica can be further classified into silica produced by combustion, silica produced by arc discharge, and the like, and wet silica can be classified into silica produced by gelling, silica produced by precipitation, and the like. The type of the silicon dioxide particles is not particularly limited, and is preferably dry silica or silica aerogel. As a type of dry silica, fumed silica is more preferred; among fumed silica, hydrophilic fumed silica is particularly preferred. The hydrophilic fumed silica refers to fumed silica majorly having hydrophilic silanol groups (Si—OH) on a surface, and generally refers to fumed silica having silanol groups not substituted with hydrophobic groups by surface treatment or the like. The silicon dioxide particles can generally be present as aggregates derived by aggregation of primary particles, or as conglomerated particles derived by further aggregation of the aggregates. In the thermal insulating layer disclosed herein, the silicon dioxide particles may be dispersed in form of primary particles, aggregates, conglomerated particles, or combination thereof.

The average primary particle diameter of the silicon dioxide particles is not particularly limited, and is, e.g., 1 nm to 100 nm, preferably 2 nm or more, more preferably 4 nm or more, and preferably 80 nm or less, more preferably 40 nm or less, even more preferably 30 nm or less, particularly preferably 20 nm or less. When the silicon dioxide particles are fumed silica, the average primary particle diameter is, e.g., 1 nm to 40 nm, preferably 2 nm or more, more preferably 4 nm or more, and preferably 30 nm or less, more preferably 20 nm or less, even more preferably 18 nm or less. When the silicon dioxide particles are silica aerogel, the average primary particle diameter is, e.g., 1 nm to 20 nm, preferably 18 nm or less, more preferably 10 nm or less. When the silicon dioxide particles has an average primary particle diameter within these ranges, the good thermal insulating property is provided more easily. Examples of a method of obtaining the average primary particle diameter of the silicon dioxide particles include a measurement method with use of an electron microscope such as a scanning electron microscope (SEM) or a transmission scanning electron microscope (TEM). A particular example is a method of randomly selecting silicon dioxide particles under an electron microscope, measuring their particle diameters, and calculating an average value of the numerical values thus obtained. A particle diameter to be employed is a diameter in a spherical particle, an intermediate value between a minor axis and a mayor axis in an elliptical particle, or an intermediate value between a short side and a long side in an indeterminate-shaped particle.

The average particle diameter of secondary aggregates (aggregates of primary particles) of the silicon dioxide particles is not particularly limited, and is, e.g., 0.1 μm to 100 μm, preferably 1 μm or more, more preferably 2 μm or more, and preferably 90 μm or less, more preferably 80 μm or less. Examples of a method of obtaining the average particle diameter of secondary aggregates of the silicon dioxide particles include a measurement method with use of the same method as for the primary particle diameter.

The BET specific surface area of the silicon dioxide particles is, e.g., 90 m²/g or more and less than 380 m²/g, preferably 130 m²/g or more, more preferably 175 m²/g or more, even more preferably 200 m²/g or more, and preferably 350 m²/g or less, more preferably 320 m²/g or less, even more preferably 200 m²/g or less. When the silicon dioxide particles has a BET specific surface area within these range, the thermal insulating property is also provided more easily under high-temperature and high-humidity conditions. The BET specific surface area can be measured by a multipoint nitrogen absorption (BET) technique in accordance with a measurement method conforming to the International Organization for Standardization (ISO) 5794/1. For example, “AEROSIL 380” manufactured by Nippon AEROSIL Co., Ltd. has a BET specific surface area of 380 m²/g as the nominal value, and is written as 350 m²/g to 410 m²/g in consideration of an error. In such a case, the nominal value of 380 m²/g is considered as a basis herein.

The apparent specific gravity of the silicon dioxide particles is not particularly limited, and is, e.g., 30 g/L to 130 g/L, preferably 40 g/L or more, more preferably 50 g/L or more, and preferably 100 g/L or less, more preferably 80 g/L or less, even more preferably 60 g/L or less. An exemplary method of obtaining the apparent specific gravity of the silicon dioxide particles is to determine a numerical value derived by filling the silicon dioxide particles in a container capable of measuring a volume such as a 250 mL graduated cylinder, measuring a filled mass (X g) and a filled volume (Y mL) of the silicon dioxide particles, and dividing the filled mass by the filled volume ([apparent specific gravity (g/L)]=X/Y×1000).

Examples of the silicon dioxide particles include hydrophilic fumed silica including AEROSIL series (manufactured by Nippon AEROSIL Co., Ltd.) such as AEROSIL 50, 90, 130, 200, 300, and 380, REOLOSIL series (manufactured by Tokuyama Corporation) such as QS-09, QS-10, QS-102, QS-20, QS-30, and QS-40, and HDK series (manufactured by Wacker Asahikasei Silicone Co., Ltd.) such as HDKV15, N20, T30, and T40; hydrophobic fumed silica including AEROSIL series (manufactured by Nippon AEROSIL Co., Ltd.) such as AEROSIL R972 and R976S, HDK series (manufactured by Wacker Asahikasei Silicone Co., Ltd.) such as HDK H15, H20, and H30; and silica aerogel including AIRLICA (manufactured by Tokuyama Corporation). The thermal insulating layer may contain one type of the silicon dioxide particles or two or more types of the silicon dioxide particles.

The silicon dioxide particle content in the thermal insulating layer is not particularly limited, and is, e.g., 50% or more (typically, 50% by mass to 99.5% by mass), preferably 60% by mass or more, more preferably 70% by mass or more, even more preferably 80% by mass or more, and preferably 95% by mass or less, more preferably 90% by mass or less, even more preferably 85% by mass or less. When the silicon dioxide particle content falls within these ranges, a good thermal insulating property and mechanical strength are provided more easily.

The thermal insulating layer may contain another component, as long as it is a layer containing the inorganic particles described above. In some embodiments, it is preferred to contain inorganic fiber. The type of the inorganic fiber is not particularly limited, and examples thereof include silica fiber, glass fiber, alumina fiber, silica-alumina fiber, silica-alumina-magnesia fiber, biosoluble inorganic fiber, glass fiber, zirconia fiber, alkaline earth metal silicate fiber, alkali earth silicate (AES) fiber, glass wool, rock wool, and basalt fiber. When the inorganic fiber is as listed above, thermostability is improved. The thermal insulating layer may contain one type of the inorganic fiber, or two or more types of the inorganic fiber.

The inorganic fiber content in the thermal insulating layer is not particularly limited, and is, e.g., 0.5% by mass to 50% by mass, preferably 1% by mass or more, more preferably 3% by mass or more, even more preferably 5% by mass or more, and preferably 40% by mass or less, more preferably 35% by mass or less, even more preferably 30% by mass or less. When the fiber content falls within these ranges, good thermal resistance is provided more easily, and the thermal insulating layer is produced more easily.

The average fiber length of the inorganic fiber in the thermal insulating layer is not particularly limited, and is, e.g., 0.05 mm to 50 mm, preferably 0.5 mm or more, more preferably 1.0 mm or more, even more preferably 2 mm or more, and preferably 35 mm or less, more preferably 30 mm or less, more preferably 25 mm or less, more preferably 13 mm or less, even more preferably 10 mm or less, and may be 8 mm or less, or 6 mm or less. When the fiber has an average fiber length within these ranges, the thermal insulating layer is produced easily.

The average fiber diameter of the inorganic fiber in the thermal insulating layer is not particularly limited, and is, e.g., 0.1 μm to 50 μm, preferably 1 μm or more, more preferably 5 μm or more, even more preferably 7 m or more, and preferably 25 μm or less, more preferably 20 μm or less, even more preferably 15 μm or less. When the fiber has an average fiber diameter within these ranges, a good thermal insulating property and mechanical strength are provided more easily.

The thermal insulating layer may contain organic fiber. Specific examples of the organic fiber include felt made of cellulose fiber, polyester, polypropylene, or the like. Use of the organic fiber may be advantageous in view of increase in a cushioning property, improvement in durability to repeated pressure fatigue, and the like. The organic fiber content in the thermal insulating layer can be appropriately set so as to provide a desired effect of use, and may be, e.g., more than 0 parts by mass, 1 part by mass or more, 4 parts by mass or more, 8 parts by mass or more, or 16 parts by mass or more relative to 100 parts by mass of inorganic fiber. Meanwhile, in some embodiments, in view of thermostability and the like, the organic fiber content in the thermal insulating layer is suitably less than 100 parts by mass, advantageously less than 50 parts by mass, and may be less than 20 parts by mass, less than 10 parts by mass, less than 5 parts by mass, or less than 1 part by mass relative to 100 parts by mass of inorganic fiber, or the thermal insulating layer may contain no organic fiber.

The thermal insulating layer may contain a binder in addition to the aforementioned inorganic particles as the other component. The thermal insulating layer may contain one type of binder, or two or more types of binders. Inclusion of a binder in the thermal insulating layer tend to improve morphological stability.

When the thermal insulating layer contains a binder, the type of the binder is not particularly limited, and can be classified into organic binders and inorganic binders. Specific examples of the organic binders include thermoplastic resins, thermoplastic elastomers, thermosetting resins, thermosetting elastomers, sugars, and water-soluble polymers. Specific examples of the inorganic binders include aluminum oxide, zirconium oxide, magnesium oxide, titanium oxide, and calcium oxide. When the binder is one of these substances, the morphological stability is effectively improved.

When the thermal insulating layer contains a binder, the binder content is not particularly limited, and is, e.g., 0.01% by mass to 10% by mass, preferably 0.05% by mass or more, more preferably 0.1% by mass or more, even more preferably 0.2% by mass or more, and preferably 5% by mass or less, more preferably 3% by mass or less, even more preferably 1% by mass or less in the thermal insulating layer. When the binder content falls within these ranges, the thermal insulating layer combines the thermal insulating property and the morphological stability more easily.

The thermal insulating layer is a layer containing the aforementioned inorganic fiber, and particularly, is preferably a shaped material shaped from a mixture containing inorganic particles and inorganic fiber. The shaped material shaped from a mixture containing inorganic particles and inorganic fiber makes combination of a thermal insulating property and a mechanical strength easier. Detailed description will be provided later for a method of mixing inorganic particles and inorganic fiber in the case of the thermal insulating layer being a shaped material shaped from a mixture containing the inorganic particles and the inorganic fiber.

The thickness of the thermal insulating layer is not particularly limited, and is, e.g., usually 0.5 mm to 10 mm, preferably 0.7 mm or more, more preferably 0.8 mm or more or 0.9 mm or more. In some embodiments, the thickness of the thermal insulating layer is preferably 1 mm or more, more preferably 1.5 mm or more, even more preferably 2 mm or more, and preferably 7 mm or less, more preferably 5 mm or less, even more preferably 3 mm or less. When the thermal insulating layer has a thickness within these ranges, a good thermal insulating property is provided more easily, and a need for the thermal insulating material to be larger can be eliminated. In some embodiments, the thickness of the thermal insulating layer may be less than 2 mm, less than 1.5 mm, 1.3 mm or less, 1 mm or less, or less than 1 mm. Providing the thermal insulating layer with a smaller thickness can make the thermal insulating material thinner or lighter. The thickness of the thermal insulating layer can exemplarily employ an average value of numerical values derived by measuring cross sections of the thermal insulating layer at several sites (e.g., 10 sites) with a thickness measuring instrument (e.g., the digital thickness gauge JAN-257 (gauge head: Φ20 mm) manufactured by Ozaki Mfg. Co., Ltd.)

The density of the thermal insulating layer is not particularly limited, and is, e.g., 0.2 g/cm³ to 0.5 g/cm³, preferably 0.3 g/cm³ or more, more preferably 0.35 g/cm³ or more, even more preferably 0.37 g/cm³ or more, and preferably 0.45 g/cm³ or less.

The thermal conductivity of the thermal insulating layer under a pressurized condition of 2 MPa at 80 °C is preferably 0.010 W/K·m or more, and preferably 0.3 W/K·m or less, more preferably 0.1 W/K·m or less, more preferably 0.08 W/K·m or less, more preferably 0.06 W/K·m or less, more preferably 0.055 W/K·m or less, more preferably 0.045 W/K·m or less, even more preferably 0.04 W/K·m or less. The thermal conductivity of the thermal insulating layer under a pressurized condition of 2 MPa at 600 °C is preferably 0.010 W/K·m or more, and preferably 0.3 W/K·m or less, more preferably 0.2 W/K·m or less, more preferably 0.1 W/K·m or less, more preferably 0.08 W/K·m or less, even more preferably 0.075 W/K·m or less.

When the thermal insulating layer is prepared so as to have a thickness of 2 mm without pressurization (initial thickness), the thermal resistance of the thermal insulating layer under a pressurized condition of 2 MPa at 80 °C is preferably 0.020 (K·m²)/W or more, more preferably 0.025 (K·m²)/W or more, more preferably 0.03 (K·m²)/W or more, even more preferably 0.035 (K·m²)/W or more, and preferably 0.1 (K·m²)/W or less. When the thermal insulating layer has an initial thickness of 2 mm, the thermal resistance of the thermal insulating layer under a pressurized condition of 2 MPa at 600 °C is preferably 0.010 (K·m²)/W or more, more preferably 0.015 (K·m²)/W or more, even more preferably 0.020 (K·m²)/W or more, and preferably 0.1 (K·m²)/W or less.

The thermal conductivity of the thermal insulating layer can be measured by the method described in Japanese Industrial Standards JIS A 1412-2: 1999, “Test Method for Thermal Resistance and Related Properties of Thermal Insulations-Part 2: Heat Flow Apparatus”.

The heat flow apparatus method (HFM method) is a secondary or comparative measurement method to measure heat-transfer properties, such as thermal conductivity and thermal resistance, by comparing a plane heat-insulating material (thermal insulating layer) of a sample and a standard plate. A procedure and conditions for the measurement will be described in detail as follows.

The thermal insulating layer is cut into a predetermined size (e.g., 20 mm×20 mm) as a sample, and a standard plate is prepared such as an alumina composite material (“RS-100” manufactured by ZIRCAR Refractory Composites, Inc.; thickness: 5 mm; thermal conductivity: 0.66 W/K·m). Subsequently, a first thermocouple, a titanium plate, the thermal insulating layer, a titanium plate, a second thermocouple, a standard plate, and a third thermocouple are stacked in this order from the top onto a surface of a lower disc of a pneumatic press, and the sample, the standard plate, the thermocouples, and the like are closely attached to one another between an upper disc and the lower disc. The upper disc and the lower disc are then heated at respective predetermined measurement temperatures, and a load is applied to pressurize the sample and the like to provide a predetermined measurement pressure using a pneumatic press.

The measurement temperature is exemplarily set to keep a temperature of 80 °C at an upper disc close to the first thermocouple, and a temperature of 30 °C at a lower disc close to the third thermocouple. Under a high-temperature condition, the measurement temperature is exemplarily set to keep a temperature of 600 °C at an upper disc close to the first thermocouple, and a temperature of 40 °C at a lower disc close to the third thermocouple.

The measurement pressure is exemplarily set to 2 MPa (load: 800 N). Measurement is continued under heating and pressurization until a detection temperature of each of the thermocouples is stable, and the thermal conductivity k1 of the thermal insulating layer can be calculated from the detection temperature of each of the thermocouples after stabilization of the temperature, the thickness of the thermal insulating layer at pressurization, the thermal conductivity of the standard plate, and the thickness of the standard plate at pressurization, according to Formula (I) as follows:

k1=k2×(L1×ΔT1)/(L2×ΔT2) (I)
wherein k1 is the thermal conductivity [W/(m·K)] of the thermal insulating layer, k2 is the thermal conductivity [W/(m·K)] of the standard plate, L1 is the pressurized thickness of the thermal insulating layer, L2 is the thickness of the standard plate, ΔT1 is temperature differential between the temperature of the second thermocouple and the temperature of the third thermocouple, and ΔT2 is temperature differential between the temperature of the first thermocouple and the temperature of the second thermocouple.

Stability of detection temperature exemplarily means that change in temperature between before and after a duration of 10 minutes falls within a predetermined range (e.g., within +0.1 °C).

The thermal resistance of the thermal insulating layer can be calculated from the thermal conductivity k1 and the pressurized thickness L1 described above, according to Formula (II) as follows:

R1=L1/k1 (II)
wherein R1 is the thermal resistance [(m²·K)/W] of the thermal insulating layer, k1 is the thermal conductivity [W/(m·K)] of the thermal insulating layer, and L1 is the pressurized thickness [m] of the thermal insulating layer.

In the thermal insulating layer forming the thermal insulating material disclosed herein in some embodiments of the thermal insulating material, when a compression test is performed at a compression rate of 0.5 mm/min only for the thermal insulating layer, a value of compressive strain at a compressive stress value of 3.45 MPa (hereinafter also referred to as “strain at a compression of 3.45 MPa”; the same applies to the same expression) may be, e.g., 55% or less or 50% or less, and in view of durability of the thermal insulating layer, prevention of generation of powder from the thermal insulating layer (e.g., generation of powder due to release of inorganic particles), or the like, it is advantageously 40% or less, preferably 35% or less or 30% or less, and may be 25% or less or 20% or less. The strain of the thermal insulating layer at a compression of 3.45 MPa is above 0%, and may be, e.g., 7% or more, and may be 10% or more, 12% or more, 15% or more, or 20% or more. When the strain at a compression of 3.45 MPa falls within any of the aforementioned ranges, the thermal insulating layer is likely to provide a thermal insulating material with a good thermal insulating property and cushioning property (e.g., good compression properties in a loading-unloading test under a high-pressure condition described later) in combination with any of the cushioning layers disclosed herein.

In some embodiments of the thermal insulating material disclosed herein, the strain at a compression of 1.39 MPa in the thermal insulating layer forming the thermal insulating material may be, e.g., 45% or less or 40% or less, and in view of durability, prevention of generation of powder, or the like, it is preferably 30% or less or 25% or less, advantageously 20% or less, and may be 18% or less, 15% or less, or 13% or less. The strain of the thermal insulating layer at a compression of 1.39 MPa is above 0%, and may be, e.g., 5% or more, and may be 7% or more, 10% or more, 12% or more, or 15% or more. When the strain at a compression of 1.39 MPa falls within any of the aforementioned ranges, the thermal insulating layer is likely to provide a thermal insulating material with a good thermal insulating property and cushioning property (e.g., good compression properties in one or both of a loading-unloading test under a high-pressure condition described later and a loading-unloading test under a low-pressure condition described later) in combination with any of the cushioning layers disclosed herein.

In some embodiments of the thermal insulating material disclosed herein, the strain at a compression of 1.00 MPa in the thermal insulating layer forming the thermal insulating material is suitably, e.g., 40% or less, preferably 25% or less or 20% or less, advantageously 18% or less, and may be 15% or less, 12% or less, or 10% or less. The strain of the thermal insulating layer at a compression of 1.00 MPa is above 0%, and may be, e.g., 4% or more, and may be 6% or more, 8% or more, 10% or more, or 12% or more. When the strain at a compression of 1.00 MPa falls within any of the aforementioned ranges, the thermal insulating layer is likely to provide a thermal insulating material with a good thermal insulating property and cushioning property (e.g., good compression properties in one or both of a loading-unloading test under a high-pressure condition and a loading-unloading test under a low-pressure condition described later) in combination with any of the cushioning layers disclosed herein.

In the thermal insulating layer forming the thermal insulating material disclosed herein in some embodiments of the thermal insulating material, the compressive strain at a 0.34 MPa is suitably 30% or less, preferably 20% or less, more preferably 15% or less. The strain of the thermal insulating layer at a compression of 0.34 MPa is above 0%, and may be, e.g., 3% or more, and may be 5% or more, 7% or more, or 9% or more. When the strain at a compression of 0.34 MPa falls within any of the aforementioned ranges, the thermal insulating layer is likely to provide a thermal insulating material with a good thermal insulating property and cushioning property (e.g., good compression properties in one or both of a loading-unloading test under a high-pressure condition and a loading-unloading test under a low-pressure condition described later) in combination with any of the cushioning layers disclosed herein.

The number of the thermal insulating layers is usually 1 or more, and usually 10 or less, preferably 7 or less, even more preferably 5 or less. The art disclosed herein can be preferably implemented in an embodiment where the number of the thermal insulating layers is 3 or less or 2 or less (typically, 1).

The thermal insulating layer may or may not be bonded to an adjacent layer with an adhesive or a pressure-sensitive adhesive (PSA), and is preferably unbonded with an adhesive or a PSA. Absence of bonding with an adhesive or a PSA, i.e., use of neither an adhesive nor a PSA, allows reduction in thermal conductivity as compared to use thereof.

The shape of the thermal insulating layer is not particularly limited. In planar view, the shape is, e.g., a polygon such as a tetragon, a circle, an oval, or the like. Examples of the tetragon include rectangles (including a square and a long rectangle).

### (Cushioning Layer)

The cushioning layer is a layer formed of a fiber-containing shaped material containing fiber (hereinafter sometimes omitted as “fiber-containing shaped material”) or a foamed shaped material containing foam (hereinafter sometimes omitted as “foamed shaped material”). As used herein, “a layer formed of a fiber-containing shaped material containing fiber” means a material that contains at least fiber as a component material and is shaped into a layer, and “a layer formed of a foamed shaped material containing foam” means a material that contains at least foam as a component material and is shaped into a layer. Hereinafter, detailed description will be made of a fiber-containing shaped material, a foamed shaped material, and the like.

In some embodiments, the cushioning layer is a shaped material containing fiber (fiber-containing shaped material). The thermal insulating layer described above is also preferably a shaped material shaped from a mixture containing inorganic particles and inorganic fiber. Thus, when the thermal insulating layer is such a shaped material, presence or absence of inorganic particles allows determination of distinction from a fiber-containing shaped material in the cushioning layer. That is, a layer containing inorganic particles can be determined as the thermal insulating layer, and a layer containing no inorganic particle and shaped with containing fiber can be determined as the cushioning layer. A fiber-containing shaped material in the cushioning layer is preferably a shaped material that contains no inorganic particle and is formed with containing fiber.

The type of fiber in the fiber-containing shaped material is not particularly limited, and can be classified into inorganic fiber and organic fiber in the same manner as for the thermal insulating layer. Specific examples include inorganic fiber such as glass wool, rock wool, and glass mat (glass needle mat), and organic fiber such as felt made of cellulose fiber, polyester, polypropylene; preferred is inorganic fiber, and particularly preferred is glass wool. Glass wool is a cured material containing fiber and thermosetting resin (e.g., a phenol binder) in which fiber fibrils are bonded to one another with thermosetting resin, and also has an effect to improve compressive stress and exert a cushioning function. The fiber-containing shaped material may contain one type of fiber, or two or more types of fiber. The fiber may assemble in form of any of nonwoven fabric, textile, knit, and the like, and usually takes a form of nonwoven fabric.

The fiber content in the fiber-containing shaped material is not particularly limited, and is, e.g., 50% by mass or more (typically, 50% by mass to 99% by mass), preferably 60% by mass or more, more preferably 70% by mass or more, even more preferably 80% by mass or more (e.g., 82% by mass), and preferably 97% by mass or less, more preferably 95% by mass or less, even more preferably 93% by mass or less. When the fiber content falls within these ranges, the fiber-containing shaped material is more likely to exert a cushioning property.

The average fiber length of fibers in the fiber-containing shaped material is not particularly limited, and is, e.g., 1 mm to 200 mm, preferably 5 mm or more, more preferably 10 mm or more, even more preferably 20 mm or more, and preferably 175 mm or less, more preferably 150 mm or less, even more preferably 125 mm or less. When the fibers have an average fiber length within these ranges, the cushioning property is more likely to be exerted.

The average fiber diameter of fibers in the fiber-containing shaped material is not particularly limited, and is, e.g., 3 μm to 13 μm, preferably 4 μm or more, more preferably 4.5 μm or more, even more preferably 5 μm or more, and preferably 10 μm or less, more preferably 9 μm or less, even more preferably 8 μm or less. When the fibers have an average fiber diameter within these ranges, the fiber-containing shaped material combines the cushioning property and low thermal conductivity more easily.

The fiber-containing shaped material preferably contains a binder in addition to fiber. The type of the binder in the fiber-containing shaped material is not particularly limited, and can be classified into organic binders and inorganic binders.

Specific examples of the organic binders include thermoplastic resins, thermoplastic elastomers, thermosetting resins, thermosetting elastomers, sugars, and water-soluble polymers. Specific examples of the inorganic binders include aluminum oxide, zirconium oxide, magnesium oxide, titanium oxide, and calcium oxide. When the binder is one of these substances, the morphological stability is improved. The thermal insulating layer may contain one type of binder, or two or more types of binders.

The binder content in the fiber-containing shaped material is not particularly limited, and is, e.g., 1% by mass to 50% by mass, preferably 2% by mass or more, more preferably 5% by mass or more, even more preferably 7% by mass or more, may be 10% by mass or more or 12% by mass or more, is also preferably 40% by mass or less, more preferably 30% by mass or less, even more preferably 20% by mass or less, and may be 18% by mass or less or 16% by mass or less. When the binder content falls within these ranges, low thermal conductivity and a better cushioning property are provided.

The fiber-containing shaped material is preferably a shaped material shaped from a mixture containing no hydrophilic fumed silica and further containing fiber and a binder. Examples of fiber to be used for the fiber-containing shaped material include a commercial product containing a thermosetting resin dispersed (attached to at least a part of fiber) as a binder, and such fiber can be cut into a form of interest, compressed with heating, and thereby formed into a fiber-containing shaped material.

The foamed shaped material is a shaped material containing foam. The material of the foam is usually a resin such as a thermoplastic resin or a thermosetting resin, and the foam can be shaped by appropriately employing a known shaping method and a condition thereof.

The type of resin of foam in the foamed shaped material is not particularly limited, and specific examples thereof include foamed forms that are formed of polyolefin-based resins such as polyethylene and polypropylene; polyethylene terephthalate resins; polyvinyl chloride resins (PVCs); styrene-based resins such as polystyrene; polyurethane-based resins such as polyurethan resins; resol phenolic resins such as phenolic resins (PFs), melamine-based resins such as melamine resins (MFs); epoxy-based resins such as epoxy resins (EPs); resins such as natural rubber (NR), styrene-butadiene rubber (SBR), chloroprene rubber (CR), nitrile rubber (NBR), and polyurethane.

The structure of cells in the foamed shaped material may be independent cells or continuous cells, and can be appropriately selected corresponding to a physical property of interest and the like.

The thickness of the cushioning layer is, e.g., 0.5 mm to 10 mm, preferably 1 mm or more, more preferably 1.5 mm or more, even more preferably 2 mm or more, and preferably 7 mm or less, more preferably 6 mm or less, even more preferably 5 mm or less. When the cushioning layer has a thickness within these ranges, a stress generated by battery expansion can be appropriately alleviated. As the thickness of the cushioning layer, the average value of numerical values can be employed that are derived by measuring the thickness of a cross-section of the cushioning layer with use of a thickness measuring device (the digital thickness gage JAN-257; gauge head: Φ20 mm; manufactured by Ozaki Mfg. Co., Ltd.) and further performing this measurement at any several sites (e.g., 10 sites) in the same manner as for the thermal insulating layer.

The thermal conductivity of the cushioning layer is not particularly limited. In some embodiments, the thermal conductivity of the cushioning layer under a condition of 80 °C and 2 MPa is preferably 0.030 W/K·m or more, more preferably 0.040 W/K·m or more, even more preferably 0.050 W/K·m or more, and preferably 0.2 W/K·m or less, more preferably 0.15 W/K·m or less, even more preferably 0.1 W/K·m or less. In some embodiments, the thermal conductivity of the cushioning layer under a condition of 600 °C and 2 MPa is preferably 0.04 W/K·m or more, more preferably 0.05 W/K·m or more, even more preferably 0.06 W/K·m or more, and preferably 0.30 W/K·m or less, more preferably 0.25 W/K·m or less, even more preferably 0.20 W/K·m or less. The thermal conductivity of the cushioning layer can be measured by the same method as the method of measuring thermal conductivity of the thermal insulating layer as described above.

The thermal resistance of the cushioning layer is not particularly limited. In some embodiments, the thermal resistance of the cushioning layer under a condition of 80 °C and 2 MPa is preferably 0.020 (K·m²)/W or more, more preferably 0.025 (K·m²)/W or more, even more preferably 0.03 (K·m²)/W or more, and preferably 0.07 (K·m²)/W or less, more preferably 0.06 (K·m²)/W or less, even more preferably 0.05 (K·m²)/W or less. In some embodiments, the thermal resistance of the cushioning layer under a condition of 600 °C and 2 MPa is preferably 0.001 (K·m²)/W or more, more preferably 0.003 (K·m²)/W or more, even more preferably 0.005 (K·m²)/W or more, and preferably 0.1 (K·m²)/W or less, more preferably 0.05 (K·m²)/W or less, even more preferably 0.01 (K·m²)/W or less. The thermal resistance can be measured by the same method as the method of measuring thermal resistance of the thermal insulating layer as described above.

In the cushioning layer forming the thermal insulating material disclosed herein in some embodiments of the thermal insulating material, when a compression test is performed at a compression rate of 0.5 mm/min only for the cushioning layer, a value of compressive strain at a compressive stress value of 3.45 MPa (hereinafter also referred to as “strain at a compression of 3.45 MPa”; the same applies to the same expression) may be, e.g., 25% or more, is advantageously 30% or more or 35% or more, preferably 40% or more, more preferably 45% or more, and may be 50% or more or 55% or more. The strain of the cushioning layer at a compression of 3.45 MPa may be, e.g., 90% or less, and may be 85% or less (e.g., less than 85%), 80% or less, or 75% or less. When the strain at a compression of 3.45 MPa falls within any of the aforementioned ranges, the cushioning layer is likely to provide a thermal insulating material with a good thermal insulating property and cushioning property (e.g., good compression properties in a loading-unloading test under a high-pressure condition described later) in combination with any of the thermal insulating layers disclosed herein.

In some embodiments of the thermal insulating material disclosed herein, the strain at a compression of 1.39 MPa in the cushioning layer forming the thermal insulating material may be, e.g., 25% or more, is advantageously 35% or more, preferably 45% or more, more preferably 50% or more or 55% or more, and may be 60% or more or 65% or more. The strain of the cushioning layer at a compression of 1.39 MPa may be, e.g., 90% or less, is preferably 80% or less, and may be 75% or less. When the strain at a compression of 1.39 MPa falls within any of the aforementioned ranges, the cushioning layer is likely to provide a thermal insulating material with a good thermal insulating property and cushioning property (e.g., good compression properties in a loading-unloading test under a high-pressure condition described later) in combination with any of the thermal insulating layers disclosed herein.

In some embodiments of the thermal insulating material disclosed herein, the strain at a compression of 1.00 MPa in the cushioning layer forming the thermal insulating material may be, e.g., 5% or more, is preferably 7% or more or 10% or more, and may be 15% or more, 20% or more, 25% or more, 30% or more, 35% or more, 40% or more, 50% or more, 55% or more, or 60% or more. The strain of the cushioning layer at a compression of 1.00 MPa may be, e.g., 85% or less, is preferably 80% or less, and may be 75% or less or 70% or less. When the strain at a compression of 1.00 MPa falls within any of the aforementioned ranges, the cushioning layer is likely to provide a thermal insulating material with a good thermal insulating property and cushioning property (e.g., good compression properties in one or both of a loading-unloading test under a high-pressure condition and a loading-unloading test under a low-pressure condition described later) in combination with any of the thermal insulating layers disclosed herein.

In some embodiments of the thermal insulating material disclosed herein, the strain at a compression of 0.34 MPa in the cushioning layer forming the thermal insulating material may be, e.g., 3% or more or 5% or more is preferably 10% or more, and may be 15% or more, 20% or more, 25% or more, 30% or more, 35% or more, 40% or more, or 45% or more. The strain of the cushioning layer at a compression of 0.34 MPa may be, e.g., 75% or less, is preferably 70% or less, and may be 65% or less, 60% or less, 50% or less, 40% or less, 35% or less, 25% or less, or 20% or less. When the strain at a compression of 0.34 MPa falls within any of the aforementioned ranges, the cushioning layer is likely to provide a thermal insulating material with a good thermal insulating property and cushioning property (e.g., good compression properties in one or both of a loading-unloading test under a high-pressure condition and a loading-unloading test under a low-pressure condition described later) in combination with any of the thermal insulating layers disclosed herein.

In some embodiments of the thermal insulating material disclosed herein, the ratio of the strain of the cushioning layer at a compression of 0.34 MPa [%] to the strain of the thermal insulating layer at a compression of 0.34 MPa [%](i.e., a ratio of strains at a compression of 0.34 MPa (cushioning layer/thermal insulating layer)) is suitably 0.5 or more, advantageously 0.75 or more, preferably 1.0 or more (e.g., more than 1.0). Combination of the thermal insulating layer and the cushioning layer to satisfy such a ratio of strains at a compression of 0.34 MPa (cushioning layer/thermal insulating layer) is likely to provide the thermal insulating material with a good thermal insulating property and cushioning property (e.g., good compression properties in one or both of a loading-unloading test under a high-pressure condition and a loading-unloading test under a low-pressure condition described later). In view of ease of providing a thermal insulating material exhibiting a better compression property in a loading-unloading test under a low-pressure condition, in some embodiments, the ratio of strains at a compression of 0.34 MPa (cushioning layer/thermal insulating layer) is preferably 2.0 or more, more preferably 3.0 or more, and may be 3.5 or more or 4.0 or more.

In some embodiments of the thermal insulating material disclosed herein, the ratio of the strain of the cushioning layer at a compression of 1.00 MPa [%] to the strain of the thermal insulating layer at a compression of 1.00 MPa [%](i.e., a ratio of strains at a compression of 1.00 MPa (cushioning layer/thermal insulating layer)) is suitably 0.5 or more, advantageously 0.75 or more, preferably 1.0 or more (e.g., more than 1.0). Combination of the thermal insulating layer and the cushioning layer to satisfy such a ratio of strains at a compression of 1.00 MPa (cushioning layer/thermal insulating layer) is likely to provide the thermal insulating material with a good thermal insulating property and cushioning property (e.g., good compression properties in one or both of a loading-unloading test under a high-pressure condition and a loading-unloading test under a low-pressure condition described later). In view of ease of providing a thermal insulating material exhibiting a better compression property in a loading-unloading test under a low-pressure condition, in some embodiments, the ratio of strains at a compression of 1.00 MPa (cushioning layer/thermal insulating layer) is preferably 2.0 or more, more preferably 3.0 or more, and may be 3.5 or more or 4.0 or more.

In some embodiments of the thermal insulating material disclosed herein, the ratio of the strain of the cushioning layer at a compression of 1.39 MPa [%] to the strain of the thermal insulating layer at a compression of 1.39 MPa [%](i.e., a ratio of strains at a compression of 1.39 MPa (cushioning layer/thermal insulating layer)) is suitably 0.5 or more, advantageously 0.75 or more, preferably 1.0 or more (e.g., more than 1.0). Combination of the thermal insulating layer and the cushioning layer to satisfy such a ratio of strains at a compression of 1.39 MPa (cushioning layer/thermal insulating layer) is likely to provide the thermal insulating material with a good thermal insulating property and cushioning property (e.g., good compression properties in one or both of a loading-unloading test under a high-pressure condition and a loading-unloading test under a low-pressure condition described later). In view of ease of providing a thermal insulating material exhibiting a better compression property in a loading-unloading test under a low-pressure condition, in some embodiments, the ratio of strains at a compression of 1.39 MPa (cushioning layer/thermal insulating layer) is preferably 2.0 or more, more preferably 3.0 or more, and may be 3.5 or more.

The number of the cushioning layers is usually 10 or less, preferably 5 or less, even more preferably 3 or less, and may be 2 or 1.

The cushioning layer may or may not be bonded to an adjacent layer with a PSA, and is preferably unbonded with an adhesive or a PSA. Absence of bonding with an adhesive or a PSA, i.e., use of neither an adhesive nor a PSA, allows reducing increase in thermal conductivity as compared to use thereof.

The shape of the cushioning layer is not particularly limited. In planar view, the shape is, e.g., a polygon such as a tetragon, a circle, an oval, or the like. Examples of the tetragon include rectangles (including a square and a long rectangle).

### (Covering Layer)

The thermal insulating material disclosed hereby preferably includes a covering layer. The covering layer is a layer that serves functions to prevent release of inorganic particles in the thermal insulating layer or other components, to protect the thermal insulating layer, and the like. For example, a covering layer formed with use of a resin film can be preferably employed.

The type of resin in the covering layer is not particularly limited, and specific example thereof include polyethylene terephthalate (PET), polybutylene terephthalate (PBT), polyimide (PI), flameproof polycarbonate (PC), breathable porous polyethylene (PE), flameproof polyethylene (PE), and biaxially oriented nylon film (Ny). The breathable porous PE preferably has a molecular weight of 1,000,000 to 7,000,000.

The thickness of the covering layer is not particularly limited, and is, e.g., 0.001 mm to 0.2 mm, preferably 0.005 mm or more, more preferably 0.007 mm or more, even more preferably 0.010 mm or more, and preferably 0.15 mm or less, more preferably 0.10 mm or less, even more preferably 0.050 mm or less. When the covering layer has a thickness within these ranges, low thermal conductivity and mechanical strength can be combined. Measurement of the thickness of the covering layer can be performed in the same manner as for the thermal insulating layer.

The number the covering layers is usually 1 or more, preferably 2 or more, and usually 5 or less, preferably 4 or less, even more preferably 3 or less. The 2 or more covering layers may be 2 or more resin films or a single resin film that is folded and inserted to provide a bilayer covering layer. In folding in such a way, the number of the covering layers is considered as two.

When the thermal insulating material includes two or more covering layers, the two or more covering layers may sandwich and enclose the thermal insulating layer among themselves in a thickness direction, and seal a gap between the covering layers (a space defined by the two or more covering layers). A method of sealing a gap between the covering layers is not particularly limited, and is, e.g., a process of providing sealing parts on the outer edges of the covering layers and attaching the sealing parts of the covering layers to one another. A method of attaching the sealing parts is also not particularly limited, and is, e.g., fusion with use of heat fusion, ultrasonic fusion, or the like, and gluing with use of an adhesive, a PSA, or the like. Fusion may be performed by directly fusing resins of the covering layers, or fusing them by providing another resin layer for fusion.

The covering layer may or may not be bonded to an adjacent thermal insulating layer with an adhesive or a PSA, and is preferably unbonded with an adhesive or a PSA.

When the thermal insulating material includes two or more covering layers that seal a gap between the covering layers, the covering layers preferably have a vent hole to connect the gap and an exterior space. Presence of the vent hole enables employing shrink packing or packing with use of a deep-drawing film as a packing method.

The number of vent holes in the covering layer is usually 1 or more, preferably 2 or more, and usually 50 or less, preferably 25 or less, even more preferably 10 or less.

The total opening area of vent holes in the covering layer is usually 0.000079 cm² to 10 cm², preferably 0.0001 cm² or more, more preferably 0.005 cm² or more, even more preferably 0.01 cm² or more, and preferably 5 cm² or less, more preferably 4 cm² or less, even more preferably 3 cm² or less. When the covering layer has a total opening area of vent holes within these ranges, outflow of powder from the thermal insulating layer is reduced easily.

A vent hole in the covering layer may be covered with a venting film. The ventilation rate of the venting film is usually 4 cm³/(cm²·s) to 500 cm³/(cm²·s), preferably 7 cm³/(cm²·s) or more, more preferably 10 cm³/(cm²·s) or more, even more preferably 21 cm³/(cm²·s) or more, and preferably 250 cm³/(cm²·s) or less, more preferably 200 cm³/(cm²·s) or less, even more preferably 100 cm³/(cm²·s) or less.

In the thermal insulating material disclosed herein, another factor is not particularly limited as long as it meets the aforementioned conditions. In some embodiments of the thermal insulating material disclosed herein, the thermal conductivity of the thermal insulating material under a condition of 80 °C and 2 MPa is preferably 0.02 W/K·m or more, more preferably 0.03 W/K·m or more, even more preferably 0.04 W/K·m or more, and preferably 0.2 W/K·m or less, more preferably 0.15 W/K·m or less, even more preferably 0.10 W/K·m or less. An exemplary method of measuring the thermal conductivity is measurement by the same method as for the thermal insulating layer.

When the thermal insulating material is prepared so as to have a thickness of 2 mm without pressurization, the thermal resistance of the thermal insulating material under a condition of 80 °C and 2 MPa is not particularly limited, and is preferably 0.01(K·m²)/W or more, more preferably 0.02(K·m²)/W or more, even more preferably 0.03(K·m²)/W or more, and preferably 0.10(K·m²)/W or less, more preferably 0.09(K·m²)/W or less, even more preferably 0.08(K·m²)/W or less. The thermal resistance of the thermal insulating material is measured by the same method as for the thermal insulating layer.

Preferably, with regard to the thermal insulating material disclosed herein, a loading-unloading test under a high-pressure condition performed by the method in the examples described later (i.e., Loading-unloading test 1) shows that a value derived by subtracting a compressive strain at a pressure of 0.34 MPa from a compressive strain at a pressure of 3.45 MPa in a compression process (strain difference (Xhp)) is 15% or more (more preferably 20% or more, even more preferably 25% or more), and that a value derived by subtracting a compressive strain at a compressed state in a compression releasing process that has the same displacement as that at a pressure of 0.34 MPa in the compression process from a compressive strain at a pressure of 3.45 MPa (strain difference (Xhr)) is 5% or more. More preferably, the strain difference (Xhp) is 30% or more, and the strain difference (Xhr) is 6% or more. When exhibiting these compression properties in a compression process and a compression releasing process in Loading-unloading test 1, the thermal insulating material is preferably used as, e.g. a thermal insulating material placed between cells in a battery module or the like to allow changing a thickness and providing a cushioning property capable of generating a more suitable stress corresponding to repetition of expansion and contraction of the cells.

In some embodiments, with regard to the thermal insulating material, a compressive strain at a pressure of 0.34 MPa in a compression process in the Loading-unloading test 1 is suitably 40% or less, advantageously 35% or less, preferably 30% or less (e.g., less than 30%), and may be 25% or less, 20% or less or 15% or less. In these embodiments, with regard to the thermal insulating material, the compressive strain at a pressure of 0.34 MPa is typically more than 0%, and may be 3% or more, 5% or more, or 10% or more. Furthermore, in the embodiments, with regards to the thermal insulating material, a compressive strain at a pressure of 3.45 MPa in a compression process in the Loading-unloading test 1 is suitably 20% or more, preferably 25% or more, more preferably 30% or more (e.g., less than 30%), and may be 35% or more, or 40% or more. In these embodiments, with regards to the thermal insulating material, the compressive strain at a pressure of 3.45 MPa may be, e.g., 70% or less, 65% or less, or 60% or less (e.g., less than 60%). When having compressive strains each falling within the aforementioned ranges at a pressure of 0.34 MPa and a pressure of 3.45 MPa in a compression process in Loading-unloading test 1, the thermal insulating material is likely to provide the preferred strain difference (Xhp) and/or strain difference (Xhr) described above.

Furthermore, preferably, with regard to the thermal insulating material disclosed herein, a loading-unloading test under a low-pressure condition performed by the method in the examples described later (i.e., Loading-unloading test 2) shows that a value derived by subtracting a compressive strain at a pressure of 0.03 MPa from a compressive strain at a pressure of 1.39 MPa in a compression process (strain difference (Xlp)) is 15% or more (more preferably 20% or more or 25% or more, even more preferably 30% or more), and that a value derived by subtracting a compressive strain at a compressed state in a compression releasing process that has the same displacement as that at a pressure of 0.03 MPa in the compression process from a compressive strain at a pressure of 1.39 MPa (strain difference (Xlr)) is 5% or more (more preferably 6% or more, even more preferably 8% or more or 10% or more). More preferably, the strain difference (Xlp) is 30% or more, and the strain difference (Xlr) is 6% or more (even more preferably 8% or more, e.g., 10% or more). When exhibiting these compression properties in a compression process and a compression releasing process in Loading-unloading test 2, the thermal insulating material is preferably used as, e.g. a thermal insulating material placed between cells in a battery module or the like to allow changing a thickness and providing a cushioning property capable of generating a more suitable stress corresponding to repetition of expansion and contraction of the cells.

In some embodiments, with regard to the thermal insulating material, a compressive strain at a pressure of 0.03 MPa in a compression process in the Loading-unloading test 2 is suitably 40% or less, advantageously 35% or less, preferably 30% or less (e.g., less than 30%), and may be 25% or less, 20% or less or 15% or less. In these embodiments, with regard to the thermal insulating material, the compressive strain at a pressure of 0.03 MPa is typically more than 0%, and may be 3% or more, 5% or more, or 10% or more. Furthermore, in the embodiments, with regards to the thermal insulating material, a compressive strain at a pressure of 1.39 MPa in a compression process in the Loading-unloading test 2 is suitably 20% or more, preferably 30% or more (e.g., less than 30%), and may be 40% or more, 50% or more, or 55% or more. In these embodiments, with regards to the thermal insulating material, the compressive strain at a pressure of 1.39 MPa may be, e.g., 90% or less, 85% or less, 80% or less, 70% or less, or 60% or less (e.g., less than 60%). When having compressive strains each falling within the aforementioned ranges at a pressure of 0.03 MPa and a pressure of 1.39 MPa in a compression process in Loading-unloading test 2, the thermal insulating material is likely to provide the preferred strain difference (Xlp) and/or strain difference (Xlr) described above.

The thermal insulating material disclosed herein has no particular limitation in application and can be appropriately used for a known application with use of the thermal insulating material. In some embodiments, the thermal insulating material is preferably used as thermal insulating material provided between cells of a battery module, particularly preferably as thermal insulating material placed between cells of a lithium ion battery module.

FIG. 2 is a perspective view schematically illustrating an exemplary battery module in which a thermal insulating material of an embodiment of the present invention is placed between cells, and FIG. 3 is a cross-sectional view thereof taken along the line II-II. As shown in FIG. 2, a battery module 50 includes a plurality of battery cells 51 (rectangular cells in the figures) arranged in a thickness direction, and the thermal insulating material 52 is placed between each couple of the battery cells 51. The plurality of the battery cells 51, arranged with holding the thermal insulating material 52 between each couple of themselves in this manner, is usually used with being constrained under application of suppress strength (compression force) in a thickness direction via constraint plates 52a and 52a placed on both ends and contained in a battery case 53.

As shown in FIG. 3, the thermal insulating material 52 has a configuration in which a thermal insulating layer 521 and cushioning layers 522 are stacked and further sandwiched between and enclosed with two resin films (a bilayer covering layer) 523A and 523B in a thickness direction. The resin films 523A and 523B are sealed by adhesion (e.g., heat fusion) at sealing parts provided along outer edges of the films, and combine together to form a covering material 523. Having such a configuration, the thermal insulating material 52 is inserted between neighboring two battery cells 51 and 51, thereby exerting an effect to provide thermal insulating between opposed faces 51a and 51a on the two battery cells 51 and 51. FIG. 3 depicts a configuration in which two cushioning layers 522A and 522B are stacked and arranged within the covering material 523, but the number of cushioning layers may be one or two or more, and two or more cushioning layers may be placed separately on both side of a thermal insulating layer. Likewise, FIG. 3 depicts a configuration including only one thermal insulating layer 521, but the number of thermal insulating layers may be two or more. A cushioning layer may be placed outside a covering material, and a plurality of cushioning layers may be placed separately inside and outside a covering material. The covering material 523 may include a vent hole.

Some possible embodiments of the thermal insulating material will be illustrated in more detail.

FIG. 4 is a perspective view schematically illustrating a thermal insulating material according to an embodiment, and FIG. 5 is a cross-sectional view taken along the line IV-IV in FIG. 4. A thermal insulating material 1 has a configuration in which a thermal insulating layer 10 formed of two thermal insulating layers 10A and 10B is placed on one face 20a of a cushioning layer 20 to form a stack that is sandwiched between and enclosed with two resin films 31A and 31B (a bilayer covering layer) in a thickness direction, as shown in FIG. 5. The resin films 31A and 31B are sealed by adhesion (e.g., heat fusion) at sealing parts 32 provided along the outer edge of the films, and combine together to form a covering material 30. The resin film 31A is shaped into a protrusion form largely covering an end face of a stack of the thermal insulating layer 10 and the cushioning layer 20, and a vent hole (through hole) 33 is formed on a part covering the end face. An opening of the vent hole 33 to the outside includes a venting film 34 for preventing outflow of powder from the thermal insulating layer. When the thermal insulating material 1 is placed, e.g., between cells in a battery module including a plurality of cells arranged in a thickness direction, the thermal insulating material 1 may be used with being placed in such a manner that the Z-direction depicted in FIG. 5 (a thickness direction of the thermal insulating material 1) is a direction of arrangement of the cells, and that the Y-direction is a direction for removing an electrode of each of the cells, i.e., in such a manner that that a direction of an opening of a vent hole in the thermal insulating material 1 (X-direction) is not identical with a direction for removing an electrode of each of the cells.

FIG. 6 is a cross-sectional view schematically illustrating a thermal insulating material according to another embodiment. In this embodiment, two thermal insulating layers 10A and 10B forming a thermal insulating layer 10 are stacked separately on a first face 20a and a second face 20b of a cushioning layer 20. Having such a configuration, the thermal insulating material 1 has high structural symmetry along a thickness direction, also facilitates reducing difference in temperature between both faces, and thus can be advantageous in view of preventing deformation (e.g., warp deformation) of the thermal insulating material. In addition, as seen in the exemplary embodiment shown in FIG. 7, the cushioning layer 20 may have a stack structure formed of two layers of cushioning layers 20A and 20B, or a stack structure formed of three or more layers. An inner face 10a of the thermal insulating layer 10A and a buffer layer 20 may or may not be bonded. The same applies to bonding of an inner face of the thermal insulating layer 10B and the buffer layer 20.

FIG. 8 is a cross-sectional view schematically illustrating a thermal insulating material according to another embodiment. In this embodiment, while a thermal insulating layer 10 is enclosed with a covering material 30, a buffer layer 20 is placed outside the covering material 30. In particular, one face 20a of the buffer layer 20 is fixed to one face of the covering material 30 via an adhesive layer 40 formed of an adhesive or a PSA. The thermal insulating material disclosed herein can also be implemented in such an embodiment.

A cell of interest is not limited to a rectangular cell, and may be any of, e.g., a laminated cell and a cylindrical cell. The shape of the thermal insulating material can be appropriately employed corresponding to the type of a cell.

Examples of a device to be equipped with a battery include electric conveyances such as electric vehicles (EVs), hybrid vehicles (HVs), and plug-in hybrid vehicles (PHVs); mobile electronics such as mobile terminals, mobile phones, and laptop PCs; and wearable devices.

### (Production Method of Thermal Insulating Material)

A method of producing a thermal insulating material is not particularly limited, can be carried out by appropriately employing a known step, and is, e.g., a production method including the following steps:
Thermal insulating layer preparation step: a step of preparing a thermal insulating layer containing inorganic particles;
Cushioning layer preparation step: a step of preparing a cushioning layer formed of a fiber-containing shaped material containing fiber and a foamed shaped material containing foam; and
Stacking step: a step of stacking component layers including the thermal insulating layer prepared in the thermal insulating layer preparation step and the cushioning layer preparing in the cushioning layer preparation step.

The thermal insulating layer preparation step, the cushioning layer preparation step, and the stacking step may be performed in parallel with another step or in sequence, on a time-series basis, as long as they do not follow a preceding step.

In some embodiments, the cushioning layer preparation step may include selecting a cushioning layer that provides a stress-strain curve passing the aforementioned Region (b1) (preferably Region (b2), more preferably Region (b3), even more preferably Region (b4)) or passing the aforementioned Region (b5) (preferably Region (b6), more preferably Region (b7), even more preferably Region (b8)), in a compression test at a compression rate of 0.5 mm/min performed only for a cushioning layer. Accordingly, the specification provides a method of producing a thermal insulating material including: selecting a cushioning layer passing a predetermined region in a graph with strain on the x-axis and stress on the y-axis, in a compression test at a compression rate of 0.5 mm/min performed only for a cushioning layer; and stacking a thermal insulating layer containing inorganic particles and the cushioning layer.

In some embodiments, the thermal insulating layer preparation step may include selecting a thermal insulating layer that provides a stress-strain curve passing the aforementioned Region (a1) (preferably Region (a2), more preferably Region (a3)) or passing the aforementioned Region (a4) (preferably Region (a5), more preferably Region (a6)), in a compression test at a compression rate of 0.5 mm/min performed only for a thermal insulating layer. Accordingly, the specification provides a method of producing a thermal insulating material including: selecting a cushioning layer passing a predetermined region in a graph with strain on the x-axis and stress on the y-axis, in a compression test at a compression rate of 0.5 mm/min performed only for a cushioning layer; selecting a thermal insulating layer passing a predetermined region in a graph with strain on the x-axis and stress on the y-axis, in a compression test at a compression rate of 0.5 mm/min performed only for a thermal insulating layer; and stacking the thermal insulating layer and the cushioning layer. Furthermore, a method of designing a thermal insulating layer including: selecting the cushioning layer and selecting the thermal insulating layer is provided.

Additionally, in some embodiments, the cushioning layer preparation step can include selecting a cushioning layer in which at least one of a strain at a compression of 0.34 MPa, a strain at a compression of 1.00 MPa, a strain at a compression of 1.39 MPa, and a strain at a compression of 3.45 MPa falls within any of the ranges disclosed hereby. For example, in production or design of a thermal insulating material that exhibits a good compression property in the loading-unloading test under a high-pressure condition described later (i.e., Loading-unloading test 1), it is preferred to select a cushioning layer in which at least values of strains at a compression of 0.34 MPa and at a compression of 3.45 MPa falls within any of the ranges disclosed hereby. Furthermore, in production or design of a thermal insulating material that exhibits a good compression property in the loading-unloading test under a low-pressure condition described later (i.e., Loading-unloading test 2), it is preferred to select a thermal insulating layer in which at least values of strains at a compression of 0.34 MPa and at a compression of 1.39 MPa falls within any of the ranges disclosed hereby.

In some embodiments, the thermal insulating layer preparation step can include selecting a thermal insulating layer in which at least one of a strain at a compression of 0.34 MPa, a strain at a compression of 1.00 MPa, a strain at a compression of 1.39 MPa, and a strain at a compression of 3.45 MPa falls within any of the ranges disclosed hereby. For example, in production or design of a thermal insulating material that exhibits a good compression property in the loading-unloading test under a high-pressure condition described later (i.e., Loading-unloading test 1), it is preferred to select a thermal insulating layer in which at least values of strains at a compression of 0.34 MPa and at a compression of 3.45 MPa falls within any of the ranges disclosed hereby. Furthermore, in production or design of a thermal insulating material that exhibits a good compression property in the loading-unloading test under a low-pressure condition described later (i.e., Loading-unloading test 2), it is preferred to select a thermal insulating layer in which at least values of strains at a compression of 0.34 MPa and at a compression of 1.39 MPa falls within any of the ranges disclosed hereby. In some embodiments, furthermore, it is more preferred to produce or design a thermal insulating material in consideration of the strain ratio at a compression of 0.34 MPa (cushioning layer/thermal insulating layer) and the strain ratio at a compression of 1.39 MPa (cushioning layer/thermal insulating layer) described above.

Hereinafter, detailed description will be made of each step of the thermal insulating layer preparation step, the cushioning layer preparation step, and the stacking step.

A method of preparing a thermal insulating layer in the thermal insulating layer preparation step is not particularly limited, and a conventional thermal insulating material may be obtained as the thermal insulating layer, or the thermal insulating layer may be produced in the preparation step. When the thermal insulating layer is a layer shaped from a mixture containing inorganic particles and inorganic fiber, mixing can be performed with employing a known mixing method such as a dry process or a wet process. Examples of the production method with a wet process include a production method including the following steps:
Mixing step: a step of mixing inorganic particles and inorganic fiber in a solvent to prepare a mixture liquid;
Applying step: a step of applying the mixture liquid prepared in the mixing step to provide an applied film; and
Applied film shaping step: a step of shaping the applied film provided in the applying step to provide a thermal insulating layer.

The mixing step is a step of mixing inorganic particles and inorganic fiber in a solvent to provide a mixture liquid; this is a so-called wet process, particularly a step of mixing inorganic particles and inorganic fiber in a solvent to prepare a mixture liquid (a slurry form). Mixing in the mixing step uses, e.g., a dispersing propeller mixer, LABO PLASTOMILL, TRI-MIX, a planetary mixer, or a kneader.

The type of the solvent is not particularly limited, and examples thereof include protic solvents such as alcohol, amide, and water; and non-protic solvents such as ester, ketone, nitrile, and ether.

The surface tension of the solvent is not particularly limited, e.g., 20 mN/m to 73 mN/m, preferably 21 mN/m or more, preferably 50 mN/m or less, more preferably 40 mN/m or less, even more preferably 30 mN/m or less. When the solvent has a surface tension within these ranges, the thermal insulating property and the mechanical strength are better improved. An exemplary method of measuring the surface tension of the solvent is measurement by ring method.

Mixing temperature is not particularly limited, and is, e.g., 20 °C or higher and not higher than a boiling point of the solvent, preferably 22 °C or more, preferably 50 °C or less, more preferably 40 °C or less, even more preferably 30 °C or less. When mixing temperature falls within these ranges, the solvent (e.g., organic solvent) is less volatile, leading to less change in a compounding ratio.

Mixing time is not particularly limited, and is, e.g., 1 minute to 5 hours, preferably 5 minutes or more, preferably 4 hours or less, more preferably 2 hours or less, even more preferably 1 hour or less. When mixing time falls within these ranges, the thermal insulating material can be produced efficiently.

The consistency of the mixture liquid is not particularly limited, and is, e.g., 50 to 200, preferably 55 or more, more preferably 60 or more, even more preferably 65 or more, and preferably 180 or less, more preferably 160 or less, even more preferably 140 or less. When the mixture liquid has a consistency within these ranges, breakage of fibers can be reduced in dispersing fibers homogenously.

An exemplary method of measuring the consistency of the mixture liquid is the method described in Japanese Industrial Standards JIS K 2220: 2013, “Lubricating Grease-Part 7: Test method for Cone Penetration”, particularly measurement as “unworked penetration”. A measuring device capable of measuring consistency is commercially available, and specific examples thereof include a penetrometer available from Nikka-engineering KK. A measuring procedure is as follows: a pot is prepared with such a large size that a cone weight is capable of descending without contact with the pot, and the pot is filled with the mixture liquid and placed on a measuring device equipped with the weight. Next, a position of the weight is adjusted and set so as to provide contact between the weight and the mixture liquid, and the position is defined as zero. Then, the weight is moved down for 5 seconds (+0.1 seconds) under a condition at room temperature (25 °C), and a depth of penetration of the weight into the mixture liquid (mm)×10 is calculated as a consistency. As the cone weight, a standard cone defined in Japanese Industrial Standards is exemplarily used, and a weight with a total mass of 102.5 g±0.05 g and a weight holder having a mass of 47.5±0.05 g are exemplarily used.

An application method and an application condition in the applying step are not particularly limited, and can appropriately employ a known method. For example, a comma coater, a spin coater, a die coater, or a dispenser can be used for application.

A shaping method and a shaping condition in the applied film shaping step are not particularly limited, and can appropriately employ a known method, and examples thereof include a process of compress-shaping with, e.g., hot press or vacuum press and drying with, e.g., a floating oven and/or an IR oven. As a drying condition, drying temperature is preferably, e.g., 60 °C to 150 °C. Drying time is preferably, e.g., 4 minutes to 20 minutes. The shaping method and the shaping condition can be selected so as to provide a thermal insulating layer with a desired density (e.g., 0.2 to 0.5 g/cm³).

A method of preparing a cushioning layer in the cushioning layer preparation step is not particularly limited, and a conventional thermal insulating material or the like may be obtained as the cushioning layer, or the cushioning layer may be produced in the preparation step. When the cushioning layer is a fiber-containing shaped material shaped from a mixture containing fiber and a binder, examples of the production method thereof include a production method including the following steps:
Precursor preparation step: a step of preparing a precursor containing a binder dispersed in fiber; and
Precursor shaping step: a step of providing a cushioning layer by shaping the precursor prepared in the precursor preparation step.

As an example of the precursor in the precursor shaping step, a material containing a thermosetting resin dispersed as a binder in fiber is commercially available and can be obtained.

A method of shaping the precursor in the precursor shaping step is not particularly limited, and examples thereof include a method of thermally compressing the precursor with a hot press machine.

A method of stacking component layers in the stacking step is not particularly limited, and the component layers may be simply stacked, or may be compressed with appropriately employing a known compressive shaping method and a condition thereof, or adjacent layers may be joined together with an adhesive or a PSA. When two or more covering layers are used to seal a gap between these covering layers, the stacking step also includes attaching the covering layers to one another.

The items disclosed hereby include the followings.
[1]A thermal insulating material including a thermal insulating layer containing inorganic particles, and a cushioning layer formed of a fiber-containing shaped material containing fiber or a foamed shaped material containing foam,
wherein the cushioning layer is a layer capable of generating a compressed state with a compressive strain value x_{B} [%] and a compressive stress value y_{B} [MPa] satisfying the following Formula (b1-1) and the following Formula (b1-2) in a compression test at a compression rate of 0.5 mm/min only for the cushioning layer:

0.50≤y_{B}≤3.45 Formula(b1-1)

0.30x_{B}−18.68≤y_{B}≤0.20x_{B}−0.48 Formula (b1-2)
[2] The thermal insulating material set forth in the item [1], wherein the thermal insulating layer is a layer capable of generating a compressed state with a compressive strain value x_{A} [%] and a compressive stress value y_{A} [MPa] satisfying the following Formula (a1-1) and the following Formula (a1-2) in a compression test at a compression rate of 0.5 mm/min only for the thermal insulating layer:

0.50≤y_{A}≤3.45 Formula (a1-1)

0.12x_{A}−2.45≤y_{A} Formula (a1-2)
[3] The thermal insulating material set forth in the item [1] or [2], wherein the cushioning layer is a layer capable of generating a compressed state with a compressive strain value x_{B} [%] and a compressive stress value y_{B} [MPa] satisfying the following Formula (b2-1) and the following Formula (b2-2) in the compression test:

1.00≤y_{B}≤3.00 Formula (b2-1)

0.20x_{B}−11.00≤y_{B}≤0.10x_{B} Formula (b2-2)
[4] The thermal insulating material set forth in any of the items [1] to [3], wherein the thermal insulating layer is a layer capable of generating a compressed state with a compressive strain value x_{A} [%] and a compressive stress value y_{A} [MPa] satisfying the following Formula (a2-1) and the following Formula (a2-2) in the compression test:

1.00≤y_{A}≤3.00 Formula (a2-1)

0.20x_{A}−3.00≤y_{A} Formula (a2-2)
[5] The thermal insulating material set forth in any of the items [1] to [4], wherein the cushioning layer is a layer capable of generating a compressed state with a compressive strain value x_{B} [%] and a compressive stress value y_{B} [MPa] satisfying the following Formula (b3-1) and the following Formula (b3-2) in the compression test:

1.50≤y_{B}≤3.00 Formula (b3-1)

0.15x_{B}−7.50≤y_{B}≤0.10x_{B}−1.00 Formula (b3-2)
[6] The thermal insulating material set forth in any of the items [1] to [5], wherein the thermal insulating layer is a layer capable of generating a compressed state with a compressive strain value x_{A} [%] and a compressive stress value y_{A} [MPa] satisfying the following Formula (a3-1) and the following Formula (a3-2) in the compression test:

1.50≤y_{A}≤2.50 Formula (a3-1)

0.20x_{A}−1.50≤y_{A} Formula (a3-2)
[7] The thermal insulating material set forth in any of the items [1] to [6], wherein the cushioning layer is layer capable of generating a compressed state with a compressive strain value x_{B}[%] and a compressive stress value y_{B} [MPa] satisfying the following Formula (b4-1) and the following Formula (b4-2) in the compression test:

2.00≤y_{B}≤2.50 Formula (b4-1)

0.10x_{B}−3.50≤y_{B}≤0.10x_{B}−1.50 Formula (b4-2)
[8] The thermal insulating material set forth in any of the items [1] to [7], wherein the inorganic particles in the thermal insulating layer are silicon dioxide particles.
[9] The thermal insulating material set forth in any of the items [1] to [8], wherein the silicon dioxide particles are at least one kind selected from the group consisting of dry silica, wet silica, and silica aerogel.
[10] The thermal insulating material set forth in any of the items [1] to [9], wherein the silicon dioxide particles are hydrophilic fumed silica.
[11] The thermal insulating material set forth in any of the items [1] to [10], wherein the thermal insulating layer is a shaped material shaped from a mixture containing inorganic particles and inorganic fiber.
[12] The thermal insulating material set forth in any of the items [1] to [11], the thermal insulating material being placed between cells in a battery module or a battery pack.
[13]A thermal insulating material including a thermal insulating layer containing inorganic particles, and a cushioning layer formed of a fiber-containing shaped material containing fiber or a foamed shaped material containing foam,
wherein the cushioning layer is a layer capable of generating a compressed state with a compressive strain value x_{B} [%] and a compressive stress value y_{B} [MPa] satisfying the following Formula (b5-1) and the following Formula (b5-2) in a compression test at a compression rate of 0.5 mm/min only for the cushioning layer:

0.10≤y_{B}≤1.39 Formula (b5-1)

0.129x_{B}−9.575≤y_{B}≤0.129x_{B}−1.19 Formula (b5-2)
[14] The thermal insulating material set forth in the item [13], wherein the thermal insulating layer is a layer capable of generating a compressed state with a compressive strain value x_{A} [%] and a compressive stress value y_{A} [MPa] satisfying the following Formula (a4-1) and the following Formula (a4-2) in a compression test at a compression rate of 0.5 mm/min only for the thermal insulating layer:

0.10≤y_{A}≤1.39 Formula (a4-1)

0.043x_{A}−0.545≤y_{A} Formula (a4-2)
[15] The thermal insulating material set forth in the item [13] or [14], wherein the cushioning layer is a layer capable of generating a compressed state with a compressive strain value x_{B} [%] and a compressive stress value y_{B} [MPa] satisfying the following Formula (b6-1) and the following Formula (b6-2) in the compression test:

0.20≤y_{B}≤1.10 Formula (b6-1)

0.12x_{B}−8.80≤y_{B}≤0.036x_{B}−0.34. Formula (b6-2)
[16] The thermal insulating material set forth in any of the items [13] to [15], wherein the thermal insulating layer is a layer capable of generating a compressed state with a compressive strain value x_{A} [%] and a compressive stress value y_{A} [MPa] satisfying the following Formula (a5-1) and the following Formula (a5-2) in the compression test:

0.20≤y_{A}≤1.10 Formula (a5-1)

0.09x_{A}−1.15≤y_{A} Formula (a5-2)
[17] The thermal insulating material set forth in any of the items [13] to [16], wherein the cushioning layer is a layer capable of generating a compressed state with a compressive strain value x_{B} [%] and a compressive stress value y_{B} [MPa] satisfying the following Formula (b7-1) and the following Formula (b7-2) in the compression test:

0.30≤y_{B}≤0.90 Formula (b7-1)

0.12x_{B}−8.70≤y_{B}≤0.04x_{B}−0.90 Formula (b7-2)
[18] The thermal insulating material set forth in any of the items [13] to [17], wherein the thermal insulating layer is a layer capable of generating a compressed state with a compressive strain value x_{A} [%] and a compressive stress value y_{A} [MPa] satisfying the following Formula (a6-1) and the following Formula (a6-2) in the compression test:

0.30≤y_{A}≤0.90 Formula (a6-1)

0.12x_{A}−0.90≤y_{A} Formula (a6-2)
[19] The thermal insulating material set forth in any of the items [13] to [18], wherein the cushioning layer is layer capable of generating a compressed state with a compressive strain value x_{B}[%] and a compressive stress value y_{B} [MPa] satisfying the following Formula (b8-1) and the following Formula (b8-2) in the compression test:

0.40≤y_{B}≤0.80 Formula (b8-1)

0.08x_{B}−5.60≤y_{B}≤0.032x_{B}−0.88 Formula (b8-2)
[20] The thermal insulating material set forth in any of the items [13] to [19], wherein the inorganic particles in the thermal insulating layer are silicon dioxide particles.
[21] The thermal insulating material set forth in any of the items [13] to [20], wherein the silicon dioxide particles are at least one kind selected from the group consisting of dry silica, wet silica, and silica aerogel.
[22] The thermal insulating material set forth in any of the items [13] to [21], wherein the silicon dioxide particles are hydrophilic fumed silica.
[23] The thermal insulating material set forth in any of the items [13] to [22], wherein the thermal insulating layer is a shaped material shaped from a mixture containing inorganic particles and inorganic fiber.
[24] The thermal insulating material set forth in any of the items [13] to [23], the thermal insulating material being placed between cells in a battery module or a battery pack.

### EXAMPLE

Some examples according to the present invention will now be described, but are not intended to limit the present invention to these specific examples.

### <Production of Thermal Insulating Material (Thermal Insulating Layer A)>

In a plastic bag, 21 parts by mass of hydrophilic fumed silica particles (“AEROSIL® 380” manufactured by Nippon Aerosil Co., Ltd., average primary particle diameter: about 7 nm, BET specific surface area: 380 m²/g) and 4 parts by mass of glass fiber (“CS 25K-871” manufactured by Nitto Boseki Co., Ltd., average fiber diameter: 13 μm, average fiber length: 25 mm), which is inorganic fiber, preliminarily broken by hands to spread out fibrils was charged and mixed together so as to homogeneously disperse. Then, the mixed powder thus obtained was charged in a breathing bag made of paper, nonwoven fabric, cloth, or textile, and compressively-shaped with a press machine so as to form a sheet of a shaped material with a density of 0.25 g/cm³ after pressing of the powder contents, thereby producing a thermal insulating material (Thermal insulating layer A) that is a shaped material shaped from a mixture containing hydrophilic fumed silica and glass fiber. The thermal insulating material thus obtained (Thermal insulating layer A) had a thickness of 2 mm and a density of 0.23 g/cm³.

### <Production of Thermal Insulating Material (Thermal Insulating Layer B)>

To a mixture solvent (surface tension: 33 mN/m) of 83 parts by mass of acetic acid (surface tension: 27 mN/m) and 17 parts by mass of water (surface tension: 73 mN/m) as protic solvents was added 21 parts by mass of hydrophilic fumed silica particles (“AEROSIL® 200” manufactured by Nippon Aerosil Co., Ltd.) and 4 parts by mass of glass fiber (“CS 25K-871” manufactured by Nitto Boseki Co., Ltd.), and mixed so as to have a consistency of 70 to 140 as measured by the method described later. Next, the mixture liquid thus obtained was applied onto a substrate so as to provide a thickness of 4 mm to form an applied film. The applied film was further compressively-shaped with a hot press machine so as to form a sheet with a thickness of 2 mm and a density of 0.1 to 0.3 g/cm³, and dried at 100 °C for 10 minutes, thereby producing a thermal insulating material (Thermal insulating layer B) that is a shaped material shaped from a mixture containing hydrophilic fumed silica and glass fiber. The thermal insulating material thus obtained (Thermal insulating layer B) had a thickness of 2 mm and a density of 0.33 g/cm³.

### <Production of Thermal Insulating Material (Thermal Insulating Layer C)>

To a mixture solvent (surface tension: 33 mN/m) of 83 parts by mass of acetic acid and 17 parts by mass of water was added 21 parts by mass of hydrophilic fumed silica particles (“AEROSIL® 200”, manufactured by Nippon Aerosil Co., Ltd.) and 4 parts by mass of glass fiber (“CS 25K-871”, manufactured by Nitto Boseki Co., Ltd.), and mixed so as to have a consistency of 70 to 140. Next, the mixture liquid thus obtained was applied onto a substrate so as to provide a thickness of 4 mm to form an applied film. The applied film was further compressively-shaped with a hot press machine so as to form a sheet with a thickness of 2 mm and a density of 0.3 to 0.5 g/cm³, and dried at 100 °C for 10 minutes, thereby producing a thermal insulating material (Thermal insulating layer C) that is a shaped material shaped from a mixture containing hydrophilic fumed silica and glass fiber. The thermal insulating material thus obtained (Thermal insulating layer C) had a thickness of 2 mm and a density of 0.37 g/cm³.

### <Production of Thermal Insulating Material (Thermal Insulating Layer D)>

To a mixture solvent (surface tension: 23 mN/m) of 300 parts by mass of isopropyl alcohol (IPA, surface tension: 21 mN/m) and 60 parts by mass of water as protic solvents was added 100 parts by mass of hydrophilic fumed silica (“AEROSIL® 200” manufactured by Nippon AEROSIL Co., Ltd.), 20 parts by mass of glass fiber (“CS 6J-888” manufactured by Nitto Boseki Co., Ltd.; average fiber diameter: 11 μm; average fiber length: 6 mm), and 1.9 parts by mass of “QUARTAMIN 24P” manufactured by Kao Corporation (active ingredient: dodecyltrimethylammonium chloride (C₁₂H₂₅N (CH₃)₃Cl); active ingredient content: 27% by mass) (0.5 parts by mass of an active ingredient (ammonium salt)) as a non-polymeric dispersant, and mixed so as to have a consistency of 70 to 140. Next, the mixture liquid thus obtained was applied onto a substrate so as to provide a thickness of 4 mm to form an applied film. The applied film was further compressively-shaped with a hot press machine so as to form a sheet with a thickness of 2 mm and a density of 0.3 to 0.5 g/cm³, and dried at 100 °C for 10 minutes, thereby producing a thermal insulating material (Thermal insulating layer D) that is a shaped material shaped from a mixture containing hydrophilic fumed silica, glass fiber, and a non-polymeric dispersant. The thermal insulating material thus obtained (Thermal insulating layer D) had a thickness of 2 mm and a density of 0.37 g/cm³.

### <Production of Thermal Insulating Material (Thermal Insulating Layer E)>

A sheet with a thickness of 2.1 mm and a density of 0.37 g/cm³ was produced by the same production method as for Thermal insulating layer D, followed by ten repetitions of an additional pressure processing step of loading to the sheet at a compression rate of 0.5 mm/sec to reach a pressure of 2.1 MPa and unloading to reach a pressure of 0 MPa, thereby producing a thermal insulating material (Thermal insulating layer E) that is a shaped material shaped from a mixture containing hydrophilic fumed silica, glass fiber, and a non-polymeric dispersant. The thermal insulating material thus obtained (Thermal insulating layer E) had a thickness of 2 mm and a density of 0.40 g/cm³.

### <Production of Thermal Insulating Material (Thermal Insulating Layer F)>

To a mixture solvent of 83 parts by mass of acetic acid and 17 parts by mass of water (surface tension: 33 mN/m) was added 21 parts by mass of hydrophilic fumed silica particles (“AEROSIL© 200” manufactured by Nippon Aerosil Co., Ltd.) and 4 parts by mass of glass fiber (“CS 25K-871” manufactured by Nitto Boseki Co., Ltd.), and mixed so as to have a consistency of 70 to 140. Next, the mixture liquid thus obtained was applied onto a substrate so as to provide a thickness of 2 mm to form an applied film. The applied film was further compressively-shaped with a hot press machine so as to form a sheet with a thickness of 1 mm and a density of 0.3 to 0.5 g/cm³, and dried at 100 °C for 10 minutes, thereby producing a thermal insulating material (Thermal insulating layer F) that is a shaped material shaped from a mixture containing hydrophilic fumed silica and glass fiber. The thermal insulating material thus obtained (Thermal insulating layer F) had a thickness of 1 mm and a density of 0.37 g/cm³.

### <Production of Thermal Insulating Material (Thermal Insulating Layer G)>

A sheet with a thickness of 1.1 mm and a density of 0.37 g/cm³ was produced by the same production method as for Thermal insulating layer F, followed by ten repetitions of an additional pressure processing step of loading to the sheet at a compression rate of 0.5 mm/sec to reach a pressure of 1.39 MPa and unloading to reach a pressure of 0 MPa, thereby producing a thermal insulating material (Thermal insulating layer G) that is a shaped material shaped from a mixture containing hydrophilic fumed silica and glass fiber. The thermal insulating material thus obtained (Thermal insulating layer G) had a thickness of 1 mm and a density of 0.40 g/cm³.

### <Production of Thermal Insulating Material (Thermal Insulating Layer H)>

The same materials as in Thermal insulating layer D were added and mixed so as to have a consistency of 70 to 140. Next, the mixture liquid thus obtained was applied onto a substrate so as to provide a thickness of 3.6 mm to form an applied film. The applied film was further compressively-shaped with a hot press machine so as to form a sheet with a thickness of 1.8 mm and a density of 0.3 to 0.5 g/cm³, and dried at 100 °C for 10 minutes, thereby producing a thermal insulating material (Thermal insulating layer H) that is a shaped material shaped from a mixture containing hydrophilic fumed silica, glass fiber, and a non-polymeric dispersant. The thermal insulating material thus obtained (Thermal insulating layer H) had a thickness of 1.8 mm and a density of 0.37 g/cm³.

### <Production of Thermal Insulating Material (Thermal Insulating Layer I)>

The same materials as in Thermal insulating layer D were added and mixed so as to have a consistency of 70 to 140. Next, the mixture liquid thus obtained was applied onto a substrate so as to provide a thickness of 1.6 mm to form an applied film. The applied film was further compressively-shaped with a hot press machine so as to form a sheet with a thickness of 0.8 mm and a density of 0.3 to 0.5 g/cm³, and dried at 100 °C for 10 minutes, thereby producing a thermal insulating material (Thermal insulating layer I) that is a shaped material shaped from a mixture containing hydrophilic fumed silica, glass fiber, and a non-polymeric dispersant. The thermal insulating material thus obtained (Thermal insulating layer I) had a thickness of 0.8 mm and a density of 0.37 g/cm³.

### <Production of Thermal Insulating Material (Thermal Insulating Layer J)>

The same materials as in Thermal insulating layer D were added and mixed so as to have a consistency of 70 to 140. Next, the mixture liquid thus obtained was applied onto a substrate so as to provide a thickness of 2.4 mm to form an applied film. The applied film was further compressively-shaped with a hot press machine so as to form a sheet with a thickness of 1.2 mm and a density of 0.3 to 0.5 g/cm³, and dried at 100 °C for 10 minutes, thereby producing a thermal insulating material (Thermal insulating layer J) that is a shaped material shaped from a mixture containing hydrophilic fumed silica, glass fiber, and a non-polymeric dispersant. The thermal insulating material thus obtained (Thermal insulating layer J) had a thickness of 1.2 mm and a density of 0.37 g/cm³.

### <Production of Thermal Insulating Material (Thermal Insulating Layer K)>

To the composition of Thermal insulating layer D was added 10 parts by mass of graphite (“AGB-5” manufactured by manufactured by Ito Graphite Co., Ltd, average particle diameter: 5 μm), and mixed so as to have a consistency of 70 to 140. Next, the mixture liquid thus obtained was applied onto a substrate so as to provide a thickness of 2.0 mm to form an applied film. The applied film was further compressively-shaped with a hot press machine so as to form a sheet with a thickness of 1.0 mm and a density of 0.3 to 0.5 g/cm³, and dried at 100 °C for 10 minutes, thereby producing a thermal insulating material (Thermal insulating layer K) that is a shaped material shaped from a mixture containing hydrophilic fumed silica, glass fiber, graphite, and a non-polymeric dispersant. The thermal insulating material thus obtained (Thermal insulating layer K) had a thickness of 1.0 mm and a density of 0.37 g/cm³.

In the production processes of thermal insulating layers B to K, the consistency of each of the mixture liquids was measured as “unworked penetration” in accordance with the description in Japanese Industrial Standards JIS K 2220: 2013, “Lubricating Grease-Part 7: Test method for Cone Penetration”. In detail, a pot was prepared with such a large size that a cone weight was capable of descending without contact with the pot, and the pot was filled with a mixture liquid and placed on a penetrometer (available from Nikka-engineering KK) equipped with the weight. Next, a position of the weight was adjusted and set so as to provide contact between the weight and the mixture liquid, and the position was defined as zero. Then, the weight was moved down for 5 seconds (±0.1 seconds) under a condition at room temperature (25 °C), and a depth of penetration of the weight into the mixture liquid (mm)×10 was calculated as a consistency. As the cone weight, a standard cone defined in Japanese Industrial Standards with a total mass of 102.5 g was used, and a weight holder having a mass of 47.5±0.05 g was used.

<Production of Fiber-containing shaped material (Cushioning Layer A)>

Glass wool (uncured wool (500 g/m²), manufactured by Central Glass Fiber Co., Ltd., raw cotton for pressing, average fiber diameter: 7 μm, glass wool content: 80 to 90% by mass, phenol binder content: 10 to 20% by mass) was heated at 240 °C for 1 minute with a hot press machine to thermally cure the resin in the glass wool, thereby producing Cushioning layer A, which was thus compressively shaped to have a thickness of 3.0 mm, as a cushioning layer. The fiber-containing shaped material thus obtained (Cushioning layer A) had a density of 0.17 g/cm³.

<Production of Fiber-containing shaped material (Cushioning Layer B)>

Glass wool (uncured wool (600 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minute with a hot press machine to thermally cure the resin in the glass wool, thereby producing Cushioning layer B, which was thus compressively shaped to have a thickness of 3.3 mm, as a cushioning layer. The fiber-containing shaped material thus obtained (Cushioning layer B) had a density of 0.18 g/cm³.

<Production of Fiber-containing shaped material (Cushioning Layer C)>

Glass wool (uncured wool (600 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer C, which was thus compressively shaped to have a thickness of 3.0 mm, as a cushioning layer. The fiber-containing shaped material thus obtained (Cushioning layer C) had a density of 0.20 g/cm³.

<Production of Fiber-containing shaped material (Cushioning Layer D)>

Glass wool (uncured wool (700 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer D, which was thus compressively shaped to have a thickness of 3.3 mm, as a cushioning layer. The fiber-containing shaped material thus obtained (Cushioning layer D) had a density of 0.21 g/cm³.

<Production of Fiber-containing shaped material (Cushioning Layer E)>

Glass wool (uncured wool (700 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer E, which was thus compressively shaped to have a thickness of 3.0 mm, as a cushioning layer. The fiber-containing shaped material thus obtained (Cushioning layer E) had a density of 0.23 g/cm³.

<Production of Fiber-containing shaped material (Cushioning Layer F)>

Glass wool (uncured wool (800 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer F, which was thus compressively shaped to have a thickness of 3.3 mm, as a cushioning layer. The fiber-containing shaped material thus obtained (Cushioning layer F) had a density of 0.24 g/cm³.

<Production of Fiber-containing shaped material (Cushioning Layer G)>

Glass wool (uncured wool (800 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer G, which was thus compressively shaped to have a thickness of 3.0 mm, as a cushioning layer. The fiber-containing shaped material thus obtained (Cushioning layer G) had a density of 0.27 g/cm³.

<Production of Fiber-containing shaped material (Cushioning Layer H)>

Glass wool (uncured wool (1000 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer H, which was thus compressively shaped to have a thickness of 3.3 mm, as a cushioning layer. The fiber-containing shaped material thus obtained (Cushioning layer H) had a density of 0.30 g/cm³.

<Production of Fiber-containing shaped material (Cushioning Layer I)>

Glass wool (uncured wool (1000 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing cushioning layer I, which was thus compressively shaped to have a thickness of 3.0 mm, as a cushioning layer. The fiber-containing shaped material thus obtained (Cushioning layer I) had a density of 0.33 g/cm³.

<Production of Fiber-containing shaped material (Cushioning Layer J)>

Glass wool (uncured wool (1200 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer J, which was thus compressively shaped to have a thickness of 3.3 mm, as a cushioning layer. The fiber-containing shaped material thus obtained (Cushioning layer J) had a density of 0.36 g/cm³.

<Production of Fiber-containing shaped material (Cushioning Layer K)>

Glass wool (uncured wool (1200 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer K, which was thus compressively shaped to have a thickness of 3.0 mm, as a cushioning layer. The fiber-containing shaped material thus obtained (Cushioning layer K) had a density of 0.40 g/cm³.

<Production of Fiber-containing shaped material (Cushioning Layer L)>

Glass wool (uncured wool (1400 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer L, which was thus compressively shaped to have a thickness of 3.3 mm, as a cushioning layer. The fiber-containing shaped material thus obtained (Cushioning layer L) had a density of 0.42 g/cm³.

<Production of Fiber-containing shaped material (Cushioning Layer M)>

Glass wool (uncured wool (1556 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer M, which was thus compressively shaped to have a thickness of 3.6 mm, as a cushioning layer. The fiber-containing shaped material thus obtained (Cushioning layer M) had a density of 0.44 g/cm³.

<Production of Fiber-containing shaped material (Cushioning Layer N)>

Glass wool (uncured wool (1400 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer N, which was thus compressively shaped to have a thickness of 3.0 mm, as a cushioning layer. The fiber-containing shaped material thus obtained (Cushioning layer N) had a density of 0.47 g/cm³.

<Production of Fiber-containing shaped material (Cushioning Layer O)>

Glass wool (uncured wool (1656 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer O, which was thus compressively shaped to have a thickness of 3.3 mm, as a cushioning layer. The fiber-containing shaped material thus obtained (Cushioning layer O) had a density of 0.50 g/cm³.

<Production of Fiber-containing shaped material (Cushioning Layer P)>

Glass wool (uncured wool (1556 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 200 °C for 2 minutes with a hot press machine to thermally cure the resin in the glass wool, thereby producing Cushioning layer P, which was thus compressively shaped to have a thickness of 3.0 mm, as a cushioning layer. The fiber-containing shaped material thus obtained (Cushioning layer P) had a density of 0.52 g/cm³.

<Production of Fiber-containing shaped material (Cushioning Layer Q)>

Glass wool (uncured wool (800 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 240 °C for 1 minute with a hot press machine to thermally cure the resin in the glass wool, thereby producing Cushioning layer Q, which was thus compressively shaped to have a thickness of 4.0 mm, as a cushioning layer. The fiber-containing shaped material thus obtained (Cushioning layer Q) had a density of 0.20 g/cm³.

<Production of Fiber-containing shaped material (Cushioning Layer R)>

Glass wool (uncured wool (800 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 240 °C for 1 minute with a hot press machine to thermally cure the resin in the glass wool, thereby producing Cushioning layer R, which was thus compressively shaped to have a thickness of 4.2 mm, as a cushioning layer. The fiber-containing shaped material thus obtained (Cushioning layer R) had a density of 0.19 g/cm³.

<Production of Fiber-containing shaped material (Cushioning Layer S)>

Glass wool (uncured wool (1050 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 240 °C for 1 minute with a hot press machine to thermally cure the resin in the glass wool, thereby producing Cushioning layer S, which was thus compressively shaped to have a thickness of 4.0 mm, as a cushioning layer. The fiber-containing shaped material thus obtained (Cushioning layer S) had a density of 0.26 g/cm³.

<Production of Fiber-containing shaped material (Cushioning Layer T)>

Glass wool (uncured wool (900 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 240 °C for 1 minute with a hot press machine to thermally cure the resin in the glass wool, thereby producing Cushioning layer T, which was thus compressively shaped to have a thickness of 3.5 mm, as a cushioning layer. The fiber-containing shaped material thus obtained (Cushioning layer T) had a density of 0.25 g/cm³.

<Production of Fiber-containing shaped material (Cushioning Layer U)>

Glass wool (uncured wool (500 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 240 °C for 1 minute with a hot press machine to thermally cure the resin in the glass wool, thereby producing Cushioning layer U, which was thus compressively shaped to have a thickness of 3.5 mm, as a cushioning layer. The fiber-containing shaped material thus obtained (Cushioning layer U) had a density of 0.14 g/cm³.

<Production of Fiber-containing shaped material (Cushioning Layer V)>

Glass wool (uncured wool (500 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 240 °C for 1 minute with a hot press machine to thermally cure the resin in the glass wool, thereby producing Cushioning layer V, which was thus compressively shaped to have a thickness of 5.0 mm, as a cushioning layer. The fiber-containing shaped material thus obtained (Cushioning layer V) had a density of 0.10 g/cm³.

<Production of Fiber-containing shaped material (Cushioning Layer W)>

Glass wool (uncured wool (600 g/m²), manufactured by Central Glass Fiber Co., Ltd., raw cotton for pressing, average fiber diameter: 7 μm, glass wool content: 80% to 90% by mass, phenol binder content: 10% to 20% by mass) was heated at 240 °C for 1 minute with a hot press machine to thermally cure the resin in the glass wool, thereby producing Cushioning layer W, which was thus compressively shaped to have a thickness of 5.0 mm, as a cushioning layer. The fiber-containing shaped material thus obtained (Cushioning layer W) had a density of 0.12 g/cm³.

<Production of Fiber-containing shaped material (Cushioning Layer X)>

Glass wool (uncured wool (600 g/m²), manufactured by Central Glass Fiber Co., Ltd., raw cotton for pressing, average fiber diameter: 7 μm %) impregnated with a thermoplastic binder (methyl methacrylate-butadiene rubber (MBR) latex manufactured by DIC Corporation, product name: “LACSTAR DM-820”) was heated at 180 °C for 7 minutes with a hot press machine to evaporate water in the latex, thereby producing Cushioning layer X, which was compressively-shaped to have a thickness of 2.9 mm. The fiber-containing shaped material thus obtained (Cushioning layer X) had a density of 0.18 g/cm³ and a MBR content of 32% by mass.

### <Organic Foam (Cushioning Layer Y)>

NR foam manufactured by Miyahara Rubber Industries Co., Ltd. (2975 g/m², thickness: 8.5 mm, Thomson #52) was used as Cushioning layer Y. The density was 0.35 g/cm³.

### <Organic Foam (Cushioning Layer Z)>

Urethane foam manufactured by ShengYing New Material Technology (Changzhou) Co., Ltd. (2880 g/m², thickness: 6 mm, product name: “MicroFoam® PH-480-6T-RP”) was used as cushioning layer Z. The density was 0.48 g/cm³.

### <Measurement of Densities of Thermal Insulating Layer and Cushioning Layer>

Measurement of the densities of Thermal insulating layers A to K and Cushioning layers A to K was performed by the following method.

Each of the thermal insulating layers and the cushioning layers was cut into a size of 20 mm×20 mm and subjected to measurement of its mass and thickness, and a density [g/cm³] was calculated by dividing the mass by volume. The results are shown in Tables 3-1, 3-2, 4-1, and 4-2.

### <Compression Test of Thermal Insulating Layer and Cushioning Layer>

A compression test was performed by the following method for each of Thermal insulating layers A to K and Cushioning layers A to K.

Using a precision universal testing machine (AUTOGRAPH AGS-5kNX, manufactured by Shimadzu Corporation), a compression test to compress each of the thermal insulating layers and the cushioning layers at a compression rate of 0.5 mm/min was performed to measure a compressive strain [%](compressive displacement/initial thickness of sample) and a compressive stress [MPa]. The respective stress-strain curves (S-S curves) thus obtained are shown in FIGS. 9 to 31. Thermal insulating layers A to E were investigated for presence of a compressed state satisfying Formula (a1-1) and Formula (a1-2), a compressed state satisfying Formula (a2-1) and Formula (a2-2), and a compressed state satisfying Formula (a3-1) and Formula (a3-2), and Cushioning layers A to P were investigated for a compressed state satisfying Formula (b1-1) and Formula (b1-2), a compressed state Formula (b2-1) and Formula (b2-2), a compressed state satisfying Formula (b3-1) and Formula (b3-2), and a compressed state satisfying Formula (b4-1) and Formula (b4-2). The results are shown in Table 1 and Table 2-1 to Table 2-4. For each of the thermal insulating layers and cushioning layers, the values of the thicknesses and the compressive strains under compressive stresses of 0.34 MPa, 1.00 MPa, 1.39 MPa, and 3.45 MPa in the compression test are shown in Table 3-1 to Table 3-2, and Table 4-1 to Table 4-2.

Upward arrows in Table 4-1 indicate that a content in a cell filled by an arrow is the same as a content in a next higher cell.

Furthermore, Thermal insulating layers A to E were scored for relationship between the shape of a stress-strain curve in a graph with strain on the x-axis and stress on the y-axis, and Region (a1) (i.e., a region enclosed by Formula (a1-1) and Formula (a1-2); the same applies hereinafter), Region (a2), and Region (a3), according to the following criteria. The results are shown in Table 3-1.
0 point: passing none of Regions (a1) to (a3).
1 point: passing Region (a1)
(add 0.5 points if crossing both the upper end line and the lower end line of Region (a1)).
2 points: passing Region (a2)
(add 0.5 points if crossing both the upper end line and the lower end line of Region (a2)).
3 points: passing Region (a3)
(add 0.5 points if crossing both the upper end line and the lower end line of Region (a3)).

The upper end line and the lower end line of each region refer to two straight lines parallel to the x-axis among lines defining the region (the same applies hereinafter).

Thermal insulating layers F to K were scored for relationship between the shape of a stress-strain curve in a graph with strain on the x-axis and stress on the y-axis, and Regions (a4) to (a6), according to the following criteria. The results are shown in Table 3-2.
0 point: passing none of Regions (a4) to (a6).
1 point: passing Region (a4)
(add 0.5 points if crossing both the upper end line and the lower end line of Region (a4)).
2 points: passing Region (a5)
(add 0.5 points if crossing both the upper end line and the lower end line of Region (a5)).
3 points: passing Region (a6)
(add 0.5 points if crossing both the upper end line and the lower end line of Region (a6)).

Similarly, Cushioning layers A to T were scored for relationship between the shape of a stress-strain curve in a graph with strain on the x-axis and stress on the y-axis, and Regions (b1) to (b4), according to the following criteria. The results are shown in Table 4-1.
0 point: passing none of Regions (b1) to (b4).
1 point: passing Region (b)
(add 0.5 points if crossing both the upper end line and the lower end line of Region (b1)).
2 points: passing Region (b2)
(add 0.5 points if crossing both the upper end line and the lower end line of Region (b2)).
3 points: passing Region (b3)
(add 0.5 points if crossing both the upper end line and the lower end line of Region (b3)).
4 points: passing Region (b4)
(add 0.5 points if crossing both the upper end line and the lower end line of Region (b4)).

Cushioning layers U to Z were scored for relationship between the shape of a stress-strain curve in a graph with strain on the x-axis and stress on the y-axis, and Regions (b5) to (b8), according to the following criteria. The results are shown in Table 4-2.
0 point: passing none of Regions (b5) to (b8).
1 point: passing Region (b5)
(add 0.5 points if crossing both the upper end line and the lower end line of Region (b5)).
2 points: passing Region (b6)
(add 0.5 points if crossing both the upper end line and the lower end line of Region (b6)).
3 points: passing Region (b7)
(add 0.5 points if crossing both the upper end line and the lower end line of Region (b7)).
4 points: passing Region (b8)
(add 0.5 points if crossing both the upper end line and the lower end line of Region (b8)).

TABLE 1

| | Example of compressed state satisfying | Example of compressed state satisfying | Example of compressed state satisfying |
|---|---|---|---|
| | Formula (a1-1) and Formula (a1-2) | Formula (a2-1) and Formula (a2-2) | Formula (a3-1) and Formula (a3-2) |
| Thermal | none | none | none |
| insulating | | | |
| layer A | | | |
| Thermal | x_{A} = 19.0 [%], y_{A} = 1.00 [MPa] | x_{A} = 19.0 [%], y_{A} = 1.00 [MPa] | none |
| insulating | Formula (a1-1): 0.50 ≤ (1.00) ≤ 3.45 | Formula (a2-1): 1.00 ≤ (1.00) ≤ 3.00 | |
| layer B | Formula (a1-2): | Formula (a2-2): | |
| | 0.12 × (19.0) − 2.45 = −0.17 ≤ (1.00) | 0.20 × (19.0) − 3.00 = 0.8 ≤ (1.00) | |
| Thermal | x_{A} = 21.4 [%], y_{A} = 2.00 [MPa] | x_{A} = 21.4 [%], y_{A} = 2.00 [MPa] | none |
| insulating | Formula (a1-1): 0.50 ≤ (2.00) ≤ 3.45 | Formula (a2-1): 1.00 ≤ (2.00) ≤ 3.00 | |
| layer C | Formula (a1-2): | Formula (a2-2): | |
| | 0.12 × (21.4) − 2.45 = 0.12 ≤ (2.00) | 0.20 × (21.4) − 3.00 = 1.28 ≤ (2.00) | |
| Thermal | x_{A} = 15.6 [%], y_{A} = 2.03 [MPa] | x_{A} = 15.6 [%], y_{A} = 2.03 [MPa] | x_{A} = 15.6 [%], y_{A} = 2.03 [MPa] |
| insulating | Formula (a1-1): 0.50 ≤ (2.03) ≤ 3.45 | Formula (a2-1): 1.00 ≤ (2.03) ≤ 3.00 | Formula (a3-1): 1.50 ≤ (2.03) ≤ 2.50 |
| layer D | Formula (a1-2): | Formula (a2-2): | Formula (a3-2): |
| | 0.12 × (15.6) − 2.45 = −0.58 ≤ (2.03) | 0.20 × (15.6) − 3.00 = 0.12 ≤ (2.03) | 0.20 × (15.6) − 1.50 = 1.62 ≤ (2.03) |
| Thermal | x_{A} = 12.2 [%], y_{A} = 2.01 [MPa] | x_{A} = 12.2 [%], y_{A} = 2.01 [MPa] | x_{A} = 12.2 [%], y_{A} = 2.01 [MPa] |
| insulating | Formula (a1-1): 0.50 ≤ (2.01) ≤ 3.45 | Formula (a2-1): 1.00 ≤ (2.01) ≤ 3.00 | Formula (a3-1): 1.50 ≤ (2.01) ≤ 2.50 |
| layer E | Formula (a1-2): | Formula (a2-2): | Formula (a3-2): |
| | 0.12 × (12.2) − 2.45 = −0.99 ≤ (2.01) | 0.20 × (12.2) − 3.00 = −0.56 ≤ (2.01) | 0.20 × (12.2) − 1.50 = 0.94 ≤ (2.01) |

TABLE 2-1

| | Example of compressed state satisfying | Example of compressed state satisfying |
|---|---|---|
| | Formula (b1-1) and Formula (b1-2) | Formula (b2-1) and Formula (b2-2) |
| Cushioning | x_{A} = 60.0 [%], y_{A} = 1.01 [MPa] | x_{A} = 60.0 [%], y_{A} = 1.01 [MPa] |
| layer A | Formula (b1-1): 0.50 ≤ (1.01) ≤ 3.45 | Formula (b2-1): 1.00 ≤ (1.01) ≤ 3.00 |
| | Formula (b1-2): | Formula (b2-2): |
| | 0.30 × (60.0) − 18.68 = −0.68 ≤ (1.01) | 0.20 × (60.0) − 11.00 = 1.00 ≤ (1.01) |
| | (1.01) ≤ 0.20 × (60.0) − 0.48 = 11.52 | (1.01) ≤ 0.10 × (60.0) = 6.00 |
| Cushioning | x_{A} = 59.4 [%], y_{A} = 1.05 [MPa] | x_{A} = 59.4 [%], y_{A} = 1.05 [MPa] |
| layer B | Formula (b1-1): 0.50 ≤ (1.05) ≤ 3.45 | Formula (b2-1): 1.00 ≤ (1.05) ≤ 3.00 |
| | Formula (b1-2): | Formula (b2-2): |
| | 0.30 × (59.4) − 18.68 = −0.86 ≤ (1.05) | 0.20 × (59.4) − 11.00 = 0.88 ≤ (1.05) |
| | (1.05) ≤ 0.20 × (59.4) − 0.48 = 11.4 | (1.01) ≤ 0.10 × (59.4) = 5.94 |
| Cushioning | x_{A} = 57.2 [%], y_{A} = 1.15 [MPa] | x_{A} = 57.2 [%], y_{A} = 1.15 [MPa] |
| layer C | Formula (b1-1): 0.50 ≤ (1.15) ≤ 3.45 | Formula (b2-1): 1.00 ≤ (1.15) ≤ 3.00 |
| | Formula (b1-2): | Formula (b2-2): |
| | 0.30 × (57.2) − 18.68 = −0.52 ≤ (1.15) | 0.20 × (57.2) − 11.00 = 0.44 ≤ (1.15) |
| | (1.15) ≤ 0.20 × (57.2) − 0.48 = 10.96 | (1.15) ≤ 0.10 × (57.2) = 5.72 |
| Cushioning | x_{A} = 60.5 [%], y_{A} = 2.00 [MPa] | x_{A} = 60.5 [%], y_{A} = 2.00 [MPa] |
| layer D | Formula (b1-1): 0.50 ≤ (2.00) ≤ 3.45 | Formula (b2-1): 1.00 ≤ (2.00) ≤ 3.00 |
| | Formula (b1-2): | Formula (b2-2): |
| | 0.30 × (60.5) − 18.68 = −0.53 ≤ (2.00) | 0.20 × (60.5) − 11.00 = 1.1 ≤ (2.00) |
| | (2.00) ≤ 0.20 × (60.5) − 0.48 = 11.62 | (2.00) ≤ 0.10 × (60.5) = 6.05 |
| | Example of compressed state satisfying | Example of compressed state satisfying |
| | Formula (b3-1) and Formula (b3-2) | Formula (b4-1) and Formula (b4-2) |
| Cushioning | none | none |
| layer A | | |
| Cushioning | none | none |
| layer B | | |
| Cushioning | none | none |
| layer C | | |
| Cushioning | x_{A} = 60.5 [%], y_{A} = 2.00 [MPa] | none |
| layer D | Formula (b3-1): 1.50 ≤ (2.00) ≤ 3.00 | |
| | Formula (b3-2): | |
| | 0.15 × (60.5) − 7.50 = 1.58 ≤ (2.00) | |
| | (2.00) ≤ 0.10 × (60.5) − 1.0 = 5.05 | |

TABLE 2-2

| | Example of compressed state satisfying | Example of compressed state satisfying |
|---|---|---|
| | Formula (b1-1) and Formula (b1-2) | Formula (b2-1) and Formula (b2-2) |
| Cushioning | x_{A} = 59.4 [%], y_{A} = 2.11 [MPa] | x_{A} = 59.4 [%], y_{A} = 2.11 [MPa] |
| layer E | Formula (b1-1): 0.50 ≤ (2.11) ≤ 3.45 | Formula (b2-1): 1.00 ≤ (2.11) ≤ 3.00 |
| | Formula (b1-2): | Formula (b2-2): |
| | 0.30 × (59.4) − 18.68 = −0.86 ≤ (2.11) | 0.20 × (59.4) − 11.00 = 0.88 ≤ (2.11) |
| | (2.11) ≤ 0.20 × (59.4) − 0.48 = 11.4 | (2.11) ≤ 0.10 × (59.4) = 5.94 |
| Cushioning | x_{A} = 59.3 [%], y_{A} = 2.02 [MPa] | x_{A} = 59.3 [%], y_{A} = 2.02 [MPa] |
| layer F | Formula (b1-1): 0.50 ≤ (2.02) ≤ 3.45 | Formula (b2-1): 1.00 ≤ (2.02) ≤ 3.00 |
| | Formula (b1-2): | Formula (b2-2): |
| | 0.30 × (59.3) − 18.68 = −0.89 ≤ (2.02) | 0.20 × (59.3) − 11.00 = 0.86 ≤ (2.02) |
| | (2.02) ≤ 0.20 × (59.3) − 0.48 = 11.38 | (2.02) ≤ 0.10 × (59.3) = 5.93 |
| Cushioning | x_{A} = 52.5 [%], y_{A} = 2.26 [MPa] | x_{A} = 52.5 [%], y_{A} = 2.26 [MPa] |
| layer G | Formula (b1-1): 0.50 ≤ (2.26) ≤ 3.45 | Formula (b2-1): 1.00 ≤ (2.26) ≤ 3.00 |
| | Formula (b1-2): | Formula (b2-2): |
| | 0.30 × (52.5) − 18.68 = −2.93 ≤ (2.26) | 0.20 × (52.5) − 11.00 = −0.5 ≤ (2.26) |
| | (2.26) ≤ 0.20 × (52.5) − 0.48 = 10.02 | (2.26) ≤ 0.10 × (52.5) = 5.25 |
| Cushioning | x_{A} = 53.3 [%], y_{A} = 2.17 [MPa] | x_{A} = 53.3 [%], y_{A} = 2.17 [MPa] |
| layer H | Formula (b1-1): 0.50 ≤ (2.17) ≤ 3.45 | Formula (b2-1): 1.00 ≤ (2.17) ≤ 3.00 |
| | Formula (b1-2): | Formula (b2-2): |
| | 0.30 × (53.3) − 18.68 = −2.69 ≤ (2.17) | 0.20 × (53.3) − 11.00 = −0.34 ≤ (2.17) |
| | (2.17) ≤ 0.20 × (53.3) − 0.48 = 10.18 | (2.17) ≤ 0.10 × (53.3) = 5.33 |
| | Example of compressed state satisfying | Example of compressed state satisfying |
| | Formula (b3-1) and Formula (b3-2) | Formula (b4-1) and Formula (b4-2) |
| Cushioning | x_{A} = 59.4 [%], y_{A} = 2.11 [MPa] | none |
| layer E | Formula (b3-1): 1.50 ≤ (2.11) ≤ 3.00 | |
| | Formula (b3-2): | |
| | 0.15 × (59.4) − 7.50 = 1.41 ≤ (2.11) | |
| | (2.11) ≤ 0.10 × (59.4) − 1.0 = 4.94 | |
| Cushioning | x_{A} = 59.3 [%], y_{A} = 2.02 [MPa] | none |
| layer F | Formula (b3-1): 1.50 ≤ (2.02) ≤ 3.00 | |
| | Formula (b3-2): | |
| | 0.15 × (59.3) − 7.50 = 1.40 ≤ (2.02) | |
| | (2.02) ≤ 0.10 × (59.3) − 1.0 = 4.93 | |
| Cushioning | x_{A} = 52.5 [%], y_{A} = 2.26 [MPa] | x_{A} = 52.5 [%], y_{A} = 2.26 [MPa] |
| layer G | Formula (b3-1): 1.50 ≤ (2.26) ≤ 3.00 | Formula (b4-1): 2.00 ≤ (2.26) ≤ 2.50 |
| | Formula (b3-2): | Formula (b4-2): |
| | 0.15 × (52.5) − 7.50 = 0.38 ≤ (2.26) | 0.10 × (52.5) − 3.50 = 1.75 ≤ (2.26) |
| | (2.26) ≤ 0.10 × (52.5) − 1.0 = 4.25 | (2.26) ≤ 0.10 × (52.5) − 1.5 = 3.75 |
| Cushioning | x_{A} = 53.3 [%], y_{A} = 2.17 [MPa] | x_{A} = 53.3 [%], y_{A} = 2.17 [MPa] |
| layer H | Formula (b3-1): 1.50 ≤ (2.17) ≤ 3.00 | Formula (b4-1): 2.00 ≤ (2.17) ≤ 2.50 |
| | Formula (b3-2): | Formula (b4-2): |
| | 0.15 × (53.3) − 7.50 = 0.50 ≤ (2.17) | 0.10 × (53.3) − 3.50 = 1.83 ≤ (2.17) |
| | (2.17) ≤ 0.10 × (53.3) − 1.0 = 4.33 | (2.17) ≤ 0.10 × (53.3) − 1.5 = 3.83 |

TABLE 2-3

| | Example of compressed state satisfying | Example of compressed state satisfying |
|---|---|---|
| | Formula (b1-1) and Formula (b1-2) | Formula (b2-1) and Formula (b2-2) |
| Cushioning | x_{A} = 50.0 [%], y_{A} = 2.23 [MPa] | x_{A} = 50.0 [%], y_{A} = 2.23 [MPa] |
| layer I | Formula (b1-1): 0.50 ≤ (2.23) ≤ 3.45 | Formula (b2-1): 1.00 ≤ (2.23) ≤ 3.00 |
| | Formula (b1-2): | Formula (b2-2): |
| | 0.30 × (50.0) − 18.68 = −3.68 ≤ (2.23) | 0.20 × (50.0) − 11.00 = −1.0 ≤ (2.23) |
| | (2.23) ≤ 0.20 × (50.0) − 0.48 = 9.52 | (2.23) ≤ 0.10 × (50.0) = 5.00 |
| Cushioning | x_{A} = 46.2 [%], y_{A} = 2.21 [MPa] | x_{A} = 46.2 [%], y_{A} = 2.21 [MPa] |
| layer J | Formula (b1-1): 0.50 ≤ (2.21) ≤ 3.45 | Formula (b2-1): 1.00 ≤ (2.21) ≤ 3.00 |
| | Formula (b1-2): | Formula (b2-2): |
| | 0.30 × (46.2) − 18.68 = −4.82 ≤ (2.21) | 0.20 × (46.2) − 11.00 = −1.76 ≤ (2.21) |
| | (2.21) ≤ 0.20 × (46.2) − 0.48 = 8.76 | (2.21) ≤ 0.10 × (46.2) = 4.62 |
| Cushioning | x_{A} = 23.6 [%], y_{A} = 2.26 [MPa] | x_{A} = 23.6 [%], y_{A} = 2.26 [MPa] |
| layer K | Formula (b1-1): 0.50 ≤ (2.26) ≤ 3.45 | Formula (b2-1): 1.00 ≤ (2.26) ≤ 3.00 |
| | Formula (b1-2): | Formula (b2-2): |
| | 0.30 × (23.6) − 18.68 = −11.6 ≤ (2.26) | 0.20 × (23.6) − 11.00 = −6.28 ≤ (2.26) |
| | (2.26) ≤ 0.20 × (23.6) − 0.48 = 4.24 | (2.26) ≤ 0.10 × (23.6) = 2.36 |
| Cushioning | x_{A} = 10.6 [%], y_{A} = 1.01 [MPa] | x_{A} = 10.6 [%], y_{A} = 1.01 [MPa] |
| layer L | Formula (b1-1): 0.50 ≤ (1.01) ≤ 3.45 | Formula (b2-1): 1.00 ≤ (1.01) ≤ 3.00 |
| | Formula (b1-2): | Formula (b2-2): |
| | 0.30 × (10.6) − 18.68 = −15.5 ≤ (1.01) | 0.20 × (10.6) − 11.00 = −8.88 ≤ (1.01) |
| | (1.01) ≤ 0.20 × (10.6) − 0.48 = 1.64 | (1.01) ≤ 0.10 × (10.6) = 1.06 |
| | Example of compressed state satisfying | Example of compressed state satisfying |
| | Formula (b3-1) and Formula (b3-2) | Formula (b4-1) and Formula (b4-2) |
| Cushioning | x_{A} = 50.0 [%], y_{A} = 2.23 [MPa] | x_{A} = 50.0 [%], y_{A} = 2.23 [MPa] |
| layer I | Formula (b3-1): 1.50 ≤ (2.23) ≤ 3.00 | Formula (b4-1): 2.00 ≤ (2.23) ≤ 2.50 |
| | Formula (b3-2): | Formula (b4-2): |
| | 0.15 × (50.0) − 7.50 = 0 ≤ (2.23) | 0.10 × (50.0) − 3.50 = 1.50 ≤ (2.23) |
| | (2.23) ≤ 0.10 × (50.0) − 1.0 = 4.00 | (2.23) ≤ 0.10 × (50.0) − 1.5 = 3.50 |
| Cushioning | x_{A} = 46.2 [%], y_{A} = 2.21 [MPa] | x_{A} = 46.2 [%], y_{A} = 2.21 [MPa] |
| layer J | Formula (b3-1): 1.50 ≤ (2.21) ≤ 3.00 | Formula (b4-1): 2.00 ≤ (2.21) ≤ 2.50 |
| | Formula (b3-2): | Formula (b4-2): |
| | 0.15 × (46.2) − 7.50 = −0.57 ≤ (2.21) | 0.10 × (46.2) − 3.50 = 1.12 ≤ (2.21) |
| | (2.21) ≤ 0.10 × (46.2) − 1.0 = 3.62 | (2.21) ≤ 0.10 × (46.2) − 1.5 = 3.12 |
| Cushioning | none | none |
| layer K | | |
| Cushioning | none | none |
| layer L | | |

TABLE 2-4

| | Example of compressed state satisfying | Example of compressed state satisfying |
|---|---|---|
| | Formula (b1-1) and Formula (b1-2) | Formula (b2-1) and Formula (b2-2) |
| Cushioning | x_{A} = 40.1 [%], y_{A} = 2.90[MPa] | x_{A} = 40.1 [%], y_{A} = 2.90[MPa] |
| layer M | Formula (b1-1): 0.50 ≤ (2.90) ≤ 3.45 | Formula (b2-1): 1.00 ≤ (2.90) ≤ 3.00 |
| | Formula (b1-2): | Formula (b2-2): |
| | 0.30 × (40.1) − 18.68 = −6.65 ≤ (2.90) | 0.20 × (40.1) − 11.00 = −2.98 ≤ (2.90) |
| | (2.90) ≤ 0.20 × (40.1) − 0.48 = 7.54 | (2.90) ≤ 0.10 × (40.1) = − 4.01 |
| Cushioning | x_{A} = 7.5 [%], y_{A} = 1.02 [MPa] | none |
| layer N | Formula (b1-1): 0.50 ≤ (1.02) ≤ 3.45 | |
| | Formula (b1-2): | |
| | 0.30 × (7.5) − 18.68 = −16.43 ≤ (1.02) | |
| | (1.02) ≤ 0.20 × (7.5) − 0.48 = 1.02 | |
| Cushioning | x_{A} = 9.7 [%], y_{A} = 1.02 [MPa] | none |
| layer O | Formula (b1-1): 0.50 ≤ (1.02) ≤ 3.45 | |
| | Formula (b1-2): | |
| | 0.30 × (9.7) − 18.68 = −15.77 ≤ (1.02) | |
| | (1.02) ≤ 0.20 × (9.7) − 0.48 = 1.46 | |
| Cushioning | x_{A} = 11.4 [%], y_{A} = 1.02 [MPa] | x_{A} = 11.4 [%], y_{A} = 1.02 [MPa] |
| layer P | Formula (b1-1): 0.50 ≤ (1.02) ≤ 3.45 | Formula (b2-1): 1.00 ≤ (1.02) ≤ 3.00 |
| | Formula (b1-2): | Formula (b2-2): |
| | 0.30 × (11.4) − 18.68 = −15.26 ≤ (1.02) | 0.20 × (11.4) − 11.00 = −8.72 ≤ (1.02) |
| | (1.02) ≤ 0.20 × (11.4) − 0.48 = 1.8 | (1.02) ≤ 0.10 × (11.4) = 1.14 |

| | Example of compressed state satisfying | Example of compressed state satisfying |
|---|---|---|
| | Formula (b3-1) and Formula (b3-2) | Formula (b4-1) and Formula (b4-2) |
| Cushioning | x_{A} = 40.1 [%], y_{A} = 2.90[MPa] | none |
| layer M | Formula (b3-1): 1.50 ≤ (2.90) ≤ 3.00 | |
| | Formula (b3-2): | |
| | 0.15 × (40.1) − 7.50 = −1.49 ≤ (2.90) | |
| | (2.90) ≤ 0.10 × (40.1) − 1.0 = 3.01 | |
| Cushioning | none | none |
| layer N | | |
| Cushioning | none | none |
| layer O | | |
| Cushioning | none | none |
| layer P | | |

### <Measuring of Thermal Conductivity of Thermal Insulating Layer>

Thermal conductivity was measured for each of Thermal insulating layers A to K.

Thermal conductivity was measured separately in two ways: under a condition of 80 °C and 2 MPa and a condition of 600 °C and 2 MPa, in accordance with the description in Japanese Industrial Standards JIS A 1412-2: 1999, “Test Method for Thermal Resistance and Related Properties of Thermal Insulations-Part 2: Heat Flow Apparatus”. First, a thermal insulating layer (having a thickness of 2 mm under no pressure) was cut into a size of 20 mm×20 mm to prepare a sample. The sample, a reference sample (alumina composite material (“RS-100” manufactured by ZIRCAR Refractory Composites, Inc.; thickness: 5 mm; thermal conductivity: 0.66 W/(m·K))), and a titanium plate (thickness: 0.2 mm) were prepared. Subsequently, a first thermocouple (sheath thermocouple type K (SCHS1-0), φ=0.15, class JIS1, manufactured by Chino Corporation), a titanium plate, the thermal insulating layer as a sample, a titanium plate, a second thermocouple (sheath thermocouple type K (SCHS1-0), φ=0.15, class JIS1, manufactured by Chino Corporation), a standard plate, and a third thermocouple (sheath thermocouple type K (SCHS1-0), φ=0.15, class JIS1, manufactured by Chino Corporation) were stacked and held in this order from the top onto a surface of a lower disc of a pneumatic press (manufactured by Imoto machinery Co., Ltd.), and the thermal insulating layer, the standard plate, the thermocouples, and the like were closely attached to one another. The upper disc and the lower disc are then heated, and pressurized after adjusting a press so as to provide a load of 800 N (corresponding to 2 MPa). Measurement was continued under heating and pressurization until detection temperatures of the thermocouples were stable. With regard to measurement temperature, measurement was performed separately in two ways: 80 °C at an upper disc and 30 °C at a lower disc, and 600 °C at an upper disc and 40 °C at a lower disc. Stability of temperature was defined as change in temperature between before and after a duration of 10 minutes falling within ±0.1 °C. The thermal conductivity k1 of the thermal insulating layer was calculated from the detection temperature of each of the thermocouples after stabilization of the temperature, the thickness at compression of the thermal insulating layer, and the thermal conductivity and thickness of the standard sample, according to Formula (I) as follows. The thermal conductivities of the thermal insulating layers thus obtained are shown in Table 3-3.

k1=k2×(L1×ΔT1)/(L2×ΔT2) (I)
wherein k1 is the thermal conductivity [W/(m·K)] of the thermal insulating layer, k2 is the thermal conductivity [W/(m·K)] of the standard plate, L1 is the pressurized thickness of the thermal insulating layer, L2 is the thickness of the standard plate, ΔT1 is temperature differential between the temperature of the second thermocouple and the temperature of the third thermocouple, and ΔT2 is temperature differential between the temperature of the first thermocouple and the temperature of the second thermocouple.

### (Thermal Resistance)

The thermal resistance of a thermal insulating layer was calculated from the thermal conductivity k1 and the pressurized thickness L1 described above, according to Formula (II) as follows. The thermal resistance of athermal insulating layer thus obtained was shown in Table 3-3.

R1=L1/k1 (II)
wherein R1 is the thermal resistance [(m²·K)/W] of the thermal insulating layer, k1 is the thermal conductivity [W/(m·K)] of the thermal insulating layer, and L1 is the pressurized thickness of the thermal insulating layer.

TABLE 3-1

| | Basis | | Thickness [mm] | | | | | Strain | | | | | Shape of |
|---|---|---|---|---|---|---|---|---|---|---|---|---|---|
| | weight | Density | 0 | 0.34 | 1.00 | 1.39 | 3.45 | 0 | 0.34 | 1.00 | 1.39 | 3.45 | S-S curve |
| | [g/m²] | [g/cm³] | MPa | MPa | MPa | MPa | MPa | MPa | MPa | MPa | MPa | MPa | [point]^{(1*)} |
| Thermal insulating layer A | 460 | 0.23 | 2.0 | 1.44 | 1.18 | 1.10 | 0.84 | 0% | 28.0% | 41.0% | 45.0% | 58.0% | 0.0 |
| Thermal insulating layer B | 660 | 0.33 | 2.0 | 1.76 | 1.62 | 1.57 | 1.36 | 0% | 12.0% | 19.0% | 21.5% | 32.0% | 2.0 |
| Thermal insulating layer C | 740 | 0.37 | 2.0 | 1.79 | 1.70 | 1.65 | 1.40 | 0% | 10.5% | 14.9% | 17.4% | 29.9% | 2.5 |
| Thermal insulating layer D | 740 | 0.37 | 2.0 | 1.86 | 1.78 | 1.77 | 1.58 | 0% | 6.8% | 11.0% | 11.5% | 21.2% | 3.5 |
| Thermal insulating layer E | 800 | 0.40 | 2.0 | 1.89 | 1.83 | 1.80 | 1.69 | 0% | 5.3% | 8.7% | 10.0% | 15.4% | 3.5 |

^{(1*)}based on Regions (a1) to (a3)

TABLE 3-2

| | Basis | | Thickness [mm] | | | | | Strain | | | | | Shape of |
|---|---|---|---|---|---|---|---|---|---|---|---|---|---|
| | weight | Density | 0 | 0.34 | 1.00 | 1.39 | 3.45 | 0 | 0.34 | 1.00 | 1.39 | 3.45 | S-S curve |
| | [g/m²] | [g/cm³] | MPa | MPa | MPa | MPa | MPa | MPa | MPa | MPa | MPa | MPa | [point]^{(2*)} |
| Thermal insulating layer F | 370 | 0.37 | 1.0 | 0.89 | 0.84 | 0.82 | 0.71 | 0% | 11.3% | 15.9% | 18.0% | 28.6% | 3.0 |
| Thermal insulating layer G | 400 | 0.40 | 1.0 | 0.88 | 0.84 | 0.83 | 0.75 | 0% | 12.0% | 15.7% | 17.5% | 25.2% | 3.0 |
| Thermal insulating layer H | 666 | 0.37 | 1.8 | 1.68 | 1.60 | 1.57 | 1.42 | 0% | 6.8% | 11.0% | 12.9% | 21.2% | 3.5 |
| Thermal insulating layer I | 296 | 0.37 | 0.8 | 0.71 | 0.68 | 0.67 | 0.60 | 0% | 10.8% | 14.7% | 16.7% | 25.3% | 3.5 |
| Thermal insulating layer J | 444 | 0.37 | 1.2 | 1.07 | 1.02 | 0.99 | 0.88 | 0% | 11.0% | 15.2% | 17.1% | 26.3% | 3.0 |
| Thermal insulating layer K | 370 | 0.37 | 1.0 | 0.88 | 0.84 | 0.82 | 0.73 | 0% | 12.3% | 16.0% | 18.0% | 27.0% | 3.0 |

^{(2*)}based on Regions (a4) to (a6)

TABLE 3-3
Table 3-3

| | Thermal conductivity [W/m · K] | | Thermal resistance [m² · K/W] | |
|---|---|---|---|---|
| | 80 °C, 2 MPa | 600 °C, 2 MPa | 80 °C, 2 MPa | 600 °C, 2 MPa |
| Thermal insulating layer A | 0.036 | 0.065 | 0.028 | 0.015 |
| Thermal insulating layer B | 0.032 | 0.064 | 0.046 | 0.023 |
| Thermal insulating layer C | 0.035 | 0.066 | 0.045 | 0.024 |
| Thermal insulating layer D | 0.037 | 0.067 | 0.046 | 0.025 |
| Thermal insulating layer E | 0.040 | 0.073 | 0.043 | 0.023 |
| Thermal insulating layer F | 0.035 | 0.065 | 0.022 | 0.012 |
| Thermal insulating layer G | 0.034 | 0.065 | 0.024 | 0.012 |
| Thermal insulating layer H | 0.037 | 0.067 | 0.041 | 0.023 |
| Thermal insulating layer I | 0.037 | 0.067 | 0.018 | 0.010 |
| Thermal insulating layer J | 0.037 | 0.067 | 0.026 | 0.015 |
| Thermal insulating layer K | 0.037 | 0.056 | 0.021 | 0.014 |

TABLE 4-1

| | Average fiber | Fiber | Basis | | Thickness [mm] | | | | |
|---|---|---|---|---|---|---|---|---|---|
| | diameter | content | weight | Density | 0 | 0.34 | 1.00 | 1.39 | 3.45 |
| | [μm] | [% by mass] | [g/m²] | [g/cm³] | MPa | MPa | MPa | MPa | MPa |
| Cushioning Layer A | 7 | 85 | 500 | 0.17 | 3.00 | 1.77 | 1.21 | 1.06 | 0.74 |
| Cushioning Layer B | ↑ | ↑ | 600 | 0.18 | 3.30 | 2.11 | 1.37 | 1.16 | 0.63 |
| Cushioning Layer C | ↑ | ↑ | 600 | 0.20 | 3.00 | 2.39 | 1.65 | 1.43 | 0.87 |
| Cushioning Layer D | ↑ | ↑ | 700 | 0.21 | 3.30 | 2.75 | 1.51 | 1.29 | 0.76 |
| Cushioning Layer E | ↑ | ↑ | 700 | 0.23 | 3.00 | 2.39 | 1.80 | 1.54 | 0.93 |
| Cushioning Layer F | ↑ | ↑ | 800 | 0.24 | 3.30 | 2.77 | 1.93 | 1.71 | 1.00 |
| Cushioning Layer G | ↑ | ↑ | 800 | 0.27 | 3.00 | 2.66 | 2.16 | 1.86 | 1.09 |
| Cushioning Layer H | ↑ | ↑ | 1000 | 0.30 | 3.30 | 2.82 | 2.21 | 1.92 | 1.18 |
| Cushioning Layer I | ↑ | ↑ | 1000 | 0.33 | 3.00 | 2.75 | 2.34 | 2.08 | 1.28 |
| Cushioning Layer J | ↑ | ↑ | 1200 | 0.36 | 3.30 | 3.03 | 2.52 | 2.21 | 1.39 |
| Cushioning Layer K | ↑ | ↑ | 1200 | 0.40 | 3.00 | 2.86 | 2.71 | 2.61 | 1.85 |
| Cushioning Layer L | ↑ | ↑ | 1400 | 0.42 | 3.30 | 3.12 | 2.95 | 2.84 | 2.02 |
| Cushioning Layer M | ↑ | ↑ | 1556 | 0.43 | 3.60 | 3.37 | 3.14 | 2.98 | 1.86 |
| Cushioning Layer N | ↑ | ↑ | 1400 | 0.47 | 3.00 | 2.88 | 2.78 | 2.72 | 2.20 |
| Cushioning Layer O | ↑ | ↑ | 1656 | 0.50 | 3.30 | 3.10 | 2.99 | 2.94 | 2.26 |
| Cushioning Layer P | ↑ | ↑ | 1556 | 0.52 | 3.00 | 2.77 | 2.66 | 2.58 | 2.22 |
| Cushioning Layer Q | ↑ | ↑ | 800 | 0.20 | 4.00 | 2.66 | 1.84 | 1.64 | 1.19 |
| Cushioning Layer R | ↑ | ↑ | 800 | 0.19 | 4.20 | 2.81 | 1.94 | 1.73 | 1.24 |
| Cushioning Layer S | ↑ | ↑ | 1050 | 0.26 | 4.00 | 3.45 | 2.61 | 2.29 | 1.58 |
| Cushioning Layer T | ↑ | ↑ | 900 | 0.25 | 3.50 | 2.93 | 2.12 | 1.86 | 1.30 |

| | Strain | | | | | Shape of |
|---|---|---|---|---|---|---|
| | 0 | 0.34 | 1.00 | 1.39 | 3.45 | S-S curve |
| | MPa | MPa | MPa | MPa | MPa | [point]^{(3*)} |
| Cushioning Layer A | 0.0% | 41.0% | 59.8% | 64.7% | 75.4% | 2.0 |
| Cushioning Layer B | 0.0% | 36.2% | 58.4% | 64.7% | 80.9% | 2.0 |
| Cushioning Layer C | 0.0% | 20.5% | 45.1% | 52.5% | 71.0% | 2.0 |
| Cushioning Layer D | 0.0% | 16.8% | 54.3% | 61.0% | 77.0% | 3.5 |
| Cushioning Layer E | 0.0% | 20.5% | 40.0% | 48.6% | 69.0% | 3.5 |
| Cushioning Layer F | 0.0% | 16.2% | 41.4% | 48.3% | 69.6% | 3.5 |
| Cushioning Layer G | 0.0% | 11.2% | 28.1% | 38.1% | 63.6% | 4.5 |
| Cushioning Layer H | 0.0% | 14.4% | 33.0% | 41.8% | 64.2% | 4.5 |
| Cushioning Layer I | 0.0% | 8.5% | 22.0% | 30.8% | 57.2% | 4.5 |
| Cushioning Layer J | 0.0% | 8.3% | 23.6% | 33.0% | 58.0% | 4.5 |
| Cushioning Layer K | 0.0% | 4.8% | 9.7% | 13.0% | 38.3% | 2.0 |
| Cushioning Layer L | 0.0% | 5.4% | 10.6% | 14.0% | 38.8% | 2.0 |
| Cushioning Layer M | 0.0% | 6.4% | 12.8% | 17.2% | 48.4% | 3.0 |
| Cushioning Layer N | 0.0% | 4.0% | 7.4% | 9.4% | 26.8% | 1.0 |
| Cushioning Layer O | 0.0% | 6.0% | 9.4% | 11.0% | 31.5% | 1.5 |
| Cushioning Layer P | 0.0% | 7.8% | 11.3% | 14.0% | 26.0% | 1.5 |
| Cushioning Layer Q | 0.0% | 33.5% | 53.9% | 59.0% | 70.3% | 3.5 |
| Cushioning Layer R | 0.0% | 33.0% | 53.7% | 58.8% | 70.5% | 3.5 |
| Cushioning Layer S | 0.0% | 13.8% | 34.8% | 42.8% | 60.6% | 4.5 |
| Cushioning Layer T | 0.0% | 16.2% | 39.5% | 46.8% | 62.9% | 4.5 |

^{(3*)}based on Regions (b1) to (b4)

As shown by scores of the shapes of the S-S curves in Table 4-1, each of Cushioning layers A to T provided a stress-strain curve passing at least Region (b1) in a compression test (see FIGS. 16 to 28).

TABLE 4-2

| | | Basis | | Thickness [mm] | | | | |
|---|---|---|---|---|---|---|---|---|
| | | weight | Density | 0 | 0.34 | 1.00 | 1.39 | 3.45 |
| | Material | [g/m²] | [g/cm³] | MPa | MPa | MPa | MPa | MPa |
| Cushioning Layer U | glass wool | 500 | 0.14 | 3.50 | 1.76 | 1.26 | 1.12 | 0.83 |
| Cushioning Layer V | glass wool | 500 | 0.10 | 5.00 | 1.77 | 1.16 | 1.00 | 0.66 |
| Cushioning Layer W | glass wool | 600 | 0.12 | 5.00 | 2.10 | 1.60 | 1.45 | 0.68 |
| Cushioning Layer X | glass wool | 600 | 0.18 | 2.90 | 1.32 | 0.99 | 0.91 | 0.69 |
| Cushioning Layer Y | NR foam | 2975 | 0.35 | 8.50 | 4.20 | 2.81 | 2.55 | 2.06 |
| Cushioning Layer Z | urethane foam | 2880 | 0.48 | 6.00 | 2.78 | 1.91 | 1.72 | 1.35 |

| | Strain | | | | | Shape of |
|---|---|---|---|---|---|---|
| | 0 | 0.34 | 1.00 | 1.39 | 3.45 | S-S curve |
| | MPa | MPa | MPa | MPa | MPa | [point]^{(4*)} |
| Cushioning Layer U | 0.00% | 49.6% | 64.1% | 67.9% | 76.4% | 4.5 |
| Cushioning Layer V | 0.00% | 64.6% | 76.9% | 80.0% | 86.9% | 4.5 |
| Cushioning Layer W | 0.00% | 58.0% | 68.0% | 71.0% | 86.5% | 4.5 |
| Cushioning Layer X | 0.00% | 54.5% | 65.8% | 68.7% | 76.3% | 4.5 |
| Cushioning Layer Y | 0.00% | 50.6% | 66.9% | 70.0% | 75.8% | 4.5 |
| Cushioning Layer Z | 0.00% | 53.6% | 68.2% | 71.3% | 77.5% | 4.5 |

^{(4*)}based on Regions (b5) to (b8)

As shown by scores of the shapes of the S-S curves in Table 4-2, each of Cushioning layers U to Z provided a stress-strain curve passing at least Region (b5) in a compression test (see FIGS. 29 to 31).

### <Production of Thermal Insulating Material (Thermal Insulating Layer+Cushioning Layer)>

### Example 1

Thermal insulating layer B and Cushioning layer A were stacked in combination, and the stack was covered with a covering layer having a vent hole, thereby producing a thermal insulating material. In particular, a thermal insulating material according to Example 1 was produced by stacking one polyethylene terephthalate (PET)-based shrink film (manufactured by Mitsubishi Chemical Group Corporation, product name: “HISHIPET PX-40S”, thickness: 20 μm) on each of the upper surface and the lower surface of a stack of Thermal insulating layer B and Cushioning layer A; melt-cutting the shrink films into a size 10% larger than the planar shape of the stack in area ratio and melt-bonding of the upper and lower films around the stack; forming a through hole as a vent hole in the films by a needle or laser; and then heating at 95 °C for 15 seconds in a heating oven to shrink the films. The vent hole was formed so as to sufficiently allow air to flow between the inside (a space for containing the stack) and the outside of the covering layer in the loading-unloading test described later.

### Examples 2 to 16

Thermal insulating materials were produced by the same production procedure as in Example 1 except that combinations of thermal insulating layers and cushioning layers were as shown in Table 5-1.

### Examples 17 to 25

Thermal insulating material were produced by the same production procedure as in Example 1 except that combinations of thermal insulating layers and cushioning layers were as shown in Table 5-2.

### <Loading-Unloading Test 1: High-Pressure Condition>

For each of Examples 1 to 25, a loading-unloading test was performed by the following method to measure thicknesses and compressive strains of thermal insulating materials at each of the following points.

Using a precision universal testing machine (AUTOGRAPH AGS-5kNX, manufactured by Shimadzu Corporation), a thermal insulating material was compressed at a compression rate of 0.5 mm/min to reach a compressive stress of 3.45 MPa, and then the compression to the thermal insulating material was released at a compression rate of 0.5 mm/min to reach a compressive stress of 0. FIG. 32 depicts a stress-strain curve (S-S curve) schematically illustrating the loading-unloading test.

A thickness and a compression displacement of a thermal insulating material at each point was calculated by extracting compression displacements of the thermal insulating material at a pressure of 0.34 MPa and at a pressure of 3.45 MPa in a compression process in the loading-unloading test, and further extracting, in a compression releasing process, a compression displacement of the thermal insulating material in a compressed state having the same displacement as that at a compressive stress of 0.34 MPa in the compression process. The results are shown in Table 5-1 and Table 5-4. Table 5-1 and Table 5-4 show values each derived by subtracting a compressive strain at a pressure of 0.34 MPa from a compressive strain at a pressure of 3.45 MPa in a compression process (strain difference (Xhp)), and values each derived by subtracting a compressive strain in the compressed state (i.e., a compressed state having the same displacement as that at a compressive stress of 0.34 MPa in a compression process) from a compressive strain at a pressure of 3.45 MPa in a compression releasing process (strain difference (Xhr)), together.

### <Loading-Unloading Test 2: Low-Pressure Condition>

For each of Examples 1 to 25, a loading-unloading test was performed by the following method to measure thicknesses and compressive strains of thermal insulating materials at each of the following points.

Using a precision universal testing machine (AUTOGRAPH AGS-5kNX, manufactured by Shimadzu Corporation, a thermal insulating material was compressed at a compression rate of 0.5 mm/min to reach a compressive stress of 1.39 MPa, and then the compression to the thermal insulating material was released at a compression rate of 0.5 mm/min to reach a compressive stress of 0. FIG. 33 depicts a stress-strain curve (S-S curve) schematically illustrating the loading-unloading test.

A thickness and a compression displacement of a thermal insulating material at each point was calculated by extracting compression displacements of the thermal insulating material at a pressure of 0.03 MPa and at a pressure of 1.39 MPa in a compression process in the loading-unloading test, and further extracting, in a compression releasing process, a compression displacement of the thermal insulating material in a compressed state having the same displacement as that at a compressive stress of 0.03 MPa in the compression process. The results are shown in Table 5-2 and Table 5-3. Table 5-2 and Table 5-3 show values each derived by subtracting a compressive strain at a pressure of 0.03 MPa from a compressive strain at a pressure of 1.39 MPa in a compression process (strain difference (Xlp)), and values each derived by subtracting a compressive strain in the compressed state (i.e., a compressed state having the same displacement as that at a compressive stress of 0.03 MPa in a compression process) from a compressive strain at a pressure of 1.39 MPa in a compression releasing process (strain difference (Xlr)), together.

TABLE 5-1

| | | | Shape of S-S curve | | | | |
|---|---|---|---|---|---|---|---|
| | | | Thermal | | | 0.34 MPa at compression | |
| | | | insulating | Cushioning | | Displacement | |
| | | | layer | layer | Total | of thickness | |
| | Thermal insulating layer | Cushioning layer | [point](1*) | [point](3*) | [point] | [mm] | Strain |
| Example 1 | Thermal insulating layer B | Cushioning layer A | 2.0 | 2.0 | 4.0 | 1.37 | 26% |
| Example 2 | Thermal insulating layer B | Cushioning layer B | 2.0 | 2.0 | 4.0 | 1.69 | 32% |
| Example 3 | Thermal insulating layer C | Cushioning layer B | 2.5 | 2.0 | 4.5 | 1.78 | 34% |
| Example 4 | Thermal insulating layer D | Cushioning layer B | 3.5 | 2.0 | 5.5 | 1.70 | 32% |
| Example 5 | Thermal insulating layer E | Cushioning layer B | 3.5 | 2.0 | 5.5 | 1.00 | 20% |
| Example 6 | Thermal insulating layer C | Cushioning layer G | 2.5 | 4.5 | 7.0 | 1.00 | 20% |
| Example 7 | Thermal insulating layer D | Cushioning layer G | 3.5 | 4.5 | 8.0 | 0.80 | 16% |
| Example 8 | Thermal insulating layer E | Cushioning layer G | 3.5 | 4.5 | 8.0 | 0.72 | 14% |
| Example 9 | Thermal insulating layer B | Cushioning layer J | 2.0 | 4.5 | 6.5 | 0.81 | 15% |
| Example 10 | Thermal insulating layer C | Cushioning layer J | 2.5 | 4.5 | 7.0 | 0.52 | 10% |
| Example 11 | Thermal insulating layer D | Cushioning layer J | 3.5 | 4.5 | 8.0 | 0.49 | 9% |
| Example 12 | Thermal insulating layer E | Cushioning layer J | 3.5 | 4.5 | 8.0 | 0.38 | 7% |
| Example 13 | Thermal insulating layer B | Cushioning layer K | 2.0 | 2.0 | 4.0 | 0.34 | 7% |
| Example 14 | Thermal insulating layer B | Cushioning layer P | 2.0 | 2.0 | 4.0 | 0.40 | 8% |
| Example 15 | Thermal insulating layer H | Cushioning layer S | 3.0 | 4.5 | 7.5 | 0.77 | 13% |
| Example 16 | Thermal insulating layer D | Cushioning layer T | 3.5 | 4.5 | 8.0 | 0.85 | 15% |

| | | | | | 0.34→3.45 MPa | | 3.45→0.34 MPa | |
|---|---|---|---|---|---|---|---|---|
| | 3.45 MPa at end point | | 0.34 MPa at relese | | Difference in | | Difference in | |
| | Displacement | | Displacement | | displacement | Strain | displacement | Strain |
| | of thickness | | of thickness | | of thickness | difference | of thickness | difference |
| | [mm] | Strain | [mm] | Strain | [mm] | (Xhp) | [mm] | (Xhr) |
| Example 1 | 2.99 | 60% | 2.63 | 53% | 1.62 | 34% | 0.36 | 7% |
| Example 2 | 3.21 | 61% | 2.89 | 55% | 1.52 | 29% | 0.32 | 6% |
| Example 3 | 3.12 | 59% | 2.86 | 54% | 1.34 | 25% | 0.26 | 5% |
| Example 4 | 3.03 | 57% | 2.77 | 52% | 1.40 | 26% | 0.26 | 5% |
| Example 5 | 3.06 | 57% | 2.78 | 52% | 1.36 | 25% | 0.28 | 5% |
| Example 6 | 2.65 | 53% | 2.34 | 47% | 1.63 | 33% | 0.31 | 6% |
| Example 7 | 2.43 | 49% | 2.12 | 43% | 1.65 | 33% | 0.31 | 6% |
| Example 8 | 2.42 | 48% | 2.09 | 42% | 1.70 | 34% | 0.33 | 6% |
| Example 9 | 2.72 | 51% | 2.30 | 43% | 1.91 | 36% | 0.42 | 8% |
| Example 10 | 2.50 | 47% | 2.13 | 40% | 1.89 | 36% | 0.40 | 8% |
| Example 11 | 2.38 | 45% | 1.98 | 37% | 1.56 | 30% | 0.42 | 8% |
| Example 12 | 1.94 | 37% | 1.52 | 29% | 1.98 | 37% | 0.37 | 7% |
| Example 13 | 1.74 | 35% | 1.25 | 25% | 1.40 | 28% | 0.49 | 10% |
| Example 14 | 1.23 | 25% | 0.79 | 16% | 0.83 | 17% | 0.44 | 9% |
| Example 15 | 2.77 | 48% | 2.44 | 42% | 2.00 | 34% | 0.33 | 6% |
| Example 16 | 2.80 | 51% | 2.48 | 45% | 1.95 | 35% | 0.32 | 6% |

(1*)based on regions (a1) to (a3),
(3*)based on Regions (b1) to (b4)

As shown in Table 5-1, each of the thermal insulating materials of Examples 1 to 16, which includes a cushioning layer that alone provides a stress-strain curve passing at least Region (b) in a compression test, exhibited a strain difference (Xhp) of 15% or more in a compression process and a strain difference (Xhr) of 5% in a compression releasing process in Loading-unloading test 1 under a high-pressure condition, indicating suitable change in its thickness corresponding to pressure. Each of these thermal insulating materials had a total score of 4.0 or more for the shape of a S-S curve. This suggests that a thermal insulating material exhibiting a compression property that allows use as a thermal insulating material placed between cells in a battery module or the like can be efficiently produced by suitably combining a thermal insulating layer and a cushioning layer in such a manner that the total score of the shape of the S-S curve of the thermal insulating layer and the shape of the S-S curve of the cushioning layer is equal to or more than a predetermined value, in terms of a region set on a graph with strain on the x-axis and stress on the y-axis. Furthermore, each of thermal insulating materials having a total score of 6.0 or more for the shape of S-S curves exhibited a better compression property, with a strain difference (Xhp) of 30% or more in a compression process and a strain difference (Xhr) of 6% or more in a compression releasing process.

TABLE 5-2

| | | | Shape of S-S curve | | | | |
|---|---|---|---|---|---|---|---|
| | | | Thermal | | | 0.03 MPa at compression | |
| | | | insulating | Cushioning | | Displacement | |
| | | | layer | layer | Total | of thickness | |
| | Thermal insulating layer | Cushioning layer | [point](2*) | [point](4*) | [point] | [mm] | Strain |
| Example 17 | Thermal insulating layer F | Cushioning layer U | 3.0 | 4.5 | 7.5 | 0.60 | 13% |
| Example 18 | Thermal insulating layer F | Cushioning layer V | 3.0 | 4.5 | 7.5 | 1.45 | 24% |
| Example 19 | Thermal insulating layer G | Cushioning layer U | 3.0 | 4.5 | 7.5 | 0.41 | 9% |
| Example 20 | Thermal insulating layer G | Cushioning layer V | 3.0 | 4.5 | 7.5 | 1.01 | 17% |
| Example 21 | Thermal insulating layer F | Cushioning layer W | 3.0 | 4.5 | 7.5 | 1.10 | 18% |
| Example 22 | Thermal insulating layer I | Cushioning layer X | 3.5 | 4.5 | 8.0 | 0.95 | 26% |
| Example 23 | Thermal insulating layer J | Cushioning layer Y | 3.0 | 4.5 | 7.5 | 0.37 | 4% |
| Example 24 | Thermal insulating layer J | Cushioning layer Z | 3.0 | 4.5 | 7.5 | 0.41 | 6% |
| Example 25 | Thermal insulating layer K | Cushioning layer U | 3.0 | 4.5 | 7.5 | 0.63 | 14% |

| | | | | | 0.03→1.39 MPa | | 1.39→0.03 MPa | |
|---|---|---|---|---|---|---|---|---|
| | 1.39 MPa at end point | | 0.03 MPa at relese | | Difference in | | Difference in | |
| | Displacement | | Displacement | | displacement | Strain | displacement | Strain |
| | of thickness | | of thickness | | of thickness | difference | of thickness | difference |
| | [mm] | Strain | [mm] | Strain | [mm] | (Xlp) | [mm] | (Xlr) |
| Example 17 | 2.81 | 63% | 1.89 | 42% | 2.21 | 49% | 0.92 | 21% |
| Example 18 | 4.10 | 68% | 3.06 | 51% | 2.65 | 44% | 1.04 | 17% |
| Example 19 | 2.68 | 60% | 1.80 | 40% | 2.27 | 50% | 0.88 | 20% |
| Example 20 | 4.02 | 67% | 2.88 | 48% | 3.01 | 50% | 1.14 | 19% |
| Example 21 | 4.31 | 72% | 3.12 | 52% | 3.21 | 54% | 1.19 | 20% |
| Example 22 | 2.19 | 58% | 1.63 | 44% | 1.24 | 32% | 0.56 | 14% |
| Example 23 | 5.86 | 60% | 1.26 | 13% | 5.49 | 57% | 4.60 | 47% |
| Example 24 | 4.7 | 65% | 1.33 | 19% | 4.29 | 60% | 3.37 | 47% |
| Example 25 | 2.83 | 63% | 2.10 | 47% | 2.25 | 49% | 0.73 | 16% |

(2*)based on Regions (a4) to (a6),
(4*)based on Regions (b5) to (b8)

As shown in Table 5-2, each of the thermal insulating materials of Examples 17 to 26, which includes a cushioning layer that alone provides a stress-strain curve passing at least Region (b5) in a compression test, exhibited a strain difference (Xlp) of 15% or more in a compression process and a strain difference (Xlr) of 5% in a compression releasing process in Loading-unloading test 2 under a low-pressure condition, indicating suitable change in its thickness corresponding to pressure. Each of these thermal insulating materials was a combination of a thermal insulating layer providing a stress-strain curve passing Region (a6) and a cushioning layer providing a stress-strain curve passing Region (b8), had a total score of 6.0 or more for the shape of S-S curves, and exhibited an excellent compression property with a strain difference (Xlp) of 30% or more in a compression process and a strain difference (Xlr) of 6% or more in a compression releasing process. This confirmed that a thermal insulating material exhibiting a compression property that allows use as a thermal insulating material placed between cells in a battery module or the like can be efficiently produced by suitably combining a thermal insulating layer and a cushioning layer in such a manner that the total score of the shape of the S-S curve of the thermal insulating layer and the shape of the S-S curve of the cushioning layer is equal to or more than a predetermined value, in terms of a region set on a graph with strain on the x-axis and stress on the y-axis.

The following Table 5-3 shows results of evaluation of the thermal insulating materials according to Examples 1 to 16 by Loading-unloading test 2 (low-pressure condition), and the following Table 5-4 shows results of evaluation of the thermal insulating materials according to Examples 17 to 25 by Loading-unloading test 1 (high-pressure condition).

TABLE 5-3

| | | | 0.03 MPa at compression | | 1.39 MPa at end point | |
|---|---|---|---|---|---|---|
| | | | Displacement | | Displacement | |
| | | | of thickness | | of thickness | |
| | Thermal insulating layer | Cushioning layer | [mm] | Strain | [mm] | Strain |
| Example 1 | Thermal insulating layer B | Cushioning layer A | 0.17 | 3% | 2.70 | 54% |
| Example 2 | Thermal insulating layer B | Cushioning layer B | 0.32 | 6% | 2.65 | 50% |
| Example 3 | Thermal insulating layer C | Cushioning layer B | 0.27 | 5% | 2.55 | 48% |
| Example 4 | Thermal insulating layer D | Cushioning layer B | 0.19 | 4% | 2.49 | 47% |
| Example 5 | Thermal insulating layer E | Cushioning layer B | 0.21 | 4% | 2.49 | 47% |
| Example 6 | Thermal insulating layer C | Cushioning layer G | 0.15 | 3% | 2.05 | 41% |
| Example 7 | Thermal insulating layer D | Cushioning layer G | 0.15 | 3% | 1.80 | 36% |
| Example 8 | Thermal insulating layer E | Cushioning layer G | 0.10 | 2% | 1.75 | 35% |
| Example 9 | Thermal insulating layer B | Cushioning layer J | 0.10 | 2% | 1.96 | 37% |
| Example 10 | Thermal insulating layer C | Cushioning layer J | 0.09 | 2% | 1.59 | 30% |
| Example 11 | Thermal insulating layer D | Cushioning layer J | 0.16 | 3% | 1.40 | 26% |
| Example 12 | Thermal insulating layer E | Cushioning layer J | 0.11 | 2% | 0.95 | 18% |
| Example 13 | Thermal insulating layer B | Cushioning layer K | 0.13 | 3% | 1.15 | 23% |
| Example 14 | Thermal insulating layer B | Cushioning layer P | 0.15 | 3% | 0.75 | 15% |
| Example 15 | Thermal insulating layer H | Cushioning layer S | 0.25 | 4% | 2.49 | 43% |
| Example 16 | Thermal insulating layer D | Cushioning layer T | 0.55 | 10% | 2.49 | 45% |

| | | | 0.03→1.39 MPa | | 1.39→0.03 MPa | |
|---|---|---|---|---|---|---|
| | 0.03 MPa at relese | | Difference in | | Difference in | |
| | Displacement | | displacement | Strain | displacement | Strain |
| | of thickness | | of thickness | difference | of thickness | difference |
| | [mm] | Strain | [mm] | (Xlp) | [mm] | (Xlr) |
| Example 1 | 2.29 | 46% | 2.53 | 51% | 0.41 | 8% |
| Example 2 | 2.12 | 40% | 2.33 | 44% | 0.53 | 10% |
| Example 3 | 1.81 | 34% | 2.28 | 43% | 0.74 | 14% |
| Example 4 | 1.86 | 35% | 2.31 | 44% | 0.63 | 12% |
| Example 5 | 1.70 | 32% | 2.28 | 43% | 0.79 | 15% |
| Example 6 | 1.06 | 21% | 1.90 | 38% | 0.99 | 20% |
| Example 7 | 1.21 | 24% | 1.65 | 33% | 0.59 | 12% |
| Example 8 | 1.19 | 24% | 1.65 | 33% | 0.56 | 11% |
| Example 9 | 0.68 | 13% | 1.86 | 35% | 1.28 | 24% |
| Example 10 | 0.72 | 14% | 1.50 | 28% | 0.87 | 16% |
| Example 11 | 0.65 | 12% | 1.24 | 23% | 0.75 | 14% |
| Example 12 | 0.61 | 12% | 0.85 | 16% | 0.34 | 6% |
| Example 13 | 0.82 | 17% | 1.03 | 21% | 0.33 | 7% |
| Example 14 | 0.70 | 14% | 0.60 | 12% | 0.05 | 1% |
| Example 15 | 1.26 | 22% | 2.24 | 39% | 1.23 | 21% |
| Example 16 | 1.41 | 26% | 1.94 | 35% | 1.08 | 20% |

TABLE 5-4

| | | | 0.34 MPa at compression | | 3.45 MPa at end point | |
|---|---|---|---|---|---|---|
| | | | Displacement | | Displacement | |
| | | | of thickness | | of thickness | |
| | Thermal insulating layer | Cushioning layer | [mm] | Strain | [mm] | Strain |
| Example 17 | Thermal insulating layer F | Cushioning layer U | 2.11 | 47% | 3.21 | 71% |
| Example 18 | Thermal insulating layer F | Cushioning layer V | 3.46 | 58% | 4.67 | 78% |
| Example 19 | Thermal insulating layer G | Cushioning layer U | 1.86 | 41% | 3.30 | 73% |
| Example 20 | Thermal insulating layer G | Cushioning layer V | 3.26 | 54% | 4.56 | 76% |
| Example 21 | Thermal insulating layer F | Cushioning layer W | 3.43 | 57% | 4.74 | 79% |
| Example 22 | Thermal insulating layer I | Cushioning layer X | 1.71 | 46% | 2.45 | 66% |
| Example 23 | Thermal insulating layer J | Cushioning layer Y | 4.18 | 43% | 6.62 | 68% |
| Example 24 | Thermal insulating layer J | Cushioning layer Z | 3.82 | 53% | 5.43 | 76% |
| Example 25 | Thermal insulating layer K | Cushioning layer U | 2.24 | 50% | 3.27 | 73% |

| | | | 0.34→3.45 MPa | | 3.45→0.34 MPa | |
|---|---|---|---|---|---|---|
| | 0.34 MPa at relese | | Difference in | | Difference in | |
| | Displacement | | displacement | Strain | displacement | Strain |
| | of thickness | | of thickness | difference | of thickness | difference |
| | [mm] | Strain | [mm] | (Xhp) | [mm] | (Xhr) |
| Example 17 | 2.99 | 64% | 1.10 | 25% | 0.22 | 7% |
| Example 18 | 4.44 | 72% | 1.21 | 20% | 0.23 | 6% |
| Example 19 | 3.11 | 66% | 1.44 | 32% | 0.19 | 7% |
| Example 20 | 4.43 | 71% | 1.30 | 22% | 0.13 | 6% |
| Example 21 | 4.53 | 72% | 1.31 | 22% | 0.21 | 7% |
| Example 22 | 2.19 | 53% | 0.74 | 20% | 0.26 | 13% |
| Example 23 | 5.08 | 52% | 2.44 | 25% | 1.54 | 16% |
| Example 24 | 4.49 | 62% | 1.61 | 23% | 0.94 | 13% |
| Example 25 | 3.06 | 68% | 1.03 | 23% | 0.21 | 5% |

Although specific examples of the present invention have been described in detail so far, these are merely for illustrations and do not limit the scope of the claims. The art recited in the claims includes various modifications and changes made to the specific examples illustrated above.

### REFERENCE SIGNS LIST

1, 52 thermal insulating material
10, 10A, 10B, 521 thermal insulating layer
20, 20A, 20B, 522 cushioning layer
30, 523 covering material (covering layer)
31A, 31B resin film
32 sealing part
33 vent hole
34 venting film
40 adhesive layer
50 battery module
51 battery cell

1. A thermal insulating material comprising a thermal insulating layer comprising inorganic particles, and a cushioning layer formed of a fiber-containing shaped material comprising fiber or a foamed shaped material comprising foam,
wherein the cushioning layer is a layer capable of generating a compressed state with a compressive strain value x_{B} [%] and a compressive stress value y_{B} [MPa] satisfying the following Formula (b1-1) and the following Formula (b1-2) in a compression test at a compression rate of 0.5 mm/min only for the cushioning layer:
0.50≤y_{B}≤3.45 Formula(b1-1)
0.30x_{B}−18.68≤y_{B}≤0.20x_{B}−0.48 Formula (b1-2)

2. The thermal insulating material according to claim 1, wherein the thermal insulating layer is a layer capable of generating a compressed state with a compressive strain value x_{A} [%] and a compressive stress value y_{A} [MPa] satisfying the following Formula (a1-1) and the following Formula (a1-2) in a compression test at a compression rate of 0.5 mm/min only for the thermal insulating layer:
0.50≤y_{A}≤3.45 Formula (a1-1)
0.12x_{A}−2.45≤y_{A} Formula (a1-2)

3. The thermal insulating material according to claim 1, wherein the cushioning layer is a layer capable of generating a compressed state with a compressive strain value x_{B} [%] and a compressive stress value y_{B} [MPa] satisfying the following Formula (b2-1) and the following Formula (b2-2) in the compression test:
1.00≤y_{B}≤3.00 Formula (b2-1)
0.20x_{B}−11.00≤y_{B}≤0.10x_{B} Formula (b2-2)

4. The thermal insulating material according to claim 2, wherein the thermal insulating layer is a layer capable of generating a compressed state with a compressive strain value x_{A} [%] and a compressive stress value y_{A} [MPa] satisfying the following Formula (a2-1) and the following Formula (a2-2) in the compression test:
1.00≤y_{A}≤3.00 Formula (a2-1)
0.20x_{A}−3.00≤y_{A} Formula (a2-2)

5. The thermal insulating material according to claim 3, wherein the cushioning layer is a layer capable of generating a compressed state with a compressive strain value x_{B} [%] and a compressive stress value y_{B} [MPa] satisfying the following Formula (b3-1) and the following Formula (b3-2) in the compression test:
1.50≤y_{B}≤3.00 Formula (b3-1)
0.15x_{B}−7.50≤y_{B}≤0.10x_{B}−1.00 Formula (b3-2)

6. The thermal insulating material according to claim 4, wherein the thermal insulating layer is a layer capable of generating a compressed state with a compressive strain value x_{A} [%] and a compressive stress value y_{A} [MPa] satisfying the following Formula (a3-1) and the following Formula (a3-2) in the compression test:
1.50≤y_{A}≤2.50 Formula (a3-1)
0.20x_{A}−1.50≤y_{A} Formula (a3-2)

7. The thermal insulating material according to claim 5, wherein the cushioning layer is layer capable of generating a compressed state with a compressive strain value x_{B} [%] and a compressive stress value y_{B} [MPa] satisfying the following Formula (b4-1) and the following Formula (b4-2) in the compression test:
2.00≤y_{B}≤2.50 Formula (b4-1)
0.10x_{B}−3.50≤y_{B}≤0.10x_{B}−1.50 Formula (b4-2)

8. The thermal insulating material according to claim 1, wherein the inorganic particles in the thermal insulating layer are silicon dioxide particles.

9. The thermal insulating material according to claim 8, wherein the silicon dioxide particles are at least one kind selected from the group consisting of dry silica, wet silica, and silica aerogel.

10. (canceled)

11. The thermal insulating material according to claim 1, wherein the thermal insulating layer is a shaped material shaped from a mixture containing inorganic particles and inorganic fiber.

12. (canceled)

13. A thermal insulating material comprising a thermal insulating layer comprising inorganic particles, and a cushioning layer formed of a fiber-containing shaped material comprising fiber or a foamed shaped material comprising foam,
wherein the cushioning layer is a layer capable of generating a compressed state with a compressive strain value x_{B} [%] and a compressive stress value y_{B} [MPa] satisfying the following Formula (b5-1) and the following Formula (b5-2) in a compression test at a compression rate of 0.5 mm/min only for the cushioning layer:
0.10≤y_{B}≤1.39 Formula (b5-1)
0.129x_{B}−9.575≤y_{B}≤0.129x_{B}−1.19 Formula (b5-2)

14. The thermal insulating material according to claim 13, wherein the thermal insulating layer is a layer capable of generating a compressed state with a compressive strain value x_{A} [%] and a compressive stress value y_{A} [MPa] satisfying the following Formula (a4-1) and the following Formula (a4-2) in a compression test at a compression rate of 0.5 mm/min only for the thermal insulating layer:
0.10≤y_{A}≤1.39 Formula (a4-1)
0.043x_{A}−0.545≤y_{A} Formula (a4-2)

15. The thermal insulating material according to claim 13, wherein the cushioning layer is a layer capable of generating a compressed state with a compressive strain value x_{B} [%] and a compressive stress value y_{B} [MPa] satisfying the following Formula (b6-1) and the following Formula (b6-2) in the compression test:
0.20≤y_{B}≤1.10 Formula (b6-1)
0.12x_{B}−8.80≤y_{B}≤0.036x_{B}−0.34. Formula (b6-2)

16. The thermal insulating material according to claim 14, wherein the thermal insulating layer is a layer capable of generating a compressed state with a compressive strain value x_{A} [%] and a compressive stress value y_{A} [MPa] satisfying the following Formula (a5-1) and the following Formula (a5-2) in the compression test:
0.20≤y_{A}≤1.10 Formula (a5-1)
0.09x_{A}−1.15≤y_{A} Formula (a5-2)

17. The thermal insulating material according to claim 15, wherein the cushioning layer is a layer capable of generating a compressed state with a compressive strain value x_{B} [%] and a compressive stress value y_{B} [MPa] satisfying the following Formula (b7-1) and the following Formula (b7-2) in the compression test:
0.30≤y_{B}≤0.90 Formula (b7-1)
0.12x_{B}−8.70≤y_{B}≤0.04x_{B}−0.90 Formula (b7-2)

18. The thermal insulating material according to claim 16, wherein the thermal insulating layer is a layer capable of generating a compressed state with a compressive strain value x_{A} [%] and a compressive stress value y_{A} [MPa] satisfying the following Formula (a6-1) and the following Formula (a6-2) in the compression test:
0.30≤y_{A}≤0.90 Formula (a6-1)
0.12x_{A}−0.90≤y_{A} Formula (a6-2)

19. The thermal insulating material according to claim 17, wherein the cushioning layer is layer capable of generating a compressed state with a compressive strain value x_{B} [%] and a compressive stress value y_{B} [MPa] satisfying the following Formula (b8-1) and the following Formula (b8-2) in the compression test:
0.40≤y_{B}≤0.80 Formula (b8-1)
0.08x_{B}−5.60≤y_{B}≤0.032x_{B}−0.88 Formula (b8-2)

20. The thermal insulating material according to claim 13, wherein the inorganic particles in the thermal insulating layer are silicon dioxide particles.

21. The thermal insulating material according to claim 20, wherein the silicon dioxide particles are at least one kind selected from the group consisting of dry silica, wet silica, and silica aerogel.

22. (canceled)

23. The thermal insulating material according to claim 13, wherein the thermal insulating layer is a shaped material shaped from a mixture containing inorganic particles and inorganic fiber.

24. (canceled)
